(19) United States
(12) Patent Application Publication
(10) Pub. No.: US 2015/0279033 A1
(43) Pub. Date: Oct. 1, 2015

(54) IMAGE DATA GENERATING APPARATUS AND IMAGE DATA GENERATING METHOD

(71) Applicant: CANON KABUSHIKI KAISHA, Tokyo (JP)

(72) Inventor: Tomochika Murakami, Ichikawa-shi (JP)

(21) Appl. No.: 14/659,957

(22) Filed: Mar. 17, 2015

(30) Foreign Application Priority Data
Mar. 27, 2014 (JP) 2014-067033

(51) Int. Cl. G06T 7/00; G06T 5/50

(52) U.S. Cl. CPC G06T 7/0014; G06T 7/0085; G06T 7/0097; G06T 5/50; G06T 2207/10004; G06T 2207/10056; G06T 2207/20048; G06T 2207/20024; G06T 2207/10148; G06T 2207/30024

(57) ABSTRACT

An image data generating apparatus includes: a transform unit that transforms original image data including plural layer image data obtained by capturing images of plural layers in a subject, into data in a frequency space; a filter application unit that applies a filter to the transformed data; and an inverse transform unit that inverse transforms the filter-applied data into image data in a real space. The filter is designed such that any of the layer image data included in the inverse-transformed image data become feature image data corresponding to image data for which a difference between plural viewpoint image data with mutually different line-of-sight directions with respect to the subject has been extracted or enhanced.

### BACKGROUND OF THE INVENTION

1. Field of the Invention

The present invention relates to an image data generating apparatus and an image data generating method for generating image data suitable for observation or diagnosis from image data obtained by imaging a subject.

2. Description of the Related Art

In the field of pathology, virtual slide systems which capture and digitize an image of a test sample placed on a prepared slide to enable pathological diagnosis on a display are used as an alternative to optical microscopes that are pathological diagnosis tools. By digitizing a pathological diagnosis image with a virtual slide system, it is possible to handle a conventional optical microscopic image of a test sample as digital data. The resultant merits include the increased speed of remote diagnosis, explanation to patients using digital image data, sharing of rare medical cases, and improved efficiency in teaching and learning.

Furthermore, digital data can be subjected to a variety of image processing, and various diagnosis support functions aiding in diagnosis performed by pathologists have been suggested with respect to image data captured by virtual slide systems.

Examples of the suggested diagnosis support functions are described below.

A method for extracting a cell membrane from a pathologic tissue specimen image data of a liver by using a digital image processing technique with the objective to calculate an N/C ratio (a ratio occupied by a nucleus relative to cytoplasm) which is an important finding for cancer diagnosis is disclosed in NPL 1. In NPL 1, three types of color information on the observation image, namely, a bright field, a dark field, and a phase difference, are combined to improve a correct extraction rate of cell membranes with respect to that when a bright-field observation image alone is used.

Further, the clarification of not only a cell membrane, but also a cell boundary (in addition to a cell membrane, an intercellular substance or the like is present on a cell boundary between cells) and a boundary between a cell and a tube or a cavity is very effective in diagnosis. Since a clear boundary enables a doctor to estimate easily a complex three-dimensional structure of a liver from a specimen, more accurate diagnosis can be realized from limited information.

The boundary between a cell and a tube or a cavity also provides useful information for accurately calculating an N/C ratio. For example, since a pathologic tissue specimen of a liver generally includes a region of a cell including a nucleus and cytoplasm and a region of sinusoids which are blood vessels for supplying substances to hepatocyte, the sinusoid region in which a cell is not present should be correctly eliminated in order to calculate a correct N/C ratio.

### Related Patent Literature (PTL)

PTL 1: Japanese Patent Application Publication No. 2007-128009

### Related Non Patent Literature (NPL)

NPL 1: Namiko Torizawa, Masanobu Takahashi, and Masayuki Nakano: “Using Multi-imaging Technique for Cell Membrane Extraction in Hepatic Histologic Images”, General Conference of Institute of Electronics, Information and Communication Engineers, D-16-9, 2009/3
NPL 2: Kazuya Kodama, Akira Kubota, “Virtual Bokeh Reconstruction from a Single System of Lenses”, The Journal of The Institute of Image Information and Television Engineers, 65 (3), pp. 372-381, March 2011
NPL 3: Kazuya Kodama, Akira Kubota, “Scene Refocusing by Linear Combination in the Frequency Domain”, Image Media Processing Symposium (IMPS 2012), 1-3.02, pp. 45-46, October 2012
NPL 4: Kazuya Kodama, Akira Kubota, “Efficient Reconstruction of All-in-Focus Images Through Shifted Pinholes from Multi-Focus Images for Dense Light Field Synthesis and Rendering”, IEEE Trans. Image Processing, Vol. 22, Issue 11, 15 pages (2013-11)

### SUMMARY OF THE INVENTION

However, the following problems are associated with the above-described related art.

In NPL 1, in order to acquire the bright field, dark field, and phase difference observation images, a phase difference objective lens and a common capacitor are mounted on a bright-field microscope and switched to capture images. Therefore, there is a cost-related problem in that additional parts are required for an optical microscope for bright-field observations. Another problem is that time and efforts are required for changing optical systems and exposure conditions during image capturing and the image capturing time is extended. The aforementioned time and efforts create a new problem in the virtual slide systems in which a wide field area is divided, images are captured for each local field, and the images obtained are joined together. Meanwhile, where the image of a wide field area is captured by switching a mechanism for each imaging of a local field, not only the imaging time is extended, but since the image is captured by switching the optical system, a problem is also associated with the durability of the holding mechanism thereof. Meanwhile, when the image of each wide field area is captured without changing the bright field, dark field, and phase difference observation images, a cumulative error of imaging positions during viewing field movement is easily induced by stage control or a difference in focusing accuracy between the images. The resultant problem is that a displacement easily occurs between the mutual image data, and image data are difficult to compare at the same image position.

The present invention has been created with consideration for the above-described problems, and it is an objective thereof to provide a novel technique for generating image data suitable for observation or diagnosis of a subject by image processing from original image data obtained by imaging the subject.

The present invention in its first aspect provides an image data generating apparatus comprising: a transform unit that transforms original image data including a plurality of layer image data obtained by capturing images of a plurality of layers in a subject that differ in a position in an optical axis direction, into data in a frequency space; a filter application unit that applies a filter to the transformed data in the frequency space; and an inverse transform unit that inverse transforms the data to which the filter has been applied into image data in a real space, wherein the filter is designed such that any of the layer image data included in the inverse-transformed image data become feature image data corresponding to image data for which a difference between a plurality of viewpoint image data with mutually different line-of-sight directions with respect to the subject has been extracted or enhanced.

The present invention in its second aspect provides an image data generating apparatus comprising: a transform unit that uses original image data including a plurality of layer image data obtained by capturing images of a plurality of layers in a subject that differ in a position in an optical axis direction, to transform each of the plurality of layer data into data in a frequency space; a filter application unit that applies a plurality of filters to the plurality of transformed data in the frequency space, respectively; a combination unit that combines together the plurality of data to which the filters have been applied; and an inverse transform unit that inverse transforms the combined data into image data in a real space, wherein the plurality of filters is designed such that the inverse-transformed image data become feature image data corresponding to image data for which a difference between a plurality of viewpoint image data with mutually different line-of-sight directions with respect to the subject has been extracted or enhanced.

The present invention in its third aspect provides an image data generating method comprising the steps of: causing a computer to transform original image data including a plurality of layer image data obtained by capturing images of a plurality of layers in a subject that differ in a position in an optical axis direction, into data in a frequency space; causing the computer to apply a filter to the transformed data in the frequency space; and causing the computer to inverse transform the data to which the filter has been applied into image data in a real space, wherein the filter is designed such that any of the layer image data included in the inverse-transformed image data become feature image data corresponding to image data for which a difference between a plurality of viewpoint image data with mutually different line-of-sight directions with respect to the subject has been extracted or enhanced.

The present invention in its fourth aspect provides an image data generating method comprising the steps of: causing a computer to use original image data including a plurality of layer image data obtained by capturing images of a plurality of layers in a subject that differ in a position in an optical axis direction, to transform each of the plurality of layer data into data in a frequency space; causing the computer to apply a plurality of filters to the plurality of transformed data in the frequency space, respectively; causing the computer to combine together the plurality of data to which the filters have been applied; and causing the computer to inverse transform the combined data into image data in a real space, wherein the plurality of filters is designed such that the inverse-transformed image data become feature image data corresponding to image data for which a difference between a plurality of viewpoint image data with mutually different line-of-sight directions with respect to the subject has been extracted or enhanced.

The present invention in its fifth aspect provides a non-transitory computer readable storage medium that stores a program for causing a computer to execute each step of the image data generating method according to the present invention.

In accordance with the present invention, it is possible to generate image data suitable for observation or diagnosis of a subject by image processing from original image data obtained by imaging the subject.

Further features of the present invention will become apparent from the following description of exemplary embodiments with reference to the attached drawings.

### BRIEF DESCRIPTION OF THE DRAWINGS

FIG. 1 depicts the configuration of an image data generation and display system according to an embodiment of the present invention;

FIG. 2 is a display example for explaining functions of an image display application;

FIG. 3 illustrates the internal configuration of an image data generating apparatus;

FIG. 4 is a diagram showing a prepared slide that is an example of a subject;

FIG. 5 schematically illustrates a configuration of an image capturing device for imaging a subject;

FIGS. 6A and 6B explain a reason for contrast enhancement in viewpoint image data;

FIGS. 7A and 7B illustrate a relationship between a polar angle of a viewpoint and an angle (observation angle) formed between a line-of-sight direction and an optical axis;

FIGS. 8A and 8B depict the unevenness present on a surface of a pathological specimen on the prepared slide;

FIGS. 9A to 9C depict the intensity of scattered light at an observation angle φ on various planes shown in FIG. 8A;

FIGS. 10A to 10F depict Z stack image data in the case of different Z positions of an object;

FIGS. 11A to 11H depict viewpoint image data and out-of-focus blur in the case of different Z positions of an object;

FIGS. 12A and 12B illustrate the out-of-focus blur of scattered light extraction image data and scattered light enhancement image data;

FIGS. 13A to 13E illustrate examples of a GUI in Example 1;

FIGS. 14A to 14C are flowcharts of scattering image data generation processing in Example 1;

FIGS. 15A and 15B explain a transmitted light component suppression mask and the generation processing thereof in Example 1;

FIGS. 16A to 16D are flowcharts of scattered light extraction image data generation processing in Example 1;

FIGS. 17A and 17B illustrate the transmitted light component suppression processing in Example 1;

FIG. 18 is a flowchart illustrating the N/C ratio calculation processing in Example 1;

FIGS. 19A and 19B illustrate the scattering image data calculation processing in Example 2;

FIG. 20 is a flowchart of the scattered light enhancement image data generation processing in Example 2;

FIGS. 21A and 21B illustrate the scattered light enhancement image data generation processing in Example 2;

FIGS. 22A to 22D illustrate the scattered light enhancement image data generation processing in Example 3;

FIG. 23 is a flowchart of the scattered light extraction image data generation processing;

FIG. 24 is a flowchart of the scattered light extraction image data generation processing;

FIGS. 25A to 25C show examples of viewpoint weighting functions and a viewpoint weighting function for scattered light information extraction;

FIG. 26 shows how the surface unevenness of a specimen is observed from viewpoints that differ in a polar angle by 180 degrees;

FIGS. 27A to 27C show the examples of viewpoint position, polar angle selection function, and polar angle selection viewpoint weighting function in Example 6; and

FIGS. 28A to 28C are flowcharts of the processing in Example 6.

### DESCRIPTION OF THE EMBODIMENTS

(Overall Configuration)

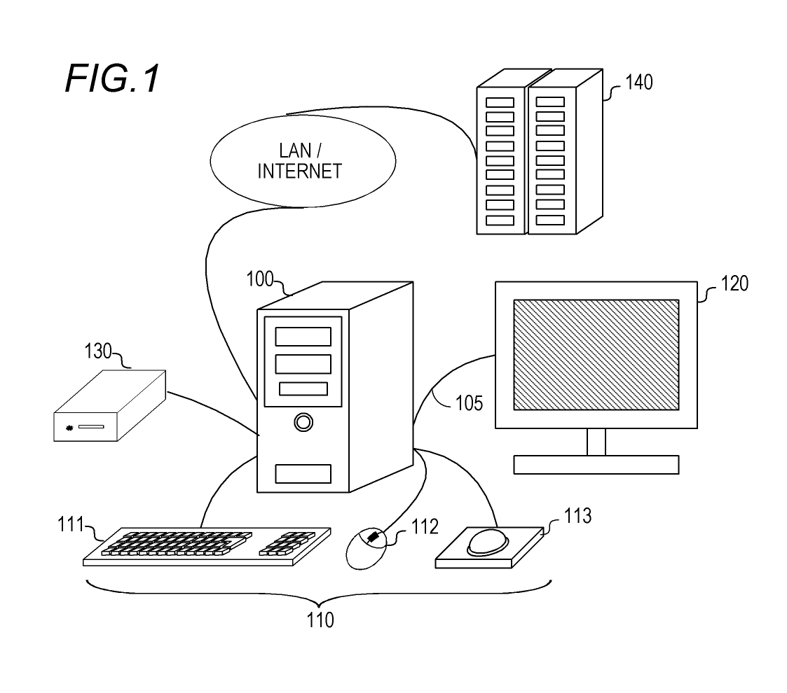

FIG. 1 the configuration of an image data generation and display system according to an embodiment of the present invention.

An operation input device 110 that receives an input from a user and a display 120 for presenting image data, or the like, outputted from an image data generating apparatus 100 to the user are connected to the image data generating apparatus (a host computer) 100. A keyboard 111, a mouse 112, a dedicated controller 113 (for example, a trackball or a touch pad) for improving operability of the user can be used as the operation input device 110. Further, a storage device 130 such as a hard disk, an optical drive, or a flash memory and another computer system 140 that can be accessed via a network I/F are connected to the image data generating apparatus 100. In FIG. 1, the storage device 130 is present outside of the image data generating apparatus 100, but the storage device may be incorporated in the image data generating apparatus 100.

The image data generating apparatus 100 acquires image data from the storage device 130 according to a user's control signal inputted from the operation input device 110 and generates observation image data suitable for observation by using image processing, or extracts information necessary for diagnosis.

An image display application and an image data generation program (none is shown in the figures) are computer programs that are executed by the image data generating apparatus 100. Those programs are stored in an internal storage device (not shown in the figure) inside the image data generating apparatus 100 or in the storage device 130. Functions relating to image data generation, which are described hereinbelow, are provided by the image data generation program. The functions of the image generation program can be invoked (used) via the image display application. Processing results (for example, generated observation image data) of the image generation program are presented to the user via the image display application.

(Display Screen)

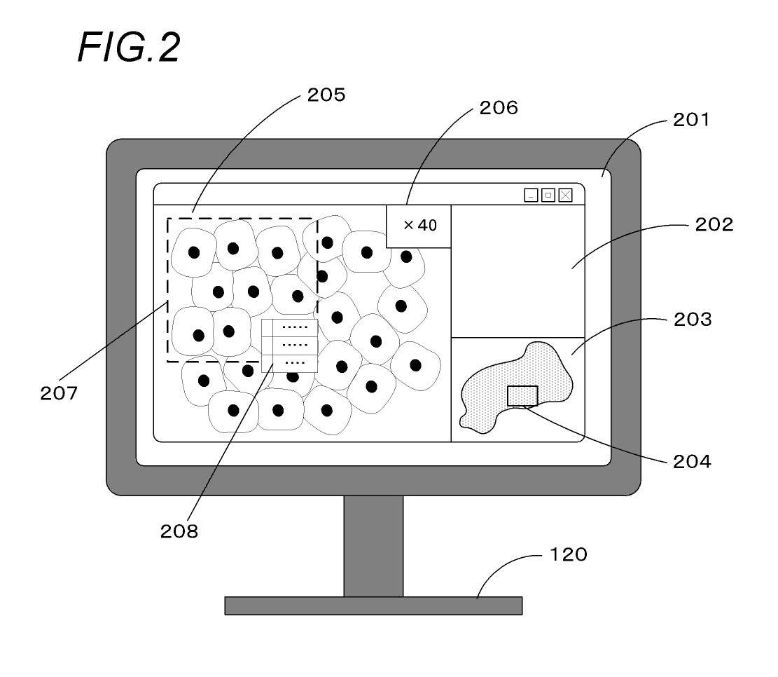

FIG. 2 illustrates an example in which image data of a pathological specimen which have been captured in advance are displayed on the display 120 via the image display application.

FIG. 2 depicts a basic configuration of a screen layout of the image display application. An information area 202 that shows a display or operation status and also information on various image data, a thumbnail image 203 of a pathological specimen that is an observation object, a display region 205 for detailed observation of pathological specimen image, and a display magnification 206 of the display region 205 are arranged within a full window 201 of the display screen. A frame line 204 drawn on the thumbnail image 203 indicates a position and a size of a region displayed in enlargement in the display region 205 for detailed observation. On the basis of the thumbnail image 203 and the frame line 204, the user can easily comprehend which portion of the entire pathological specimen image data is being observed.

The image to be displayed in the display region 205 for detailed observation can be set and updated by a movement operation or an enlargement/reduction operation performed with the operation input device 110. For example, the movement can be realized by a drag operation of the mouse on the screen, and the enlargement/reduction can be realized by rotating a mouse wheel (for example, the forward rotation of the wheel may be allocated to enlargement and a backward rotation of the wheel may be allocated to reduction). Further, switching to an image with a different focusing position, that is, an image with a different depth position, can be realized by rotating the mouse wheel while pressing a prescribed key (for example, the Ctrl key). For example, the forward rotation of the wheel may be allocated to a transition to a deep image and the backward rotation of the wheel may be allocated to a transition to a shallow image. The display region 205, the display magnification 206, and the frame line 204 inside the thumbnail image 203 are updated according to a change operation performed by the user on the displayed image as described hereinabove. The user can thus observe an image with desired in-plane position, depth position, and magnification.

(Image Data Generating Apparatus)

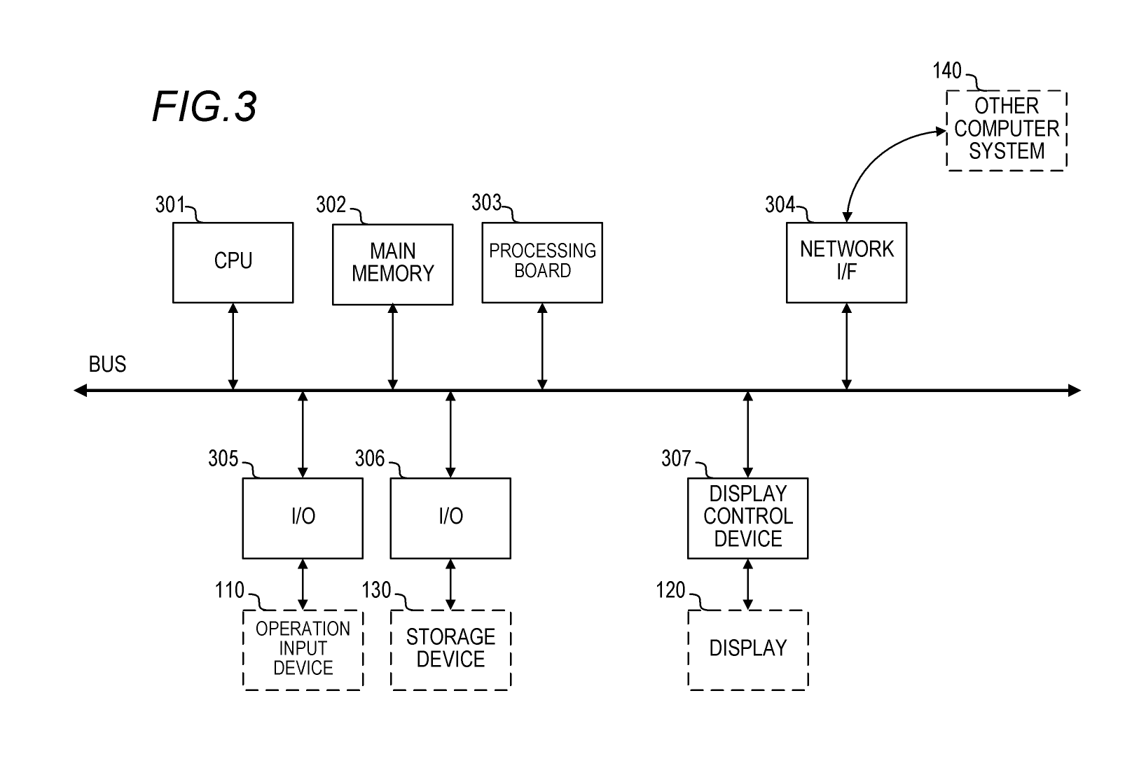

FIG. 3 illustrates the internal configuration of the image data generating apparatus 100.

A CPU 301 controls the entire image data generating apparatus by using programs and data stored in a main memory 302. The CPU 301 also performs various computational processing and data processing such as scattering image data generation processing, transmitted light component suppression processing, and transmitted light enhancement image data generation processing which are described in the examples hereinbelow.

The main memory 302 includes an area for temporarily storing programs and data loaded from the storage device 130 and programs and data downloaded from the other computer system 140 via a network I/F (interface) 304. The main memory 302 also includes a work area necessary for the CPU 301 to perform various processing.

The operation input device 110 is constituted by a device capable of inputting various instructions to the CPU 301, such as the keyboard 102, the mouse 103, or the dedicated controller 113. With the operation input device 110, the user inputs information for controlling operations of the image data generating apparatus 100. Reference numeral 305 denotes an I/O (input/output) for notifying the CPU 301 of various instructions and the like inputted via the operation input device 110.

The storage device 130 is a large-capacity information storage device, such as a hard disk, and stores an OS (operating system), and also programs and image for executing the processing described in the following examples in the CPU 301. Writing of information into the storage device 130 and reading of information from the storage device 130 are performed via an I/O 306.

A display control device 307 performs control processing for displaying images, characters, and the like on the display 120. The display 120 performs image display for prompting the user's input and displays image data acquired from the storage device 130 or the other computer system 140 and processed by the CPU 301.

A computational processing board 303 includes a processor in which specific computational functions such as image processing have been enhanced and a buffer memory (not shown in the figures). The explanation hereinbelow assumes that the CPU 301 is used for various computational processing and data processing and the main memory 302 is used as a memory region, but it is also possible to use the processor and the buffer memory in the computational processing board, and such a configuration is also within the scope of the present invention.

(Subject)

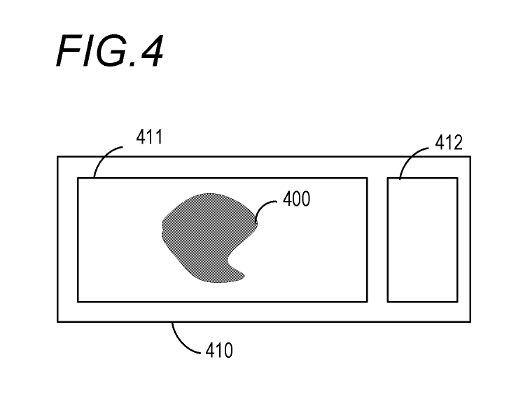

FIG. 4 represents a prepared slide (also referred to as a slide) of a pathological specimen that is an example of a subject. With the prepared slide of the pathological specimen, a pathological specimen 400 placed on a slide glass 410 is encapsulated by an encapsulating agent (not shown in the figure) and a cover glass 411 to be placed on top of the encapsulating agent. A size and thickness of the pathological specimen 400 differ for each pathological specimen. Furthermore, a label area 412 in which information relating to the pathological specimen has been recorded is also present on the slide glass 410. Information may be recorded in the label area 412 manually with a pen or by printing a barcode or a two-dimensional code. Further, a storage medium capable of storing information by an electric, magnetic, or optical method may be provided in the label area 412. In the following embodiment, the prepared slide of the pathological specimen shown in FIG. 4 will be described as a subject by way of example.

(Image Capturing Device)

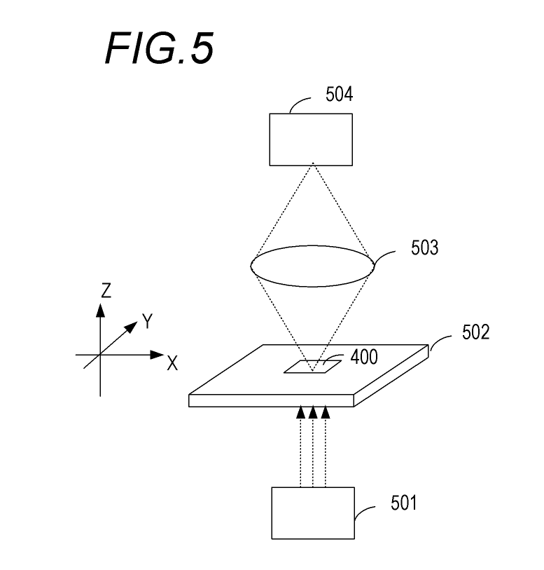

FIG. 5 schematically represents part of the configuration of an image capturing device which captures an image of the subject and acquires a digital image. As depicted in FIG. 5, in the present embodiment, an x axis and an y axis are parallel to a surface of the pathological specimen 400 and a z axis is taken in a depth direction of the pathological specimen 400 (in an optical axis direction of the optical system).

A prepared slide (the pathological specimen 400) is placed on a stage 502 and irradiated with light from an illuminating unit 501. Light transmitted by the pathological specimen 400 is enlarged by an imaging optical system 503 and forms an image on a light-receiving surface of an image capturing sensor 504. The image capturing sensor 504 is a line sensor (one-dimensional sensor) or an area sensor (two-dimensional sensor) having a plurality of photoelectric conversion elements. An optical image of the pathological specimen 400 is converted by the image capturing sensor 504 into an electric signal and outputted as digital data.

When image data of the entire pathological specimen cannot be acquired in one image-capturing shot, segmental image capturing is performed a plurality of times while moving the stage 502 in the x direction and/or the y direction, and a plurality of obtained segmented images is composited (spliced) to generate an image of the entire pathological specimen. Further, by taking a plurality of image-capturing shots while moving the stage 502 in the z direction, a plurality of image data (referred to as layer image data) with different focusing positions in the optical axis direction (depth direction) is acquired. In the present description, an image data group constituted by a plurality of layer image data with different focusing positions in the optical axis direction (depth direction) is referred to as “Z stack image data”. Further, layer image data or Z stack image data which are image data acquired by capturing the image of the subject are referred to as “original image data”.

The value of magnification that is displayed as the display magnification 206 in FIG. 2 is a product of the magnification of the imaging optical system 503 and the enlargement/reduction ratio on the image display application. The magnification of the imaging optical system 503 may be fixed or varied by replacing an objective lens.

(Description of Techniques for Generating Viewpoint Image Data)

In the image data generating apparatus 100, an observation/image capturing method in which an optical system is changed, for example, between dark field observation and phase difference observation, is not required. Instead, intermediate image data (viewpoint image data) are generated by image processing from Z stack image data, and observation image data suitable for observation and diagnosis are generated using the intermediate image data. Explained initially herein is a technique that can be used in processing for generating the viewpoint image data as the intermediate image data from the Z stack image data.

It is known that viewpoint image data observed from an arbitrary direction (arbitrary viewpoint image data) can be generated on the basis of a plurality of image data (Z stack image data) captured while changing the focusing position in the optical axis direction. In this case, viewpoint image data, as referred to herein, represent image data obtained by observing the subject from a predetermined observation direction (that is, a viewpoint).

For example, Japanese Patent Application Publication No. 2007-128009 (referred to hereinbelow as PTL 1) discloses a method for generating image data of an arbitrary viewpoint or an arbitrary blur from a group of out-of-focus blur image data which has been captured while changing the focusing position. With this method, the group of out-of-focus blur image data is subjected to coordinate transform processing such that out-of-focus blur in three dimensions (referred to hereinbelow as three dimensional out-of-focus blur) obtained by combining two-dimensional out-of-focus blur generated before and after the focusing position becomes unchanged at an XYZ position. Then, image data in which the viewpoint or blur has been changed are obtained by using three-dimensional filter processing in the obtained orthogonal coordinate system (XYZ).

Further, an improvement of the method disclosed in PTL 1 is disclosed in NPL 2. In NPL 2, integrated image data are generated by determining a line-of-sight direction from a viewpoint and integrating the Z stack image data in the line-of-sight direction, and integrated image data of three-dimensional out-of-focus blur in the line-of-sight direction are also generated in the same manner. By thereafter subjecting the integrated image data with three-dimensional out-of-focus blur to inverse filter processing with respect to the integrated image data of the Z stack image data, an effect produced by the constraint in the Z direction (the number of layer image data) can be suppressed and high-quality viewpoint image data can be generated.

A method of speeding up the calculation performed in NPL 2 is disclosed in NPL 3. With the method disclosed in NPL 3, arbitrary viewpoint image data or arbitrary out-of-focus blur image data of a frequency region can be efficiently calculated by a linear coupling of a filter determined in advance independently of a subject (scene) and a Fourier transform image data of a group of the out-of-focus blur image data group at each Z position.

The method disclosed in NPL 3 is explained in greater detail in NPL 4.

In the present embodiment, the viewpoint image data observed from an arbitrary direction (arbitrary viewpoint image data) are generated or image data having arbitrary out-of-focus blur are generated on the basis of a plurality of image data (Z stack image data) captured by changing the focusing position in the optical axis direction. In the explanation below, those techniques will be collectively referred to as a multi-focus imaging (MFI) arbitrary viewpoint/out-of-focus blur image generating method.

Further, in the Z stack image data captured by changing the focusing position with a microscope having a bilaterally telecentric optical system, the three-dimensional out-of-focus blur remains unchanged at a xyz position. Therefore, when the MFI arbitrary viewpoint/out-of-focus blur image generating method is applied to the Z stack image data captured with the bilaterally telecentric optical system, the coordinate transform processing and the enlargement/reduction processing of image data performed in conjunction with the coordinate transform processing are not required.

An image capturing device is known which is capable of acquiring, by one image capturing operation, image data in which four-dimensional information referred to as a light field (information in which the degree of freedom of a viewpoint position is added to XY two-dimensional image data) is recorded. Such an image capturing device is referred to as a light field camera or a light field microscope. In such devices, a lens array is disposed at an original position of an imaging plane and a light field is captured with an image sensor located behind the lens array. Image data with an arbitrary focusing position or viewpoint image data observed from an arbitrary direction (arbitrary viewpoint image data) can be also generated using well-known techniques from the original image data in which a light field has been recorded.

In the present example, image data with an arbitrary observation direction that are generated by digital image processing on the basis of captured image data such as Z stack image data and a light field, without physically changing the direction of the image capturing device with respect to the subject, will be referred to as “viewpoint image data”. The viewpoint image data are image data which simulate an optical image formed on an image capturing plane by a luminous flux centered on a main optical axis which is an arbitrary optical axis passing through an imaging optical system used to capture the image of the subject. The direction of the main optical axis corresponds to the observation direction. The direction of the main optical axis can be set arbitrarily. A magnitude (NA) of the luminous flux can be also set arbitrarily. When the objective is to perform image diagnosis or the like, it is desirable that the depth of field of the viewpoint image data be large. Therefore, it is desirable that the NA of the luminous flux corresponding to the viewpoint image data be equal to or less than 0.1.

Viewpoint image data generated (calculated) by digital image processing do not necessarily match the image data captured by physically changing the image capturing conditions (an aperture position and/or an aperture size), optical axis direction, lenses, or the like, of the imaging optical system. However, even when the viewpoint image data do not match the actually captured image data, the viewpoint image data are useful for image observation, image diagnosis, and the like, provided that the image data have features similar to those obtained when observing the subject while changing the viewpoint (in other words, provided that an effect same as that of changing the observation direction can be obtained with digital image processing). Therefore, image data which do not exactly match the image data actually captured while changing the optical axis direction, but which have been subjected to digital image processing such that features same as those of the actually captured image data appear, are also included in the viewpoint image data according to the present example.

Viewpoint image data observed through a pinhole at a position shifted to a viewpoint (x, y, z)=(s, t, 0) from a point of origin O(x, y, z)=(0, 0, 0) on a lens plane (corresponds to a pupil plane) in a real space can be generated from an out-of-focus blur image group subjected to coordinate transform. With the MFI arbitrary viewpoint/out-of-focus blur image generating method, an observation direction from which the subject is observed, that is, a line-of-sight direction, can be varied by changing the position of the viewpoint on the lens plane.

A line-of-sight direction can be defined as an inclination of a straight line that passes through a viewpoint position (x, y, z)=(s, t, 0) on the lens plane within a luminous flux emitted from a predetermined position of the subject corresponding to a formed image. The line-of-sight direction can be represented by a variety of methods. For example, the representation by a three-dimensional vector indicating a traveling direction along a straight line may be used, or the representation by an angle (observation angle) formed by the aforementioned three-dimensional vector with the optical axis and an angle (polar angle) formed between the vector when projected on a plane perpendicular to the optical axis and the X axis may be used.

Where the imaging optical system is not bilaterally telecentric, the three-dimensional out-of-focus blur on the image capturing plane varies depending on the spatial position (a position in the xyz coordinates) of the subject in focus, and the inclination of the straight line that passes through the viewpoint position (x, y, z)=(s, t, 0) on the lens plane is not constant. In this case, the line-of-sight direction may be defined on an orthogonal coordinate system (XYZ) after the coordinate transform described in PTL 1, and the line-of-sight direction can be represented by a vector (X, Y, Z)=(−s, −t, 1). A method of determining the line-of-sight direction after coordinate transform is described hereinbelow.

PTL 1 indicates that all optical axes connecting arbitrary positions where the imaging optical system is in focus and a position (x, y, z)=(s, t, 0) of the same viewpoint on the lens plane (corresponds to the pupil plane) of the image capturing device are parallel to each other in the orthogonal coordinate system (XYZ) after coordinate transform (see FIGS. 1 to 3 and descriptions thereof in PTL 1).

Light exiting a point where the subject is present in a perspective coordinate system (a real space prior to coordinate transform) passes through (p+s, q+t, f) (where f is a focal distance) and is refracted at the viewpoint position (x, y, z)=(s, t, 0). This straight line may be represented by the following expression.

$$( x , y ) = \frac{z}{f} \times ( p , q ) + ( s , t ) ( z > 0 ) \qquad [ Expression 1 ]$$

The straight line represented by Expression 1 may be represented by the following expression in the orthogonal coordinate system (XYZ) after coordinate transform.

(X,Y)=(p·q)+(1−Z)×(s,t)(Z≧f) [Expression 2]

Where Z=0 (z=f) and Z=1 (z=∞) are substituted into Expression 2 and three-dimensional coordinates are determined, the respective results are (X, Y, Z)=(p+s, q+t, 0) and (X, Y, Z)=(p, q, 1). Therefore, the inclination of the straight line in the orthogonal coordinate system (X, Y, Z) is represented by (−s, −t, 1).

Therefore, a vector representing the line-of-sight direction in the orthogonal coordinate system after coordinate transform is (X, Y, Z)=(−s, −t, 1).

Where the imaging optical system is bilaterally telecentric, the three-dimensional out-of-focus blur in a plurality of image data (Z stack image data) captured while changing the focal point in the depth direction is unchanged regardless of the Z position.

Therefore, the coordinate transform for making the three-dimensional out-of-focus blur unchanged regardless of spatial positions is not required. The inclination (−s, −t, za) of a straight line connecting a predetermined position (x, y, z)=(0, 0, za) of the subject in focus in real space and the viewpoint position (x, y, z)=(s, t, 0) on the lens plane may be considered, without any modification, as the line-of-sight direction.

(Correspondence Relationship Between Viewpoint and Polar Angle θ and Observation Angle φ Obtained in Actual Specimen Observations)

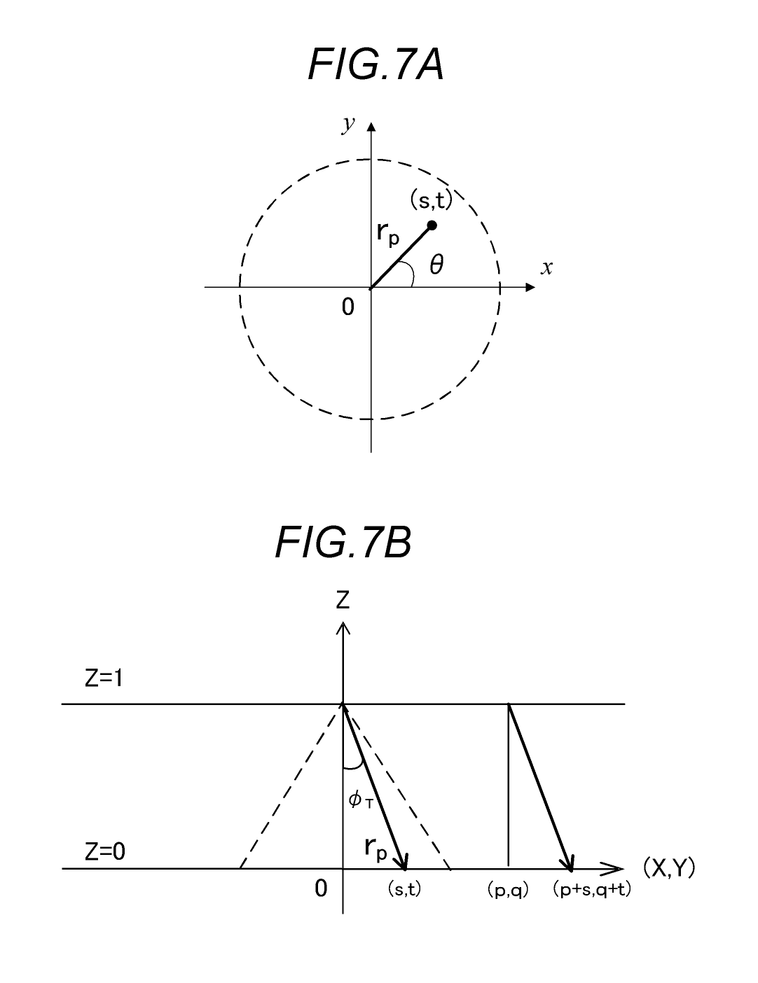

FIG. 7A is a schematic view representing the viewpoint position (x, y, z)=(s, t, 0) in real space, and FIG. 7B is a schematic view representing an optical axis that passes through the viewpoint position (x, y, z)=(s, t, 0) in the orthogonal coordinate system (XYZ).

A dot-line circle shown in FIG. 7A represents a range in which an optical axis can pass through on the lens plane (z=0). Where the polar angle θ is defined as an angle formed between the viewpoint position (x, y, z)=(s, t, 0) on the lens plane and the x axis on the lens plane (z=0) or an angle formed between the x axis and a straight line obtained when a line of sight (−s, −t, 1) is projected on the xy plane, the polar angle θ may be determined by the following expression.

$$θ = {tan}^{- 1} ( \frac{t}{s} ) \qquad [ Expression 3 ]$$

However, θ is adjusted such as to be confined within a range of −180 degrees to +180 degrees according to the signs of t and s.

The relationship between the line of sight and an observation angle φ_{T} on a transformed coordinate is described hereinbelow using FIG. 7B.

In FIG. 7B, a straight line represented by Expression 2 and a straight line obtained by substituting a point p=0, q=0 on the optical axis into Expression 2 are shown by solid arrows.

According to PTL 1, Z=0 in the orthogonal coordinate system (XYZ) corresponds to z=f (or z=−∞) in the perspective coordinate system (xyz), and Z=1 corresponds to z=∞(or z=−f). Therefore, FIG. 7B indicates that a luminous flux from infinity (Z=1) in the orthogonal coordinate system (XYZ) has a spread on a focal plane (Z=0) in front of the lens plane (see FIG. 3 and the description thereof in PTL 1).

In this case, where the observation angle φ_{T} on the transformed coordinate is defined as an angle formed between the line of sight (−s, −t, 1) and the optical axis (Z axis), since the line of sight does not depend on the position of the subject, as is also apparent from FIG. 7B, the observation angle φ_{T} can be determined by the following expression.

φ_{T}=tan⁻¹(\sqrt{s²+t²}) [Expression 4]

The two dot lines in FIG. 7B represent optical axes that pass through outermost edges on the lens plane. Where an aperture radius of the lens in the perspective coordinate system (xyz) prior to coordinate transform is denoted by rₘ, then viewpoint image data can be calculated only when the viewpoint position (x, y, z)=(s, t, 0) is within the radius rₘ.

The polar angle θ and the observation angle φ corresponding to the line of sight when the specimen is actually observed and is not on the transform coordinate are described hereinbelow. According to the Snell's law, when a light beam is incident on a boundary between different refractive indexes, the product of an incidence angle of the light beam and the refractive index of an incident-side medium is equal to the product of the refraction angle of the light beam and the refractive index of a refraction-side medium. Since the refractive index of the specimen is greater than the refractive index of the air, the observation angle in the specimen is less than the observation angle in the air. Therefore, the three-dimensional out-of-focus blur in the specimen which is constituted by the refracted light beams is less than the three-dimensional out-of-focus blur in the air. However, in the present example, the viewpoint position is calculated on the basis of the three-dimensional imaging relationship determined by the three-dimensional out-of-focus blur in the specimen. Therefore, the effect of the refractive index of the specimen need not to be taken into account, and the polar angle θ and the observation angle φ represent, as they are, the observation direction in the specimen.

When the imaging optical system is bilaterally telecentric, since the coordinate transform is not necessary, where a sensor pixel pitch in the x direction is assumed to be the same as in the y direction, the observation angle φ can be represented by the following expression by using the sensor pixel pitch Δx in the x direction and a movement interval Δz (units: μm) in the z direction.

$$φ = {tan}^{- 1} ( Δ x \times \frac{\sqrt{{s}^{2} + {t}^{2}}}{Δ z} ) \qquad [ Expression 5 ]$$

Further, when the imaging optical system is not bilaterally telecentric, the observation angle φ can be determined using a sensor pixel pitch ΔX in the X direction and a movement interval ΔZ in the Z direction in the orthogonal coordinate system (XYZ) instead of Δx and Δz in Expression 5.

Described hereinabove are the polar angle θ and the observation angle φ corresponding to the line of sight when the specimen is actually observed.

In the following description, the viewpoint position (x, y, z)=(s, t, 0) on the lens plane is abbreviated as a viewpoint (s, t). Further, since the explanation assumes the image processing on the orthogonal coordinate system (XYZ), only when the viewpoint position (s, t) is concerned, a position in the perspective coordinate system (a real space prior to coordinate transform) is represented, and other positions are to represent positions in the orthogonal coordinate system (XYZ), unless specifically stated otherwise.

Where the MFI arbitrary viewpoint/out-of-focus blur image generating method is applied to the Z stack image data acquired with the image capturing device depicted in FIG. 5, the viewpoint image data obtained by changing a viewpoint position, that is, an observation direction, can be generated.

The viewpoint image data calculated by the MFI arbitrary viewpoint/out-of-focus blur image generating method mainly have two features. One feature is that the viewpoint image data have an extremely large (infinite) depth of field, and boundaries between substances in the specimen with different transmittances are clearly seen. The other feature is that in the viewpoint image data, an unevenness which varies along the line-of-sight direction on the XY plane is enhanced and the specimen appears to be three-dimensional in the vicinity of an observed image under oblique illumination which is obtained by illuminating the specimen from a partial region of illumination. In the viewpoint image data, the contrast of the unevenness of the specimen surface increases and the specimen surface appears to be more three-dimensional as the line-of-sight direction inclines with respect to the line-of-sight direction, that is, as the observation angle φ of the line of sight increases, in the same manner as in the image under oblique illumination.

(However, the image under oblique illumination and the viewpoint image data physically differ from each other. The difference is that in the image under oblique illumination, optical blur is generated as the focusing position is changed, whereas in the viewpoint image data, the depth of field remains extremely large regardless of whether the focusing position is changed. Moreover, while the viewpoint image data vary depending on the Z position Zf of the Z stack image data that are brought into focus, the variation is expressed by a translation in the XY direction).

The reason why the boundary of substances with different transmittances is clearly seen, this being the first feature, is explained hereinbelow.

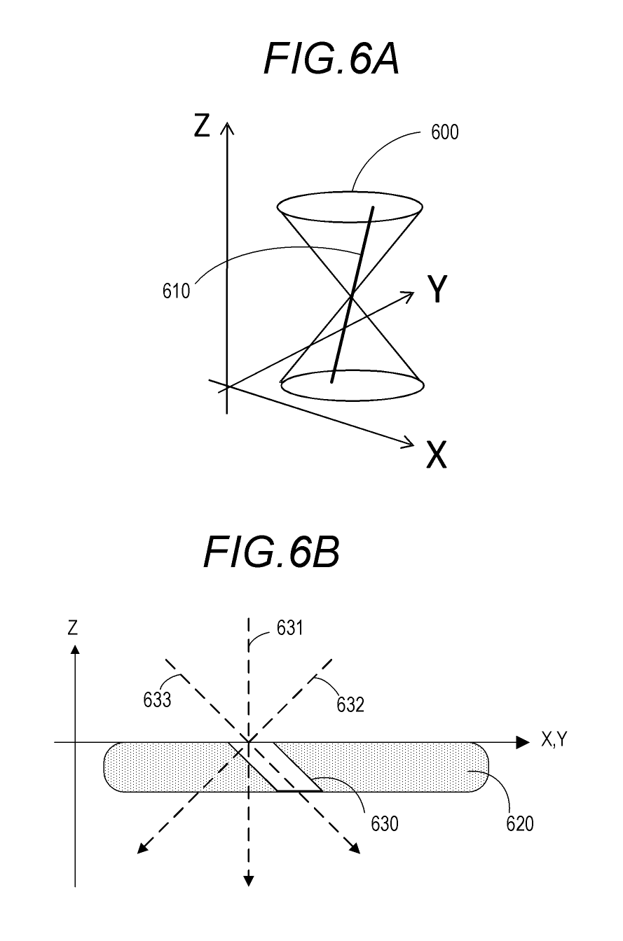

FIG. 6A represents the three-dimensional out-of-focus blur of an optical system in the orthogonal coordinate system (XYZ). Reference numeral 600 denotes the shape of the three-dimensional out-of-focus blur and indicates that there is only a slight out-of-focus blur at a focusing position (apexes of two cones), but the out-of-focus blur spreads with the distance from the Z position withdraws to the focusing position. Where the MFI arbitrary viewpoint/out-of-focus blur image generating method is used, viewpoint image data constituted by a light beam in an arbitrary line-of-sight direction (for example, a straight line 610) that passes inside the cone 600 from the Z stack image data can be generated.

FIG. 6B is a view of a pathological specimen in the orthogonal coordinate system (XYZ) which is taken from different directions. A cavity 630 in the oblique direction is present inside a specimen 620 in FIG. 6B.

Since segments other than the cavity 630 are seen through when observed from a direction 631, the contrast of the wall surface of the cavity 630 is unclear. The contrast of the cavity 630 is also unclear when observations are performed from a direction 632. However, when observations are performed from a direction 633 along the wall surface of the cavity 630, since no effects are received from other segments, the contrast of the wall surface of the cavity 630 becomes clear. Furthermore, a state with a relatively high contrast can be maintained even when the line-of-sight direction somewhat differs from the direction of the wall surface of the cavity.

Meanwhile, the three-dimensional out-of-focus blur of the Z stack image data of the specimen 620 is the combination of light beams in various line-of-sight directions. Therefore, in the layer image data at any Z position (focusing position), the image is also blurred by the effect of a multi-directional luminous flux including light beams in the directions 631 to 633, and the contrast of the wall surface of the cavity does not become clearer than in the observation image from the direction 633. This phenomenon is observed not only in the cavity, but also in a nucleus, a cell membrane, a fiber, and the like.

Described hereinabove is a phenomenon explaining why the boundary of substances with different transmittances in a specimen is clearly seen in viewpoint image data.

The pathological specimen is a semitransparent object, and scattered light is present in addition to the transmitted light. The presence of the scattered light generates the second feature of the viewpoint image data.

The reason why the contrast of the specimen surface unevenness increases with the increase in the observation angle φ of the line of sight due to the light scattered on the specimen is explained hereinbelow.

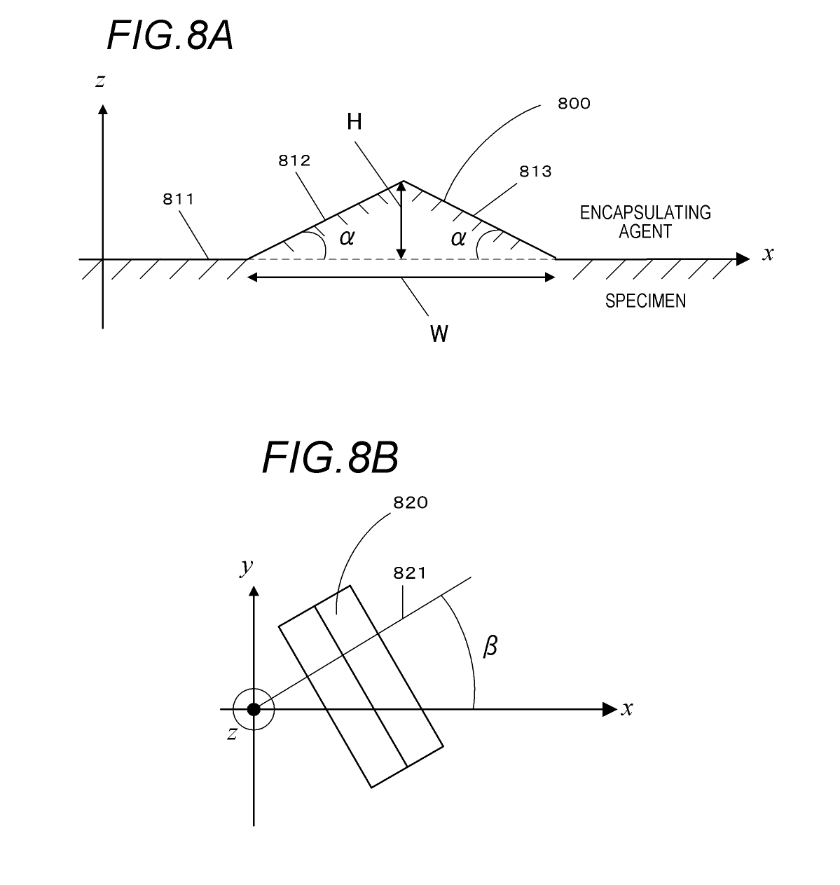

Reference numeral 800 in FIG. 8A is a schematic view of the unevenness present on the surface of a pathological specimen in the prepared slide. The unevenness on the xz plane depicted in FIG. 8A is assumed to continue also in the y direction which is the depth direction.

A pathological specimen for tissue diagnosis is fixed by paraffin, then sliced in a uniform thickness by a microtome, and then stained. However, the pathological specimen is not completely uniform, the unevenness caused by tissue structure or components of substances is present at a boundary between a cell and a tube or a cavity, a boundary between a nucleus and cytoplasm, and the like, and a structure having peaks such as depicted in FIG. 8A is present on the surface of the pathological specimen.

FIG. 8A represents a simplified model, and the unevenness of an actual specimen seldom includes only a small number of sharp portions such as depicted in FIG. 8A. Further, in addition to convex structures such as depicted in FIG. 8A, there are also structures receding inward of the specimen. Furthermore, since an optical distance varies when a substance with a different refractive index is present inside the specimen even when the surface is smooth, a discontinuity in the refractive index inside the specimen can be considered as a surface unevenness.

In a real prepared slide, a transparent encapsulating agent is present between a cover glass and a specimen. However, since a difference between the refractive index of the encapsulating agent and the refractive index of the specimen is very small and produces but a small effect, the two refractive indexes are assumed in the explanation hereinbelow to be equal to each other.

Reference numeral 811 in FIG. 8A denotes a plane with no unevenness, reference numeral 812 denotes an inclined plane rising to the right, and reference numeral 813 denotes an inclined plane falling to the right. Inclination angles formed between the inclined planes 812 and 813 and the x axis are each α (α>0).

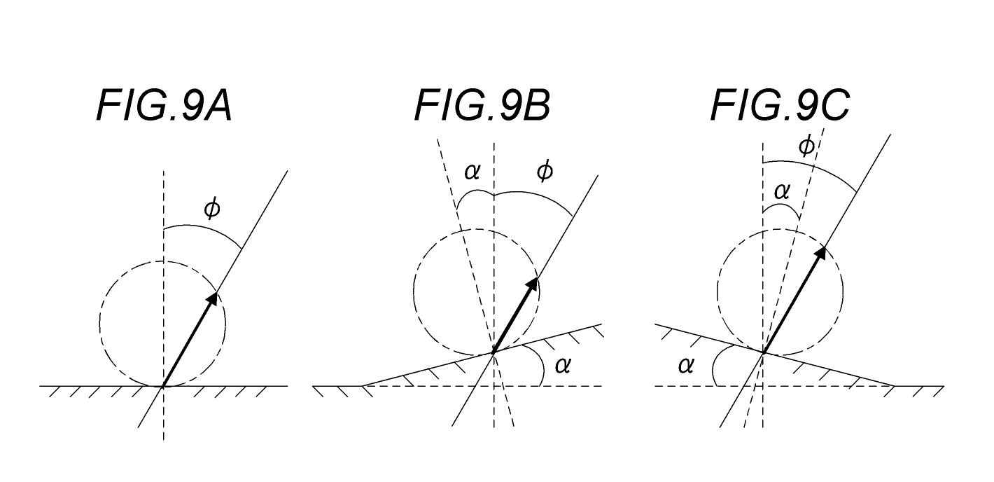

FIGS. 9A to 9C are schematic diagrams showing the intensity of scattered light at an observation angle φ on the planes 811 to 813 in FIG. 8A. FIGS. 9A, 9B, and 9C represent the scattering of light by the plane 811 and the inclined planes 812 and 813, respectively. A circle that is in contact with each plane represents the intensity of scattered light for different scattering directions when the diffusion characteristic of light on the specimen surface is assumed to correspond to a perfect diffusion/transmission surface. The length of the solid arrow line inside the circle represents the intensity of scattered light when observed from a direction that is inclined by φ from the optical axis (z axis) (although an actual specimen surface is not a perfect diffusion/transmission surface and the intensity depends on the incidence direction and observation direction of light, the specimen surface is assumed herein to be a perfect diffusion/transmission surface to simplify the explanation).

With a perfect diffusion/transmission surface, where the intensity of light in a normal direction which is perpendicular to the surface is denoted by I(δ) and an angle formed between an observation direction and a normal to the surface is denoted by δ, the intensity I(δ) of scattered light in the δ direction is represented by as I(δ)=I₀ cos δ.

In FIGS. 9A, 9B and 9C, since angles δ formed between the observation direction and the normal to the planes are represented by φ, φ+α, and φ−α, the respective intensities of the scattered light are

I₀ cos(φ),I₀ cos φ+α),I₀ cos(φ−α).

Further, where the inclination angle α is taken to be positive at an inclined plane on which the value of z increases when viewed from the observation direction (a rising inclined plane) and the inclination angle α is taken to be negative at an inclined plane on which the value of z decreases (a falling inclined plane), the intensity of scattered light can be expressed as I₀ cos(φ−α) for either plane.

Where a value obtained by dividing the intensity of scattered light in the direction of the observation angle φ of the inclined planes 812 and 813 by the intensity of scattered light in the direction of the observation angle φ of the plane 811 is defined as a contrast C(φ, α), the contrast can be represented by the following expression.

$$C ( φ , α ) = \frac{{I}_{0} cos ( φ - α ) - {I}_{0} ( φ + α )}{{I}_{0} cos φ} = 2 tan φ sin α \qquad [ Expression 6 ]$$

Values of the contrast C(φ, α) obtained by changing φ and α are shown in Table 1.

TABLE 1

| Observation | Inclination angle | |
|---|---|---|
| angle | of inclined plane | Contrast |
| φ [deg] | α [deg] | C(φ, α) |
| 0 | 1 | 0.0000 |
| 0 | 5 | 0.0000 |
| 0 | 10 | 0.0000 |
| 0 | 20 | 0.0000 |
| 10 | 1 | 0.0062 |
| 10 | 5 | 0.0307 |
| 10 | 10 | 0.0612 |
| 10 | 20 | 0.1206 |
| 20 | 1 | 0.0127 |
| 20 | 5 | 0.0634 |
| 20 | 10 | 0.1264 |
| 20 | 20 | 0.2490 |
| 30 | 1 | 0.0202 |
| 30 | 5 | 0.1006 |
| 30 | 10 | 0.2005 |
| 30 | 20 | 0.3949 |

It follows from Table 1, that when the observation angle φ is small, the contrast between the inclined planes 812 and 813 is low and is difficult to observe even when the inclination angle α is large, and as the observation angle φ increases, the contrast increases and becomes more easily observable even when the inclination angle α is small.

Explained hereinabove is the reason why the contrast of the specimen surface unevenness increases with the increase in the observation angle φ of the line of sight due to the light scattered on the specimen.

(Variation in Scattered Light Intensity when Viewpoint is Changed)

A variation in the scattered light intensity on the specimen surface when the viewpoint is changed will be explained.

FIG. 8A illustrates the case in which the edge direction of surface unevenness in the xy plane is orthogonal to the x axis, and the direction of high-low variations in the surface unevenness (direction perpendicular to the edge) matches the polar angle θ (θ=0) of a viewpoint. Meanwhile, FIG. 8B illustrates the case in which the direction of high-low variations in the surface unevenness does not match the x axis. As depicted in FIG. 8B, where an angle formed between the direction (821) perpendicular to the edge of the surface unevenness (820) and the x axis is taken as an unevenness direction angle β, when the unevenness direction angle β and the polar angle θ do not match, the surface unevenness 820 is observed from an oblique direction. In this case, an apparent inclination angle α′ of the inclined plane 813 and the inclined plane 812 in the direction opposite thereto, which are viewed from the observation direction having an angle expressed as the polar angle θ−β, is determined by:

$$tan {α}^{′} = \frac{tan α}{1 + tan ( \vert θ - β \vert )} \qquad [ Expression 7 ]$$

It follows from Expression 7 that the apparent inclination angle α′ is less than α and that the contrast C is decreased by a difference |θ−β| between the unevenness direction angle β and the polar angle θ.

It is noteworthy that the sign of the inclination angles α and α′ changes from positive to negative or from negative to positive at |θ−β| equal to 90 degrees as a boundary. This corresponds to an interchange between a rising inclined plane and a falling inclined plane depending on the observation direction obtained by changing a viewpoint polar angle. The inclination angle α′ is within a range from −α to +α and, for example, on the inclined plane 813, α′=α (rising inclined surface as viewed from the observation direction) when the viewpoint inclination angle is |θ−β|=0, and α′=α (falling inclined surface) when the viewpoint polar angle is |θ−β|=π.

Considered hereinbelow is a scattered light normalized intensity V(φ, α) obtained by normalizing the scattered light intensity at the inclined plane 813 observed from the direction with the viewpoint inclination angle of θ−β by the intensity of light observed at the plane 811. The intensity of light observed at the plane 811 is represented by Iₜₛ(φ) and taken as a function of the observation angle φ constituted by a sum of the intensity of transmitted light and the intensity of scattered light. Therefore, the scattered light normalized intensity V(φ, α) can be represented by the following expression.

$$V ( φ , α ) = \frac{{I}_{0} cos ( φ - α )}{{I}_{ts} ( φ )} = A ( φ ) \times cos α + B ( φ ) \times sin α \\ where , \\ A ( φ ) = \frac{{I}_{0} cos φ}{{I}_{ts} ( φ )} , B ( φ ) = \frac{{I}_{0} sin φ}{{I}_{ts} ( φ )} \qquad [ Expression 8 ]$$

Since it can be assumed that the inclination angle α of surface unevenness in a pathological specimen is sufficiently small, Expression 8 can be approximated in the following manner by using the approximate expressions cos_{α}=1 and sin_{α}=_{α}.

V(φ,α)≅A(φ)+α×B(φ) [Expression 9]

Values assumed by A(φ) and B(φ) are explained hereinbelow.

Since the light intensity Iₜₛ(φ) generally tends to decrease according to the observation angle due to the properties of the illumination optical system, where the transmitted light intensity at the inclination angle φ=0 is denoted as I₁ and the approximation of Iₜₛ(φ)=I₁ cos(φ) is used, an expression of A(φ)=I₀/I₁ is obtained. Where the intensity of scattered light is less than that of the transmitted light, A(φ) can be considered as a comparatively small constant. As for B(φ), when (φ)=0, it follows from sin φ=0 that B(φ)=0. Since it can be assumed that sin φ increases and light intensity Iₜₛ(φ) decreases with the increase in the observation angle φ, B(φ)) is an increasing function. Thus, B(φ))=I₀/I₁×tan φ is obtained where it is assumed that Iₜₛ(φ)=I₁ cos φ.

With the viewpoint image data calculated by the MFI arbitrary viewpoint/out-of-focus blur image generating method, the average brightness of image data is not changed, regardless of the viewpoint, due to the frequency filter processing that maintains an average. Therefore, it can be assumed that a value obtained by subtracting the transmitted light intensity affected by the transmittance of the stained segment from the brightness of the inclined plane 813 in the viewpoint image data is substantially equal to the normalized intensity V(φ, α).

(Variation in Transmitted Light Intensity when Viewpoint is Changed)

A variation in transmitted light intensity in viewpoint image data obtained by changing the viewpoints is considered hereinbelow.

In a region with a small difference in brightness with the adjacent substance in the specimen which is being observed (cytoplasm or a cell boundary), the difference in brightness is small and the effect produced on the transmitted light intensity is small even when the line-of-sight direction is different. Further, in a comparatively thin specimen having a thickness of about 4 μm, as in a pathological specimen for tissue diagnosis, the position of the object inside the specimen under observation does not change significantly in the viewpoint image data calculated when the specimen surface is brought into focus (in the viewpoint image data calculated by the MFI arbitrary viewpoint/out-of-focus blur image generating method, the object present close to the Z position Zf of the focused Z stack image data appears at about the same XY position in the viewpoint image data, regardless of the viewpoint; it can be also understood from the fact that blurring is reduced because there is no difference in the XY position in the image data obtained by combining the viewpoint image data of a plurality of viewpoints).

Therefore, it can be assumed that the difference in transmitted light intensity between the viewpoint image data obtained by changing the viewpoint position is very small, and the difference between the scattered light normalized intensities can be considered to be substantially equal to the difference between the viewpoint image data.

(Extraction of Information on Scattered Light at Specimen Surface from Viewpoint Image Data Obtained by Changing Viewpoint Polar Angle θ)

Considered hereinbelow is the extraction of information on scattered light at the specimen surface by computations of viewpoint image data obtained by changing the polar angle θ.

According to Expression 7, in the predetermined surface unevenness with an inclination angle α that is denoted by 813 in FIG. 8, where the difference |θ−β| between the unevenness direction angle β and the polar angle θ is 0 degrees, the inclination angle is α and the scattered light normalized intensity V (φ, α) is at a maximum. Meanwhile, where |θ−β| is 180 degrees, the apparent inclination angle α′ is equal to −α and the scattered light normalized intensity V (φ, α) is at a minimum.

Therefore, it is clear that where subtraction is performed between the viewpoint image data in which |θ−β| is 0 degrees and the viewpoint image data in which |θ−β| is 180 degrees, it is possible to extract effectively (part of) information on the scattered light at the specimen surface. This is represented by the following expression.

V(φ,α)−V(φ,α′)≅(α−α′)×B(φ)=2α×B(φ) [Expression 10]

(where α′=−α when |θ−β|=π).

Since the inclination angle α and the unevenness direction angle β of the surface unevenness of the specimen can take various values, it is clear that information on the scattered light at the specimen surface can be extracted by obtaining a difference between the viewpoint image data of the viewpoints with the inclination angles φ that differ by 180 degrees among a variety of viewpoints for which the inclination angle φ has been changed and combining the results obtained.

It follows from Expression 10 that information on the scattered light can be also extracted by computations other than those between the viewpoint image data of the viewpoints with the inclination angles φ that differ by 180 degrees. For example, α′=0 when |θ−β|=π/2 (90 degrees), and α×B(φ) can be extracted from the difference between the viewpoint image data.

The information on the scattered light at the specimen surface can be extracted not only by subtraction, but also by division. Thus, since the value of V(φ, α)/V(φ, α′) changes according to the inclination angle α, this value can be said to be an indicator representing the information on scattered light.

(Extraction of Information on Scattered Light at Specimen Surface from Viewpoint Image Data Obtained by Changing Viewpoint Observation Angle φ))

Considered hereinbelow is the extraction of information on scattered light at the specimen surface by computations between viewpoint image data obtained by changing the observation angle φ, which is similar to the above-described extraction related to the polar angle θ.

The subtraction between two viewpoint image data with the observation angles φ and φ′ can be represented by the following expression (it is approximated that A(φ)=A(φ′)).

V(φ,α)−V(φ′,α)≅α×(B(φ)−B(φ′)) [Expression 11]

As has already been mentioned hereinabove, since B(φ) is a function increasing with the increase in φ, it is clear that (part of) information on scattered light at the specimen surface can be extracted by computations between two viewpoint image data obtained by changing the observation angle φ. Since B(φ) takes a value of 0 when φ=0, the subtraction of the viewpoint image data with the observation angle φ and the viewpoint image data with the observation angle φ′ equal to 0 is most effective.

Since the unevenness direction angle β takes various values, it is clear that, in the same manner as in the above-described case of the polar angle θ, information on the scattered light at the specimen surface can be extracted by obtaining a difference between the viewpoint image data not only at the viewpoints obtained by changing the observation angle φ, but also at the viewpoints obtained by changing the polar angle θ and collecting the results obtained.

The information on the scattered light at the specimen surface can be extracted not only by subtraction, but also by division. It follows from the explanation hereinabove that the brightness of viewpoint image data at the observation angle φ can be approximated by α×B(φ) +D (D is a constant) and, therefore, the division of the brightness between the viewpoint image data obtained by changing the observation angles φ can be represented as:

$$D I V ( φ , {φ}^{′} ) ≅ \frac{α \times B ( φ ) + D}{α \times B ( {φ}^{′} ) + D} \qquad [ Expression 12 ]$$

DIV(φ, φ′) is 1 when α is 0, and the intensity changes according to the value of α when α is not 0. Therefore, information on the inclination angle α can be also extracted by the division DIV(φ, φ′).

In the same manner as in the case of subtraction, information on the scattered light at the specimen surface can be extracted by performing the division between the viewpoint image data of various viewpoints obtained by changing not only the observation angle φ, but also the polar angle θ and collecting the results obtained.

Image data (microscopic image data) captured with a transmission microscope, as in the present example, include a transmitted light component created by the light transmitted by the specimen and a scattered light component created by the light scattered at the specimen surface, or the like. Since the intensity of the transmitted light component depends of the light transmittance of the specimen, this intensity represent the difference in color or a difference in refractive index inside the specimen. Meanwhile, as mentioned hereinabove, the intensity of the scattered light component mainly depends on the unevenness (surface profile) of the specimen surface. In the microscopic image data serving as original image data, the transmitted light component is predominant and the scattered light component is hardly recognizable, but the scattered light component can be extracted or enhanced by extracting or enhancing the difference between a plurality of viewpoint image data that differ in the observation direction, as mentioned hereinabove. In other words, the “difference” and “ratio” of two viewpoint image data with different observation directions can be said to be feature amounts representing the scattered light component (information on scattered light) included in the original image data.

The “enhancement” is an operation of highlighting (with respect to the original state) a certain portion, and the “extraction” is an operation of taking out only a certain portion, but from the standpoint of focusing attention on a certain portion, those operations are the same. For this reason, in the present description, the two terms are sometimes not distinguished from each other. The operation of enhancing a scattered light component corresponds not only to an operation of increasing the intensity of the scattered light component in the image data, but also to an operation of relatively increasing the intensity of the scattered light component by decreasing the intensity of the transmitted light component in the image data. Image data obtained by extracting or enhancing the scattered light component (information on scattered light) included in the image data are referred to hereinbelow as scattering image data or feature image data. An operation of generating scattering image data from the original image data is referred to as scattering image data generation (feature image data generation).

Further, in the present invention, image data obtained by extracting the scattered light from a subject, from among the scattering image data, are referred to as scattered light extraction image data, and image data obtained by enhancing the scattered light from a subject, from among the scattering image data, are referred to as scattered light enhancement image data.

Further, subtraction and division are presented hereinabove as examples of computations performed to extract or enhance the difference between the viewpoint image data, but any kind computation capable of enhancing the difference between image data may be used.

Scattering image data can be expected to be valuable as observation image data suitable for observations of unevenness (surface profile) of a specimen surface and for diagnosis based thereupon. For example, even when unevenness is present on the surface of a certain region in a specimen, where the transmittance in the region is substantially uniform, the brightness or color of this region becomes uniform, and the unevenness cannot be visually recognized. Scattering image data are particularly effective for visualizing such surface unevenness (surface unevenness that does not appear as a change in brightness or color). Further, since a cell boundary and a boundary of a cell and a sinusoid are also examples of unevenness, the scattering image data are also effective for clarifying those boundaries. Edge extraction (enhancement) is a type of processing for extracting or enhancing image features, but surface unevenness which does not appear as a change in brightness or color of the image cannot be visualized by the edge extraction (enhancement). Therefore, the scattering image data extraction and edge extraction may be used selectively according to which structure or feature of the specimen is to be observed.

Explained hereinabove is mainly the case in which the scattered light is generated at the specimen surface, but the observation object is not necessarily limited to the specimen surface. Thus, where a substance which has a refractive index different from that of surroundings and causes scattering is present at a position (Z=Zf) which has been brought into focus, such scattering can be considered similarly to the scattering phenomenon on the specimen surface and the observation can be performed using the scattering image data.

(Three-Dimensional Image Formation Relationship in MFI Arbitrary Viewpoint/Out-of-focus blur image Generating Method)

Described hereinabove are the features of the light scattered on the subject surface (surface brought into focus). However, transmitted light is also present, in addition to the scattered light, at the subject. The three-dimensional image formation relationship in the MFI arbitrary viewpoint/out-of-focus blur image generating method is initially described below to determine the effect of the transmission light in the viewpoint image data.

In the MFI arbitrary viewpoint/out-of-focus blur image generating method, a relationship is valid in which an out-of-focus blur image group (Z stack image data) subjected to coordinate transform is represented by convolution of a three-dimensional subject and three-dimensional out-of-focus blur. Where the three-dimensional subject is denoted by f(X, Y, Z), the three-dimensional out-of-focus blur is denoted by h(X, Y, Z), and the out-of-focus blur image group (Z stack image data) subjected to coordinate transform is denoted by g(X, Y, Z), the following expression is valid:

g(X,Y,Z)=f(X,Y,Z)***h(X,Y,Z) [Expression 13]

(where *** represents three-dimensional convolution)

FIGS. 10A to 10F are schematic diagrams indicating the difference between Z stack image data obtained when an object is present at different Z positions of a three-dimensional subject. In a three-dimensional subject 1001, the object is present at a position Z=Zf, and in a three-dimensional subject 1011, the object is present at a position Z=Zo.

By capturing the images of the three-dimensional subjects 1001 and 1011 while changing the focusing position in the Z direction by using an optical system having a three-dimensional out-of-focus blur 1002, it is possible to obtain Z stack image data 1003 and 1013, respectively (since the three-dimensional out-of-focus blur h(X, Y, Z) is shift-invariably transformed, it remains the same). It is obvious that image data with the smallest out-of-focus blur are obtained at the position Z=Zf in the Z stack image data 1003 and at the position Z=Zo in the Z stack image data 1013.

(Computation of Arbitrary Viewpoint Image Data in MFI Arbitrary Viewpoint/Out-of-Focus Blur Image Generating Method)

Methods disclosed in PTL 1 and NPLs 2-4 are known as the MFI arbitrary viewpoint/out-of-focus blur image generating methods. An arbitrary viewpoint image data generating method based on the method disclosed in NPL 2 will be explained hereinbelow by way of example.

Viewpoint image data observed from a line-of-sight direction corresponding to a viewpoint (s, t) are denoted by a_{s,t}(X, Y, Zf). The viewpoint image data a_{s,t}(X, Y, Zf) are obtained by deconvoluting integration image data b_{s,t}(X, Y, Zf) of Z stack image data in the same line-of-sight direction with an integration value c_{s,t}(X, Y, Zf) of the three-dimensional out-of-focus blur of the imaging optical system in the same line-of-sight direction (the relationship explained in FIG. 10, that is, the relationship according to which g(X, Y, Z) is obtained by convolution of f(X, Y, Z) and h(X, Y, Z) is valid regardless of the integration in the line-of-sight direction).

When represented by an expression, the following relationship is valid.

A_{s,t}(u,v)=B_{s,t}(u,v)×C_{s,t}(u,v)⁻¹ [Expression 14]

Here, A_{s,t}(u, v), B_{s,t}(u, v), and C_{s,t}, (u, v) are Fourier transforms of a_{s,t}(X, Y, Zf), b_{s,t}(X, Y, Zf), and c_{s,t}(X, Y, Zf), respectively, and u and v are frequency coordinates corresponding to variations in the X and Y directions, respectively.

a_{s,t}(X, Y, Zf) can be obtained from the following expression.

a_{s,t}(X,Y,Zf)=F⁻¹{B_{s,t}(u,v)×C_{s,t}(u,v)⁻¹} [Expression 15]

where F⁻¹{ } is inverse Fourier transform.

The relationship between arbitrary viewpoint image data and arbitrary viewpoint out-of-focus blur data in the MFI arbitrary viewpoint/out-of-focus blur image data generating method is explained hereinbelow.

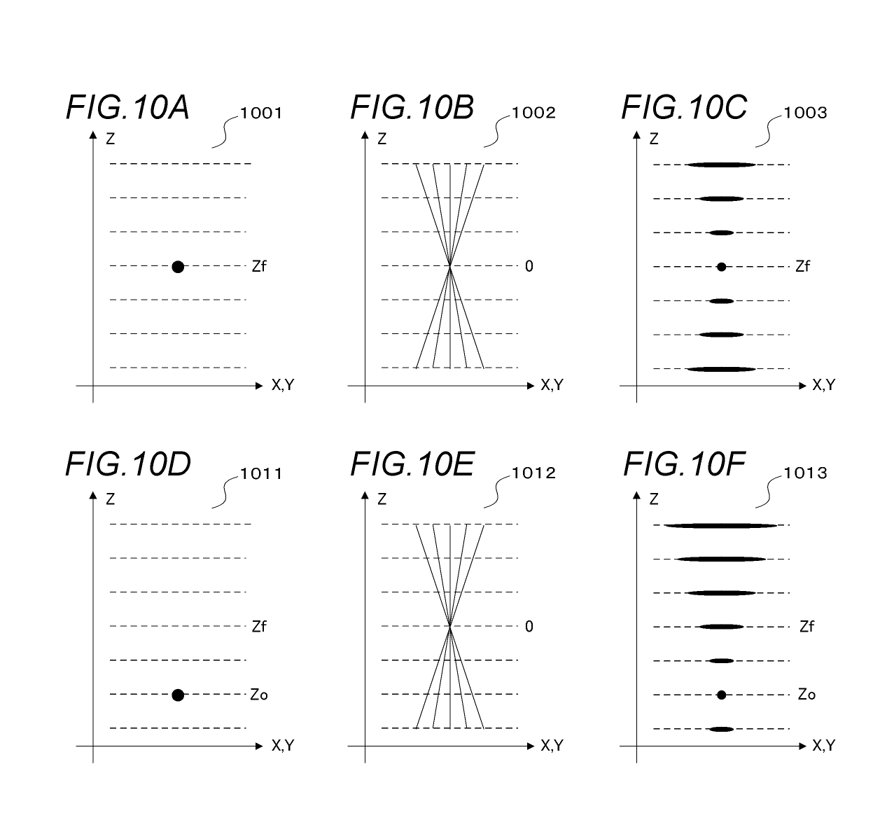

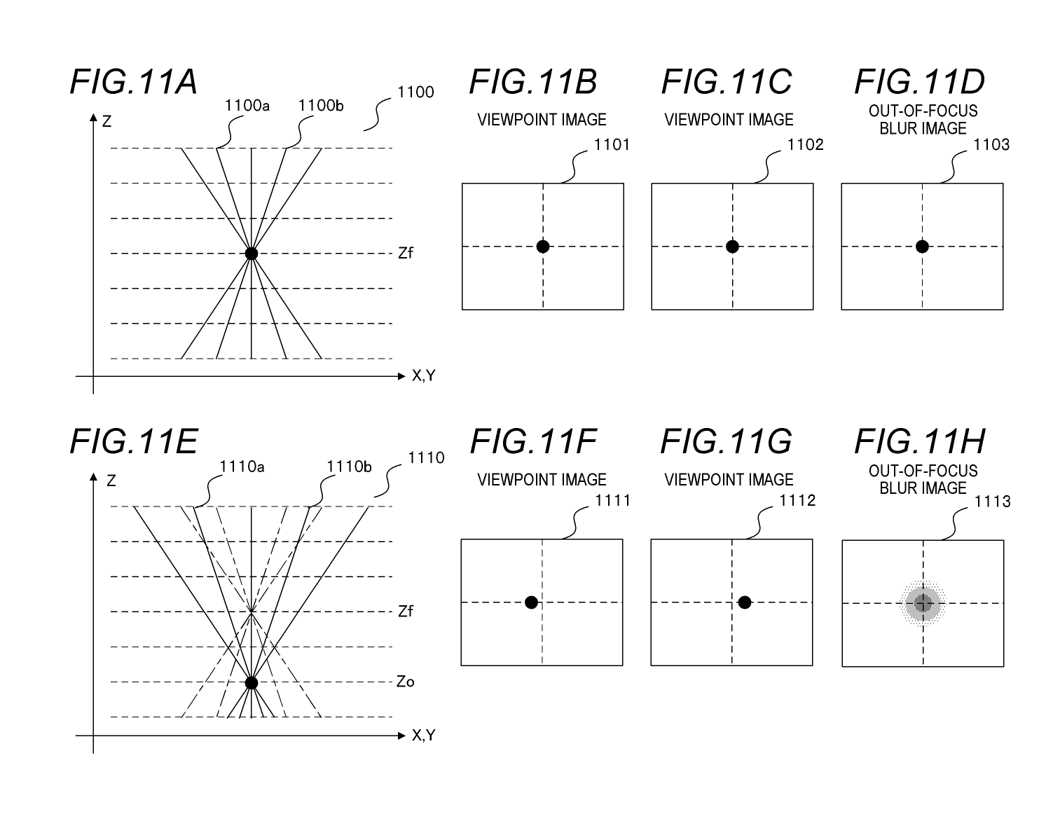

FIGS. 11A to 11H are schematic diagrams illustrating the relationship between arbitrary viewpoint image data and arbitrary viewpoint out-of-focus blur data obtained by the MFI arbitrary viewpoint/out-of-focus blur image data generating method when an object is present at different Z positions of three-dimensional subjects.

Reference numeral 1100 in FIG. 11A and reference numeral 1110 in FIG. 11E denote three-dimensional subjects. The same is true with respect to 1001 in FIG. 10A and 1011 in FIG. 10D. The light beams represented by solid lines in three-dimensional subjects 1100 and 1110 represent light beams passing through the objects in the subjects and also through the respective predetermined viewpoint on the lens plane of the optical system. The broken line in FIG. 11E corresponds to the solid line in FIG. 11A.

Light beams 1100a and 1110a pass through the viewpoint (a) located on the lens plane, and viewpoint image data observed from the light-of-sight direction corresponding to the viewpoint such that the position Z=Zf becomes the focusing position become 1101 in FIG. 11B and 1111 in FIG. 11F, respectively. Likewise, light beams 1100b and 1110b pass through the viewpoint (b) located on the lens plane, and viewpoint image data observed such that the position Z=Zf becomes the focusing position become 1102 in FIG. 11C and 1112 in FIG. 11G, respectively.

In viewpoint image data 1101 and 1102, the images of the object appear at the same position. By contrast, in the viewpoint image data 1111 and 1112, the images of the object do not appear at the same position and are shifted by an amount determined by the line-of-sight direction and a distance dZ (=Zo−Zf) between Zf and Zo.

In the MFI arbitrary viewpoint/out-of-focus blur image generating method, layer image data g(X, Y, Zf) at the position Z=Zf of the Z stack image data can be represented by the following expression.

g(X,Y,Zf)=∫∫k(s,t)×a_{s,t}(X,Y,Zf)dsdt [Expression 16]

Here, k(s, t) is a function indirectly representing the three-dimensional out-of-focus blur of the imaging optical system and represents the relative intensity distribution of the light beam passing through each viewpoint (s, t) on the lens plane. The following relationship is valid between k(s, t) and h(X, Y, Z).

h(X,Y,Z)=∫∫k(s,t)×δ(X+s×Z,Y+t×Z)dsdt [Expression 17]

k(s, t) is assumed to be normalized such that the sum at all of the viewpoints (s, t) present on the lens plane takes a value of 1, as indicated by the following expression.

∫∫k(s,t)dsdt=1 [Expression 18]

Moreover, a_{s,t}(X, Y, Zf) in Expression 16 represents viewpoint image data at Z=Zf. It is clear from Expression 16 that by weighting and combining a plurality of viewpoint image data at a certain Z position (Z=Zf), it is possible to reconfigure image data having arbitrary out-of-focus blur at the Z position (Z=Zf), that is the arbitrary out-of-focus blur image data.

In the description hereinbelow, a function defining a weight for each viewpoint (s, t) (each line-of-sight direction) when a plurality of image data is combined together, as k(s, t), is called a “viewpoint weighting function”. The viewpoint weighting function can be also said to originate from a certain point on the subject and represent a relative intensity distribution of the light beam passing through the viewpoint (s, t). The abovementioned k(s, t) is a viewpoint weighting function having properties corresponding to the three-dimensional out-of-focus blur of the imaging optical system used for capturing the images of the subject. Any kind of function may be used as the viewpoint weighting function. For example, a kₐ(s, t) function corresponding to an arbitrary three-dimensional out-of-focus blur for generating arbitrary out-of-focus blur image data in the MFI arbitrary viewpoint/out-of-focus blur image generating method can be also used as the viewpoint weighting function. A function of an arbitrary shape such as a columnar shape described in the examples hereinbelow can be also used as the viewpoint weighting function.

Further, Expression 16 is described using an integral f that means integration of continuous values, but in the actual image processing, computations are performed with respect to a plurality of (finite number of) discreet viewpoints (s, t). Therefore, the description with sigma E is correct. However, since the integral ∫ enables generalization, the integral ∫ is also used in the explanation below. Where (finite number of) discrete viewpoints are present, Expression 18 represents normalization performed such that a sum of all viewpoint weighting functions k(s, t) or kₐ(s, t) used in the calculations is 1.

(Blurred Image at Z=Zf)

Layer image data at the position Z=Zf of the Z stack image data are obtained from the viewpoint image data at Z=Zf by using the MFI arbitrary viewpoint/out-of-focus blur image generating method.

In this case, it is assumed that a point object is present on the optical axis of the optical system in the three-dimensional objects 1001 and 1011 and that the viewpoint image data (all-in-focus image data) viewed from a viewpoint passing through the optical axis are represented by the following expression.

I(X,Y,Zf)=(a−b)×δ(X,Y)+b [Expression 19]

Here, δ is a Dirac delta function, a is the intensity (pixel value) of the point object, and b is the intensity of the background.

The layer image data at the position Z=Zf of the Z stack image data at the time the images of the three-dimensional subjects 1001 and 1011 are captured are determined hereinbelow by using Expression 16.

(Layer Image Data at Z=Zf of Three-Dimensional Subject 1001)

Where it is assumed that the thickness of the object can be ignored, the viewpoint image data a_{s,t}(X, Y, Zf) in Expression 16 are represented by I(X, Y, Zf) regardless of the viewpoint position (s, t). Therefore, the layer image data represented by the following expression can be obtained by substituting Expression 19 into Expression 16 and performing transformations.

g(X,Y,Zf)=(a−b)×δ(X,Y)+b [Expression 20]

(Layer Image Data at Z=Zf of Three-Dimensional Subject 1011)

Likewise, where it is assumed that the thickness of the object can be ignored, the viewpoint image data a_{s,t}(X, Y, Zf) in Expression 16 are represented by translation of I(X, Y, Zf). Therefore, the following expression is obtained by translating Expression 19 according to the viewpoint (s, t) and the distance dZ between the subject and the focusing position, substituting into Expression 16, and performing transformations using Expression 17 and Expression 18.

g(X,Y,Zf)=(a−b)×h(X,Y,dZ)+b [Expression 21]

(where, dZ=Zo−Zf)

It can be seen that an out-of-focus blur caused by the shift dZ of the object and focusing position is included in the Z stack image data g(X, Y, Zf).

Out-of-focus blur image data (layer image data) 1103, 1113 depicted in FIGS. 11D and 11H are schematic views of layer image data at Z=Zf obtained from a plurality of viewpoint image data corresponding to a multiplicity of viewpoints that have been set on the lens plane. The layer image data 1103 represent image data corresponding to Expression 20, and layer image data 1113 represent image data corresponding to Expression 21.

In the layer image data 1103, the viewpoint image data for which the position of the object image has not shifted are multiplied by the viewpoint weighting functions, and the weighted data equal in number to the number of the viewpoints are combined. Therefore, a blur-free image is obtained. Meanwhile, in the layer image data 1113, the viewpoint image data for which the position of the object image has shifted are multiplied by the viewpoint weighting functions, and data equal in number to the number of the viewpoints are combined. Therefore, an image including the blur of the optical system is obtained.

Where the shift dZ of the subject from the focusing position is present, the shift of the object image position is generated in each of the viewpoint image data, and the difference in brightness between the object and the surroundings becomes (a−b). Therefore, it is clear that the difference between the viewpoint image data increases with the increase in dZ and difference in brightness (a−b).

(Method for Extracting Scattering Image Data Using Viewpoint Image Data)

Explained hereinbelow is a method for extracting scattering image data using viewpoint image data.

Where the shift dZ of the subject from the focal point is taken to be 0, the scattering image data can be extracted, as has already been explained with Expression 10, by performing subtraction between the viewpoint image data of the predetermined viewpoint (s, t) and the viewpoint image data of the viewpoint at the same observation angle φ and at a polar angle θ that is different by 180 degree.

The explanation below uses expressions.

(Computation Between Viewpoint Image Data with Different Polar Angles θ)

Where the coordinates of the viewpoint P0 of the processing object are taken as (x, y)=(sₚ, tₚ) in the coordinate system depicted in FIG. 7A, the coordinates of the viewpoint P1 rotated through 180 degrees become (x, y)=(−sp, −tp) (the extraction of viewpoint image data is also possible at a rotation angle of the polar angle other than 180 degrees, but explained herein is the case of 180-degree rotation which yields a maximum effect).

Viewpoint image data observed from the line-of-sight direction of the viewpoint P0 such that the position Z=Zf becomes the focusing position are taken as I_{P0} (X, Y, Zf), and viewpoint image data observed from the line-of-sight direction of the polar-angle-rotated viewpoint P1 such that the position Z=Zf becomes the focusing position are taken as I_{P1} (X, Y, Zf). Viewpoint scattering image data which are scattering image data obtained from the viewpoint image data of the viewpoint P0 are taken as S_{P0} (X, Y, Zf).

In this case, information on the scattered light at the specimen surface can be extracted by computations indicated by the following Expression 22 or Expression 23.

$$\begin{matrix} {S}_{P 0} ( X , Y , Zf ) = \frac{1}{2} \times \vert {D}_{1} ( X , Y , Zf ) \vert \\ {D}_{1} ( X , Y , Zf ) = {I}_{p 0} ( X , Y , Zf ) - {I}_{P 1} ( X , Y , Zf ) & [ Expression 22 ] \\ {S}_{p 0} ( X , Y , Zf ) = \{ \begin{matrix}{D}_{1} ( X , Y , Zf ) : {D}_{1} ( X , Y , Zf ) \geq 0 \\ 0 : {D}_{1} ( X , Y , Zf ) < 0\end{matrix} \\ {D}_{1} ( X , Y , Zf ) = {I}_{P 0} ( X , Y , Zf ) - {I}_{P 1} ( X , Y , Zf ) & [ Expression 23 ]\end{matrix}$$

Multiplication by a factor of ½ in Expression 22 is performed to prevent the intensity from being doubled due to simultaneous extraction, by absolute values, of the scattered light which increases when observations are performed from the line-of-sight directions corresponding to the viewpoint P0 and viewpoint P1, respectively. In Expression 23, pixels with the intensity of viewpoint image data of the viewpoint P0 larger than those on the viewpoint P1 are assumed to be the pixels where strong light scattering has been generated, and only values of pixels with a positive difference are used.

The reason why information on scattered light at the specimen surface can be extracted by computations with Expressions 22 and 23 is explained below. As has already been mentioned hereinabove, the intensity variations of the transmitted light in the viewpoint image data obtained by changing the viewpoint are small, but brightness variations caused by the scattered light at the specimen surface increase with the polar angle θ. Therefore, by performing subtraction between viewpoint image data obtained by changing the viewpoint, it is possible to cancel the transmitted light component in the image data and extract the scattered light component (information on the scattered light). It is also possible not to cancel the entire transmitted light component. Where the intensity of the transmitted light component in the image data is reduced and image data in which the scattered light component in the image data is relatively enhanced are obtained, this operation also can be referred to as generation of scattering image data.

Where the polar angle rotation angle is 180 degrees, the scattered light from the surface unevenness having an unevenness direction angle at which the scattered light reaches a maximum at the polar angle of the viewpoint P0 reaches a minimum at the polar angle of the viewpoint P1. Likewise, the scattered light from the surface unevenness having an unevenness direction angle at which the scattered light reaches a maximum at the polar angle of the viewpoint P1 reaches a minimum at the polar angle of the viewpoint P0.

Therefore, where a difference D₁ (X, Y, Zf) between viewpoint image data of the viewpoint P0 and the viewpoint image data of the viewpoint P1 is determined, the information on the scattered light at the surface unevenness having an unevenness direction angle at which the scattered light reaches a maximum at the polar angles of the viewpoints P0 and P1 can be extracted as image data.

In Expressions 22 and 23, the absolute value or positive value of the difference D₁(X, Y, Zf) is used for computing the image data scattering image data S_{P0} (X, Y, Zf) because nonlinearity is required in the processing of combining a plurality of viewpoint scattering image data obtained from the viewpoint image data. The operation of obtaining differences between viewpoint image data of a variety of viewpoints and then finding the sum of the differences, without taking the absolute values, is equivalent to the operation of finding the sum of viewpoint image data of various viewpoints and then obtaining the differences. In this case, the viewpoint image data cancel each other and the obtained combination image is substantially 0. Therefore, a nonlinear function is used in the image data scattering image data S_{P0} (X, Y, Zf) to prevent the aforementioned mutual cancellation.

The nonlinear function is assumed to have a property such that a result obtained by applying the function to predetermined image data (viewpoint image data) and then adding up a plurality of image data does not match a result obtained by adding up a plurality of predetermined image data (viewpoint image data) and then applying the function.

Σᵢ₋₁^{N}S(D(i))≠S(Σᵢ₌₁^{N}D(i)) [Expression 24]

Here, N is the number of viewpoints, Di is differential image data of the viewpoint image data in a viewpoint i and polar-angle-rotated viewpoint image data, S( ) is a function corresponding to the expression for obtaining S_{P0} (X, Y, Zf) in Expressions 22 and 23, respectively.

Image data obtained by integrating viewpoint scattering image data S_{P0} (X, Y, Zf) in Expressions 22 and 23, that is, scattering image data DS(X, Y, Zf), are considered hereinbelow with respect to a variety of viewpoints. The expression for obtaining the scattering image data DS(X, Y, Zf) is represented below.

DS(X,Y,Zf)=∫∫k(s,t)×S_{P0}(X,Y,Zf)dsdt [Expression 25]

where k(s) is an arbitrary weight function.

Where the integration of Expression 25 is performed with respect to a variety of viewpoints (s, t), the scattered light components in various directions can be combined together.

In the computations by Expression 22, the viewpoint scattering image data I_{P0} (X, Y, Zf) of the viewpoint P0 and the viewpoint scattering image data (X, Y, Zf) of the viewpoint P1 are equal to each other. Therefore, the same result as that obtained with Expression 25 can be obtained by obtaining the viewpoint scattering image data with respect to half of the viewpoints from among all of the viewpoints (s, t) which are to be integrated and multiplying the weighted integral thereof by a factor of 2. In other words, the merit of using Expression 22 is that the volume of integration computations is reduced by about a half. Meanwhile, since Expression 23 also includes information in the observation direction at a position in which the scattered light is to be extracted, this formula is effective when the relationship between the observation direction and the scattered light intensity is to be understood. However, where the computations by Expression 23 are performed with respect to a large number of viewpoints obtained by changing the polar angle θ and observation angle φ within possible ranges on the lens plane, the results obtained using Expressions 22 and 23 are the same.

(Computations Between Viewpoints with Different Observation Angles φ))

As has already been explained with reference to Expression 11, scattering image data can be extracted by subtraction between viewpoint image data of a certain viewpoint (s, t) and viewpoint image data of a viewpoint with the same polar angle θ and a different observation angle φ or a viewpoint (0, 0).

Between the viewpoint image data obtained by changing the observation angle φ, scattering image data can be also generated by obtaining the observation-angle-changed viewpoint P1 from the viewpoint P0, performing the computations indicated by Expression 22 or 23, and executing the integration of Expression 25. However, when the observation angle φ is changed, the scattering image data can be also generated by separate computations. This is explained hereinbelow.

Where the coordinate of the viewpoint P0 which is the processing object is taken as (x, y)=(sₚ, tₚ) in the coordinate system depicted in FIG. 7A, the coordinate of the viewpoint P1 in which the observation angle φ takes a value of 0 is (x, y)=(0, 0) (the extraction of scattering image data is possible even when the angle obtained by changing the observation angle is other than 0 degrees, but in the case described herein, the viewpoint P1 is used in which the observation angle with the maximum effect is 0 degrees).

When the viewpoint P0 and the viewpoint P1 are in the aforementioned relationship, the scattered light can be extracted with the following expression. S_{P0} (X, Y, Zf) are viewpoint scattering image data of the viewpoint P0.

S_{P0}(X,Y,Zf)=I_{P0}(X,Y,Zf)−I_{P1}(X,Y,Zf) [Expression 26]

By contrast with the case in which the polar angle θ is rotated, it is not always necessary to use nonlinear computations. This is because when the observation angles φ of the viewpoint P0 and the viewpoint P1 differ from each other, the results obtained by calculating the integrals at viewpoints with different polar angles θ (that is, viewpoints with equal radius vectors rₚ in FIG. 7A) are not equal to each other, and therefore 0 is not obtained in calculations by Expression 26.

Where the radius vector r of the viewpoint P0 is denoted by r1 and the radius vector r of the viewpoint P1 is denoted r2, the scattering image data obtained by executing the integration at different polar angles θ can be represented by the following expression.

DS(X,Y,Zf)=∫S_{P0}(X,Y,Zf)dθ=∫I_{P0}(X,Y,Zf)dθ−∫I_{P1}(X,Y,Zf)dθ [Expression 27]

The integral at a viewpoint position with a radius vector r can be represented by a viewpoint weighting function having a value only at the viewpoint with the radius vector r. Therefore, where Expression 27 is transformed, the transformation can be performed with the following expression.

$$\begin{matrix}DS ( X , Y , Zf ) = \int \int {k}_{a 1} ( s , t ) \times {I}_{P 0} ( X , Y , Zf ) d s d t - \\ \int \int {k}_{a 2} ( s , t ) \times {I}_{P 0} ( X , Y , Zf ) d s d t \\ = \int \int {k}_{ex} ( s , t ) \times {I}_{P 0} ( X , Y , Zf ) d s d t\end{matrix} \qquad [ Expression 28 ]$$

where kₑₓ(s, t) is

kₑₓ(s,t)=kₐ₁(s,t)−kₐ₂(s,t) [Expression 29]

Since the integrals of the viewpoint weighting functions kₐ₁(s, t) and kₐ₂(s, t) with respect to all of the viewpoints are each 1, the integral of kₑₓ(s, t) with respect to all of the viewpoints is 0.

∫∫kₑₓ(s,t)dsdt=0 [Expression 30]

As has already been indicated with respect to Expression 11, in order to extract differential information on scattered light, it is necessary that the observation angle φ of I_{P0} (X, Y, Zf) be larger than the observation angle φ of (X, Y, Zf).

Therefore, generalizing, a condition for extracting information on scattered light which uses a predetermined radius vector rₜₕ as a threshold is that kₑₓ(s, t) should have a positive value in a region with a radius vector larger than rₜₕ (that is, a region with a large observation angle φ) and a negative value in a region with a radius vector equal to or less than rₜₕ. In this case, the intensity of generated scattering image data increases as the threshold rₜₕ decreases. rₜₕ=0 can be considered as an example of effective condition. In this case, the conditions for kₑₓ (s, t) can be represented by the following expressions.

$$\int \int {k}_{ex} ( s , t ) outr ( s , t , {r}_{th} ) d s d t > 0 \\ \int \int {k}_{ex} ( s , t ) inr ( s , t , {r}_{th} ) d s d t < 0 \\ outr ( s , t , {r}_{th} ) = \{ \begin{matrix}0 : \sqrt{{s}^{2} + {t}^{2}} \leq {r}_{th} \\ 1 : \sqrt{{s}^{2} + {t}^{2}} > {r}_{th}\end{matrix} \\ inr ( s , t , {r}_{th} ) = \{ \begin{matrix}1 : \sqrt{{s}^{2} + {t}^{2}} \leq {r}_{th} \\ 0 : \sqrt{{s}^{2} + {t}^{2}} > {r}_{th}\end{matrix} \qquad [ Expression 31 ]$$

However, rₜₕ is a predetermined value satisfying the condition of rₜₕ≦rₘ. Here, rₘ is the distance of a most external viewpoint on the lens plane, from among the viewpoints used for calculating the scattering image data, from the point of origin (0, 0).

kₑₓ(s, t) can be set freely where the conditions of Expressions 30 and 31 are fulfilled.

It is clear from Expression 28 that scattering image data can be calculated by a difference between two arbitrary out-of-focus blur image data having different out-of-focus blur and generated using kₐ₁(s, t) and kₐ₂(s, t). The scattering image data can be also calculated from arbitrary out-of-focus blur image data generated using kₑₓ(s, t) that fulfil the conditions of Expressions 30 and 31. The viewpoint weighting function calculated with Expression 29 or the viewpoint weighting function kₑₓ(s, t) that fulfils the conditions of Expressions 30 and 31 is referred to hereinbelow as a viewpoint weighting function for scattered light information extraction.

(Enhancement of Scattered Light and Reduction of Out-of-Focus Blur in Scattering Image Data)

As has already been mentioned hereinabove, the position of a subject in the viewpoint image data changes when the subject is at a position at a distance from the focusing position, as depicted in FIG. 10D. Therefore, the effect of out-of-focus blur of the subject at a distance from the focusing position is also included in the scattering image data obtained by calculations with Expression 25 or 28.

The following expression is used to reduce the effect of out-of-focus blur while enhancing the scattered light in the scattering image data.

DS(X,Y,Zf)=∫∫kₑₓ(s,t)×C_{P0}(X,Y,Zf)dsdt [Expression 32]

Here, C_{P0} (X, Y, Zf) are image data represented by an expression below, that is, image data obtained by adding scattering image data of the viewpoint P0 to the viewpoint image data of the same viewpoint P0. The C_{P0} (X, Y, Zf) are referred to hereinbelow as scattered light enhancement image data of viewpoint P0.

C_{P0}(X,Y,Zf)=I_{P0}(X,Y,Zf)+S_{P0}(X,Y,Zf) [Expression 33]

S_{P0}(X, Y, Zf) in Expression 33 are viewpoint scattering image data represented by Expression 22 or 23.

The transformed Expression 32 can be represented by the following expression.

$$DS ( X , Y , Zf ) = \int \int {k}_{a 1} ( s , t ) \times \{ {I}_{P 0} ( X , Y , Zf ) + {S}_{P 0} ( X , Y , Zf ) \} d s d t - \int \int {k}_{a 2} ( s , t ) \times \{ {I}_{P 0} ( X , Y , Zf ) + {S}_{P 0} ( X , Y , Zf ) \} d s d t \qquad [ Expression 34 ]$$

Thus, Expression 32 corresponds to a difference between scattered light enhancement image data.

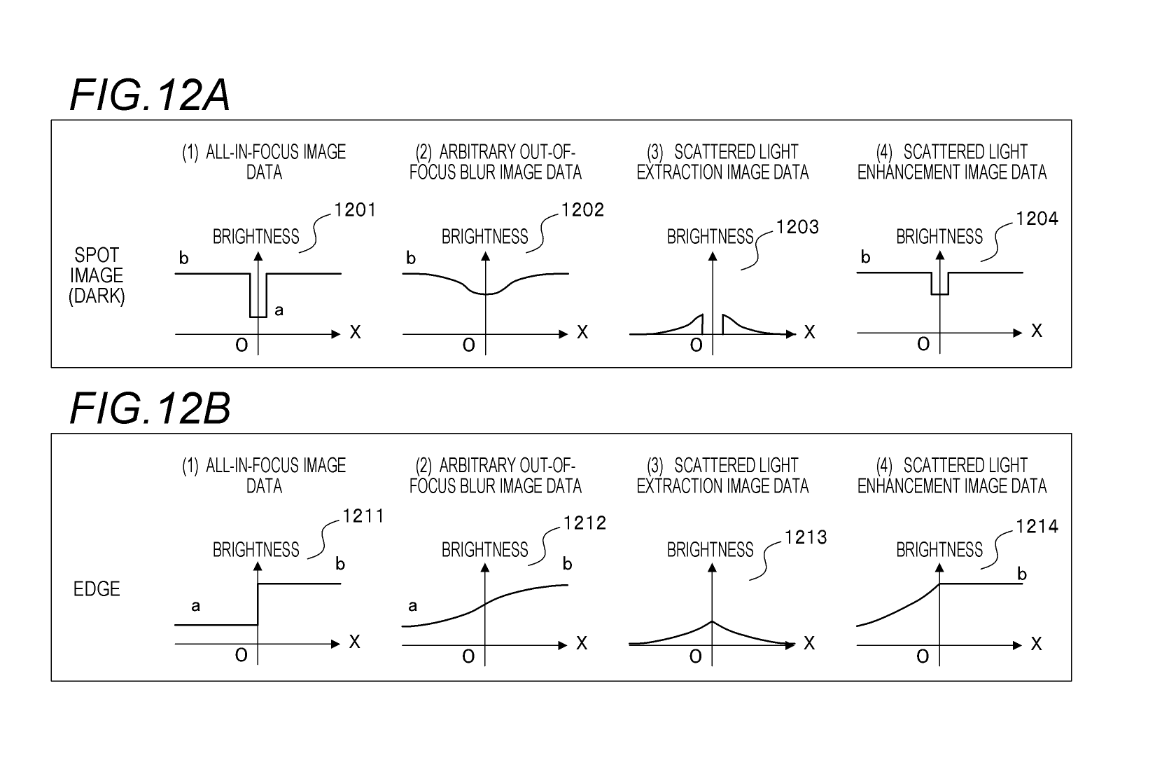

The reason why the scattered light can be enhanced and the out-of-focus blur can be reduced by the difference between scattered light enhancement image data in Expression 34 is explained hereinbelow with reference to FIGS. 12A and 12B.

FIG. 12A depicts: (1) all-in-focus image data, (2) arbitrary out-of-focus blur image data, (3) scattered light extraction image data, and (4) scattered light enhancement image data, all those data relating to the case in which the subject is a position at a distance from the focusing position and is a point image with a brightness value lower than that of surroundings. FIG. 12B depicts: (1) all-in-focus image data, (2) arbitrary out-of-focus blur image data, (3) scattered light extraction image data, and (4) scattered light enhancement image data, all those data relating to the case in which the subject is a position at a distance from the focusing position and is an edge with a difference in brightness.

The scattered light extraction image data are calculated using Expression 20, and the scattered light enhancement image data are obtained by adding up the arbitrary out-of-focus blur image data and scattered light extraction image data as represented by the following expression. It is, however, assumed that a condition of b>a≧0 is fulfilled in FIGS. 12A and 12B.

$$[ Expression 35 ]$$

$$\begin{matrix}Comp ( X , Y , Zf ) = \int \int k ( s , t ) \times {I}_{P 0} ( X , Y , Zf ) d s d t + \\ \int \int k ( s , t ) \times {S}_{P 0} ( X , Y , Zf ) d s d t \\ = \int \int k ( s , t ) \times \{ {I}_{P 0} ( X , Y , Zf ) + {S}_{P 0} ( X , Y , Zf ) \} d s d t\end{matrix}$$

The image data (all-in-focus image data 1201, arbitrary out-of-focus blur image data 1202, scattered light extraction image data 1203, and scattered light enhancement image data 1204) in FIG. 12A can be represented in the order of description by the following expressions.

I(X,Zf)=(a−b)×δ(X)+b [Expression 36]

a(X,Zf)=(a−b)×h(X,dZ)+b [Expression 37]

where h(X, dz) is a two-dimensional out-of-focus blur in which only the X direction and Z direction are taken into account.

DS(X,Zf)=(b−a)×{h(X,dZ)−h(0,dZ)} [Expression 38]

Comp(X,Zf)=(a−b)×h(0,dZ)+b [Expression 39]

In the scattered light enhancement image data 1204, the out-of-focus blur in a high-brightness region (region with brightness b) in all-in-focus image data 1201 can be suppressed.

Meanwhile, the image data (all-in-focus image data 1211, arbitrary out-of-focus blur image data 1212, scattered light extraction image data 1213, and scattered light enhancement image data 1214) in FIG. 12B can be represented in the order of description by the following expressions.

I(X,Zf)=(b−a)×step(X)+a [Expression 40]

where step(X) is the following step function.

$$step ( X ) = \{ \begin{matrix}0 : X < 0 \\ 1 : Z \geq 0\end{matrix} \\ a ( X , Zf ) = ( b - a ) \times H ( X , d Z ) + a \qquad [ Expression 41 ]$$

where H(X, dZ) is the integration value of h(X, dZ).

$$\begin{matrix}H ( X , d Z ) = {\int }_{- ∞}^{x} h ( X , d Z ) d X & [ Expression 42 ] \\ DS ( X , Zf ) = \{ \begin{matrix}( b - a ) \times H ( X , d Z ) : X < 0 \\ ( b - a ) \times \{ 1 - H ( X , d Z ) \} : X \geq 0\end{matrix} & \\ Comp ( X , Zf ) = \{ \begin{matrix}2 ( b - a ) \times H ( X , d Z ) : X < 0 \\ b : X \geq 0\end{matrix} & [ Expression 43 ]\end{matrix}$$

Likewise, the out-of-focus blur in a high-brightness region (region with brightness b) can be suppressed in the scattered light enhancement image data 1214 and the all-in-focus image data 1211, but it is clear that the out-of-focus blur is not canceled in a low-brightness region. However, since the scattered light component present in the arbitrary out-of-focus blur image data 1212 and the scattered light component present in the scattered light extraction image data 1213 are added to each other, information on the scattered light can be further enhanced. In FIGS. 12A and 12B, since only the transmitted light component is depicted, the scattered light component is not shown.

As has already been mentioned hereinabove, Expression 34 represents the difference between scattered light enhancement image data having different viewpoint weighting functions kₐ₁(s, t) and kₐ₂(s, t), and this expression means that the scattered light can be extracted by the difference between the scattered light enhancement image data calculated by changing the viewpoint weighting function. Therefore, it is clear that the scattered light component can be efficiently extracted when the intensity of kₐ₁(s, t) is relatively large at a position with a large observation angle φ and the intensity of kₐ₂(s, t) is relatively large at a position with a small observation angle φ, in the same manner as in Expression 28.

The relationship between the scattering image data (Expression 25) obtained by changing the polar angle and the scattering image data (Expression 32) obtained by enhancing the scattered light is analyzed below. The following expression is considered which is obtained by changing the viewpoint weighting function k(s, t) of Expression 25 into the viewpoint weighting function kₑₓ(s, t) for scattered light information extraction.

DS(X,Y,Zf)=∫∫kₑₓ(s,t)×S_{P0}(X,Y,Zf)dsdt [Expression 44]

where S_{P0} (X, Y, Zf) are viewpoint scattering image data represented by Expression 22 or 23.

As has been explained with respect to Expression 10, when the observation angle φ is small, information on scattered light which is included in viewpoint scattering image data S_{P0} (X, Y, Zf) calculated by Expression 22 or 23 is small. Therefore, where kₑₓ(s, t) has a negative intensity only at a small observation angle φ, the difference between the scattered light extraction image data calculated by Expression 25 and the scattered light extraction image data calculated by Expression 44 is small. Where a negative intensity is obtained only at an observation angle φ=0, the difference between the scattered light extraction image data calculated by Expression 25 and Expression 44 becomes 0.

It is clear that Expression 32 is a sum of Expression 28 representing scattered light extraction image data obtained by changing the observation angle φ and Expression 44 representing viewpoint scattering image data obtained by changing the polar angle θ. Thus, it is clear that formula 32 represents combined scattered light image extraction data obtained by changing the polar angle θ and the observation angle φ. It is indicated hereinabove that scattering image data can be generated using viewpoint image data that differ in the polar angle θ and the observation angle φ.

(Out-of-Focus Blur Effect of Subject in Image Dagan of Pathological Specimen)

The effect of out-of-focus blur of a subject in scattering image data generated from a pathological specimen is described below.

As indicated in 1213 in FIG. 12B, where a subject is at a position at a distance from a focusing position and a large difference in brightness is present in the specimen (for example, an edge), an artefact (out-of-focus blur component) that is different from a scattered light component, such as oozing of the out-of-focus blur into a region that is lower in brightness than surroundings, is generated in scattered light extraction image data. The out-of-focus blurs appearing in a low-brightness region (region with a negative X) in 1214 in FIG. 12B differ from each other also when scattered light extraction image data are obtained using Expression 32 from a difference between two scattered light enhancement image data that differ in an out-of-focus blur, and therefore the same phenomenon is generated in this difference. The difference in out-of-focus blur likewise remains even when a difference between two out-of-focus blur image data that differ in the out-of-focus blur is obtained with Expression 28.

The abovementioned phenomenon tends to become prominent in a low-brightness region of an edge where the difference in brightness is particularly large. For example, in the microscopic image of a pathological specimen subjected to HE staining, the nucleus and the interior thereof are stained deep blue and the transmittance is low, whereas a cytoplasm portion is stained light pink and the transmittance is high.

Therefore, since the difference in transmittance is comparatively small (in the case illustrated by FIGS. 12A and 12B, the difference in brightness between a and b is small) inside the cytoplasm, the effect of out-of-focus blur is very small and practically no problem is associated with the effect of out-of-focus blur in a low-brightness region.

However, since the difference in transmittance is large (in the case illustrated by FIGS. 12A and 12B, the difference in brightness between a and b is large) at the boundary of a nucleus and cytoplasm, the out-of-focus blur of the subject oozes into the low-brightness region (in the case of 1214, a region with a negative X) and an artefact can be observed. This phenomena can be observed in both the scattered light extraction image data and the scattered light enhancement image data.

In the below-described examples, a method is provided by which the effect of subject out-of-focus blur appearing in a low-brightness region is suppressed and information on the scattered light in scattering image data can be made more reliable by focusing attention on a phenomenon of the amount of scattered light being small in a low-brightness region and large in a high-brightness region.

### Example 1

Described hereinbelow are specific examples of the image data generating apparatus 100.

### (Scattering Image Data Generation Setting Screen)

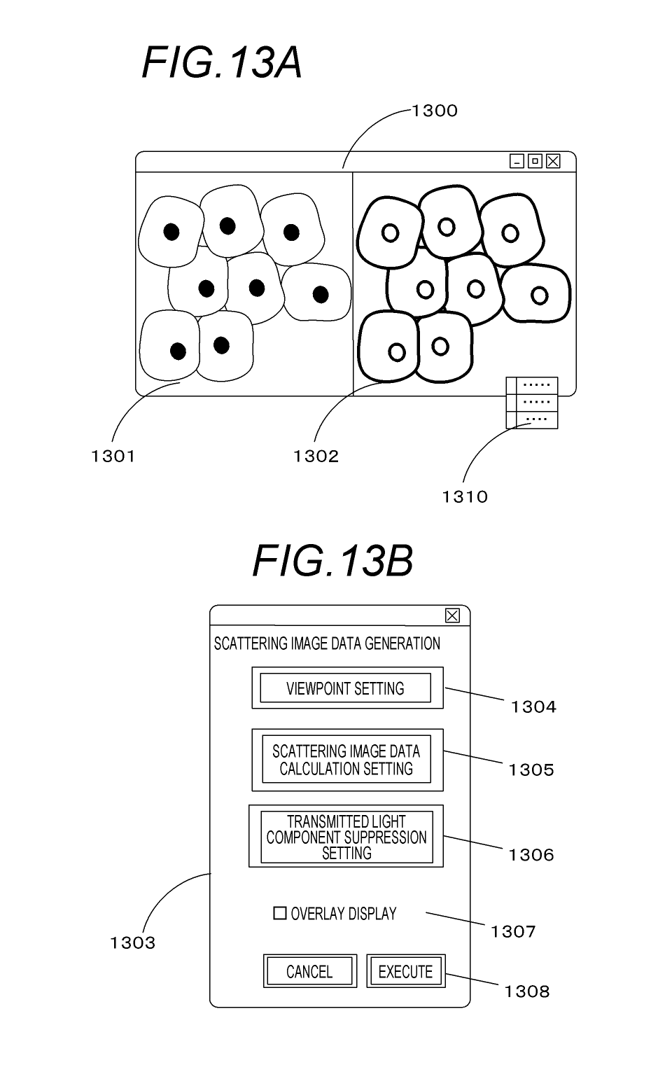

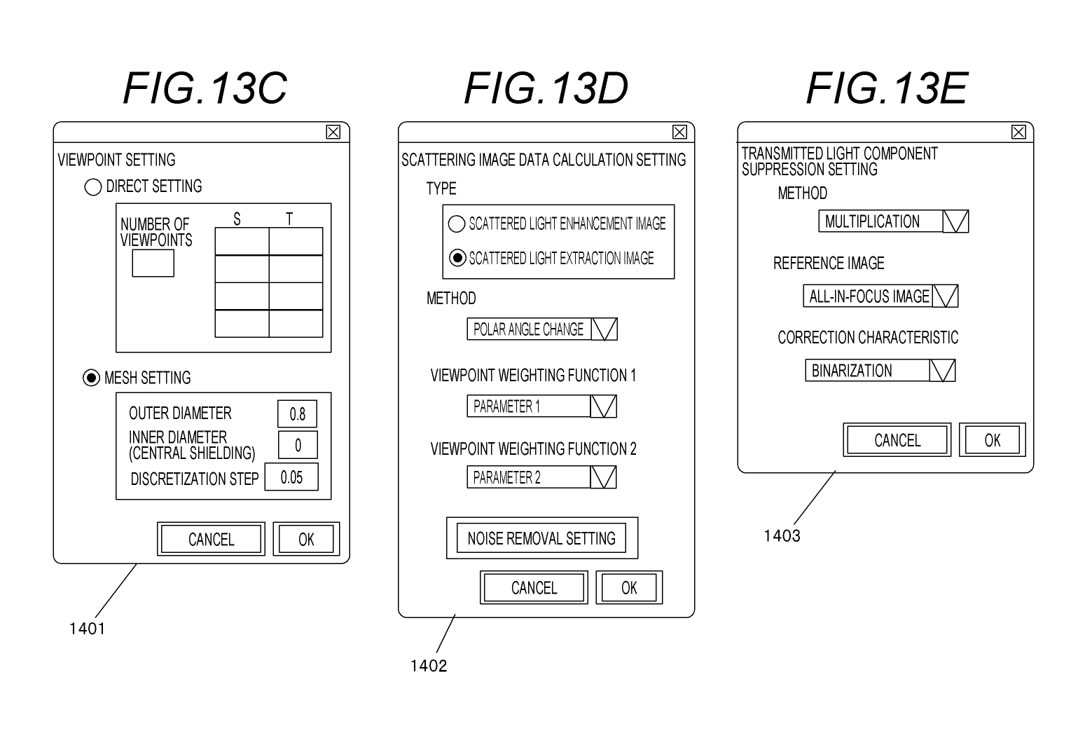

FIGS. 13A and 13B show examples of setting screens of a scattering image data generation function in Example 1. A region 207 in a displayed image in the image display application depicted in FIG. 2 is selected with a mouse, and then an item named “SCATTERING IMAGE DATA GENERATION” (not shown in the figure) is selected from a function extension menu 208 that is displayed by a right click of the mouse. In response thereto, a new window 1300 (FIG. 13A) showing images before and after the scattering image data generation processing and a setting screen 1303 of the scattering image data generation function (FIG. 13B) are displayed. The image data in the region 207 are displayed in a left-side region 1301 of the window 1300 and an image data resulting from the scattering image data generation processing are displayed in a right-side region 1302.

The setting screen 1303 is operated when changing settings of the scattering image data generation function. When the user presses a viewpoint setting button 1304 with the mouse, a setting screen for determining a line-of-sight direction (a three-dimensional observation direction) to be used in scattering image data generation is displayed. Further, there may be one or a plurality of viewpoints. Details will be described hereinbelow. When the user presses a scattering image data calculation setting button 1305, a scattering image data calculation setting screen for setting a method or parameters for calculating the scattering image data is displayed. Various methods that have already been described can be selected as a method for generating the scattering image data. Details thereof will be described hereinbelow. If necessary, an optional noise removal parameter for the scattering image data can be also set. Details will be described hereinbelow. When the user presses a transmitted light component suppression setting button 1306, a setting screen for suppressing an artefact (out-of-focus blur component) of a low-brightness region in the scattering image data is displayed. Details will be described hereinbelow.

An overlay display 1307 is a check box. Where this setting is enabled, the image data in the selection region 207 and the scattering image data are overlapped and displayed in the right-side region 1302. When the user performs the abovementioned settings as necessary and then presses an execution button 1308, the generation of scattering image data is performed and a processing result is displayed. Details will be described hereinbelow.

Reference numeral 1310 stands for a function extension menu that can be invoked by right-clicking inside the window 1300. Items for image analysis such as N/C ratio calculation (not shown in the figure) are arranged side by side in the function extension menu 1310. Where an item is selected, a setting screen for image analysis processing (not shown in the figure) is displayed, analysis processing is executed with respect to a selected region in the window or on the entire window and a processing result is displayed. Details will be described hereinbelow.

(Scattering Image Data Generation Processing)

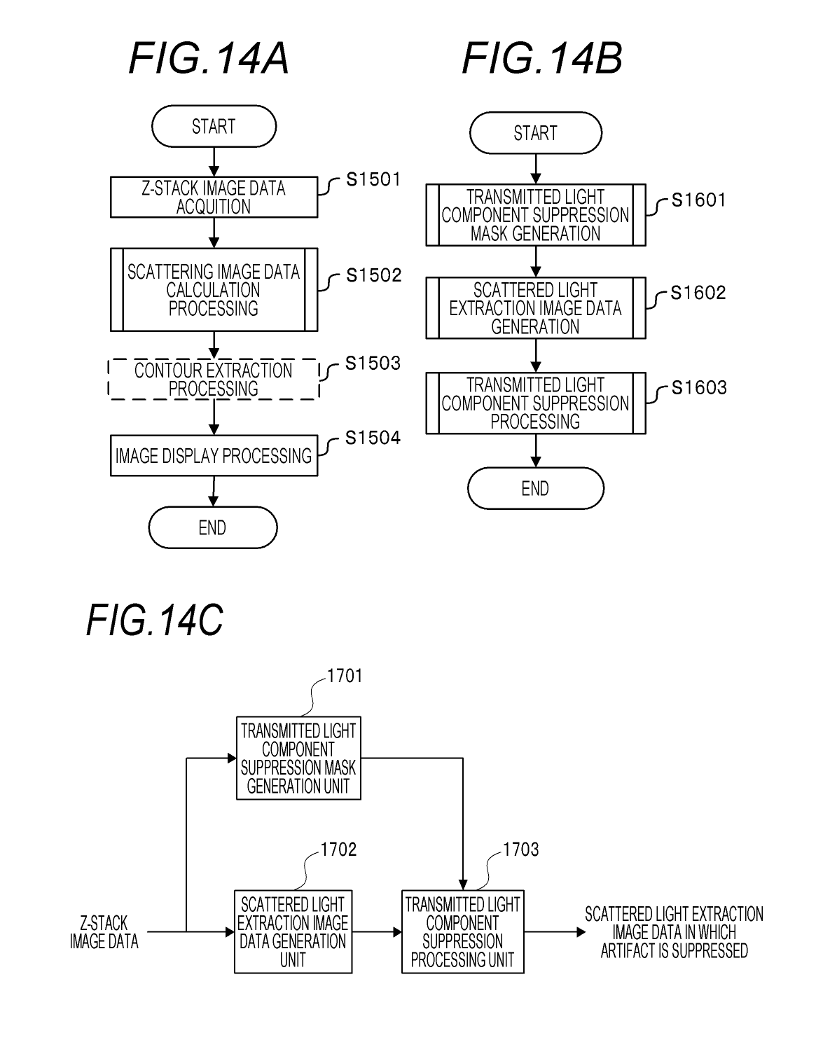

FIG. 14A shows a flow of scattering image data generation processing that is executed when the abovementioned execution button 1308 is pressed. This processing is realized by the image display application and the image data generation program that is invoked therefrom.

In a Z stack image data acquisition step S1501, data of a necessary range are acquired from the Z stack image data stored in the main memory 302 or the storage device 130 on the basis of coordinates of the image selection region 207 which is being displayed by the image display application. When the Z stack image data are present in another computer system 140, data are acquired through the network I/F 304 and stored in the main memory 302.

Then, in a scattering image data processing step S1502, viewpoint image data corresponding to a plurality of viewpoints are generated from the Z stack image data on the basis of information on a viewpoint which determines a line-of-sight direction with respect to the subject (observation direction). Scattering image data are then generated using the viewpoint image data. Details will be described hereinbelow.

Then, in a contour extraction processing step S1503, contour extracted image data obtained by extracting a contour from the scattering image data are generated. The processing of step S1503 is not essential and whether or not to apply this processing can be determined according to settings (not shown in the figure). Details will be described hereinbelow.

In an image display processing step S1504, the contour extracted image data, the viewpoint scattering image data, or the scattering image data (scattered light enhancement image data or scattered light extraction image data) are enlarged/reduced in accordance with a display magnification of the image display application and displayed in the right-side region 1302. When the overlay display 1307 is enabled, the contour extracted image data, the viewpoint scattering image data, or the scattering image data are overlaid on the image data in the selection region 207 and displayed. In this case, an image obtained by synthesizing (adding or subtracting) the viewpoint scattering image data or scattering image data of a corresponding position with the image data in the selection region 207 may be displayed in the right-side region 1302. Furthermore, image data obtained by performing gradation correction of the synthesized image data such that brightness approaches that of the image data in the selection region 207 may be displayed in the right-side region 1302. An animation display in which a plurality of viewpoint scattering image data is switched at a constant time interval may be also performed. In this case, the contour extracted image data, the viewpoint scattering image data, or the scattering image data may be displayed in a different color for each channel (RGB) or may be changed to another color that does not overlap the color of the specimen. The image data to be used for the display in this case (contour extracted image data, viewpoint scattering image data, scattering image data, and image data obtained by combining those image data with the original image data) are all observation image data suitable for image observation and image diagnosis (including automatic diagnosis).

(Scattering Image Data Calculation Processing Step S1502)

The internal processing of the scattering image data calculation processing step S1502 in the main processing of scattering image data generation processing executed by pressing the execution button 1308 is explained hereinbelow.

FIG. 14B is a flowchart showing the internal processing of the scattering image data calculation processing step S1502 of the present example. FIG. 14C is a block diagram that realizes the function of scattering image data calculation processing. A transmitted light component suppression mask generation unit 1701, a scattered light extraction image data generation unit 1702, and a transmitted light component suppression processing unit 1703 depicted in FIG. 14C are blocks for realizing the functions of steps S1601, S1602, and S1603, respectively, those steps being depicted in FIG. 14B.

A method for generating scattering image data is described hereinbelow with reference to FIGS. 14B and 14C.

Initially, in the transmitted light component suppression mask generation step S1601, the transmitted light component suppression mask generation unit 1701 generates a transmitted light component suppression mask by using the inputted Z stack image data and outputs the generated mask to the transmitted light component suppression processing unit 1703 of the subsequent stage.

The transmitted light component suppression mask is mask data that have the same size in the XY directions as the image data of the focusing position Z=Zf and is obtained by allocating a coefficient to each pixel. Details will be described hereinbelow.

Then, in the scattered light extraction image data generation step S1602, the scattered light extraction image data generation unit 1702 generates scattered light extraction image data by using the inputted Z stack image data and outputs the generated data to the transmitted light component suppression processing unit 1703 of the subsequent stage. Details will be described hereinbelow.

Finally, in the transmitted light component suppression processing step S1603, the transmitted light component suppression processing unit 1703 generates corrected scattered light extraction image data in which the transmitted light component has been suppressed by using the transmitted light component suppression mask and the scattered light extraction image data. Details will be described hereinbelow.

(Transmitted Light Component Suppression Mask Generation Step 1601)

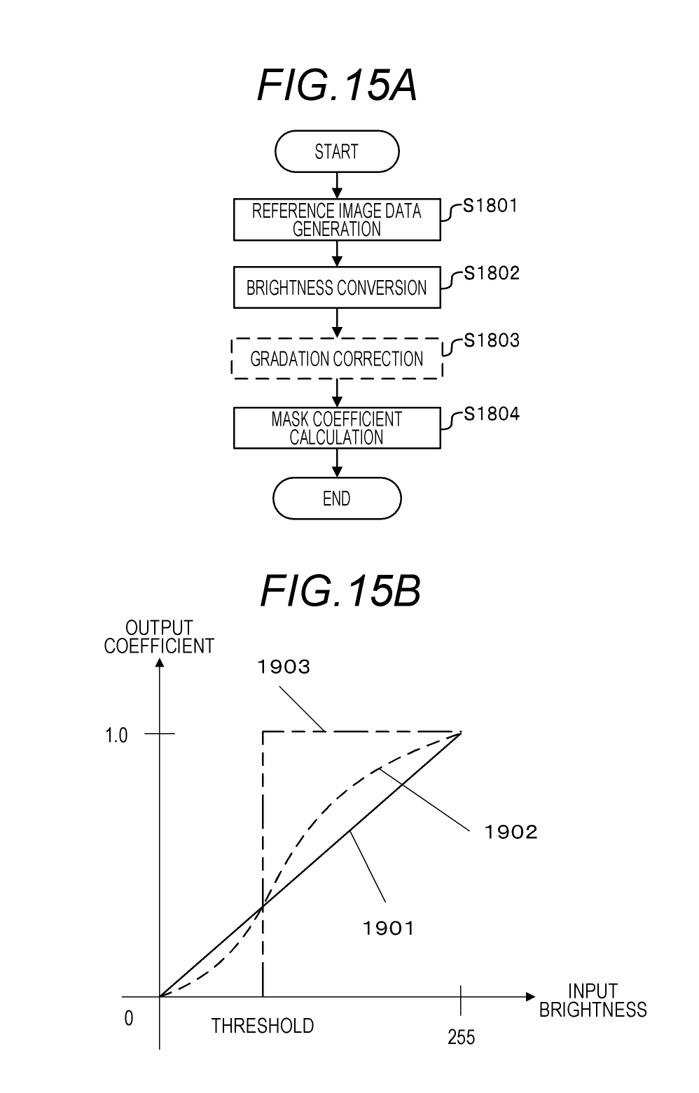

The internal processing of the transmitted light component suppression mask generation step S1601 is described hereinbelow. FIG. 15A is a flowchart showing the internal processing of step S1601.

In the transmitted light component suppression mask generation step S1601, a transmitted light component suppression mask is generated on the basis of the transmitted light component suppression setting (1403). The processing is explained hereinbelow together with settings.

The transmitted light component suppression setting screen 1403 depicted in FIG. 13E is an example of a setting screen displaced when the transmitted light component suppression setting button 1306 is pressed. This is used to set information for suppressing the aforementioned out-of-focus blur component of the subject in the low-brightness region.

On the setting screen 1403, “METHOD” for designating a method for suppressing the transmitted light component, “REFERENCE IMAGE” for designating reference image data to be referred to when generating the transmitted light component suppression mask, and “CORRECTION CHARACTERISTIC” for selecting the type of gradation correction to be applied to the reference image data can be selected from a dropdown list.

In step S1601, the transmitted light component suppression mask is generated on the basis of those types of setting information.

In a reference image data generation step S1801, reference image data for transmitted light component suppression mask generation are generated from the inputted Z stack image data. Image data of various types and properties can be used as the reference image data, provided that they can represent the brightness feature of the Z stack image data which are the original image data. The type and properties of the desired reference image data can be set in “REFERENCE IMAGE” of the setting screen 1403. Typically, viewpoint image data that are generated from the Z stack image data and viewed from a viewpoint passing through the optical axis, that is, the all-in-focus image data, may be used as the reference image data. Alternatively, arbitrary out-of-focus blur image data generated from the Z stack image data (that is, image data having an out-of-focus blur different from that of the original layer image data) may be also used. For example, image data with a depth of field enlarged with respect to that of the original layer image data may be used. Alternatively, some layer image data selected from the Z stack image data may be used as the reference image data. In the case of the Z stack image data acquired with a microscope having a bilaterally telecentric optical system, the fixed pattern noise of a sensor is easily represented in the all-in-focus image data. In this case, noise reducing processing such as median filtering may be performed with respect to the all-in-focus image data. The all-in-focus image data may be also generated by extracting a region with a high contrast in the XY directions from each of the layer image data at a plurality of Z positions in the Z stack image data and combining the extracted regions. A method for generating arbitrary viewpoint image data and arbitrary out-of-focus blur image data has already been described hereinabove and the explanation thereof is herein omitted.

Then, in a brightness conversion step S1802, the all-in-focus image data generated in step S1801 are converted into a brightness, and reference image data for mask reference are generated. It is also possible to change the order of step S1801 and step S1802, subject the Z stack image data to brightness conversion, and then generate the all-in-focus image data. The conversion processing of brightness is explained hereinbelow. When the Z stack image data are monochromatic image data, the brightness values are directly taken as pixel value. When the Z stack image data are RGB color images, the brightness value (Y) is determined from pixel values of each color (respective R, G, B) by using a numerical formula. For example, In the case of an NTSC signal used in analog TV broadcasting, the conversion expression from RGB values to the brightness value (Y) is:

Y=0.299×R+0.587×G+0.114×B.

Since the conversion expression from RGB values to the brightness value (Y) differs depending on a color space (sRGB or Adobe RGB) representing the signal, a conversion expression corresponding to the respective color space may be used.

Then, in a gradation correction step S1803, gradation correction is performed with respect to the reference image data. In this case, the gradation correction that has been set in “CORRECTION CHARACTERISTIC” of the setting screen 1403 is applied. Examples of gradation correction include “CORRECTION USING TONE CURVE”, “BINARIZATION”, and “ADAPTIVE BINARIZATION”. The binarization is performed with a predetermined (fixed) threshold, and in adaptive binarization, an adaptive threshold is selected dynamically according to the brightness distribution of image data. The binarization threshold may be directly set by the user. When the processing is applied to a HE-stained pathological specimen, a threshold is preferably set that makes it possible to separate nucleus and cytoplasm regions. Where a threshold is determined that identifies the nucleus and cytoplasm regions by using color components, it is possible to input specific color components such as R and B in step S1803, without performing the brightness conversion in step S1802. In the binarization, a region with a brightness higher than the threshold is set to a maximum brightness (255), and a region with a brightness lower than the threshold is set to a minimum brightness (0). The gradation correction step S1803 is not essential (when “NO GRADATION CORRECTION” is selected on the setting screen 1403, the step S1803 is skipped).

Finally, in a mask coefficient computation processing step S1804, a transmitted light component suppression mask M(X, Y, Zf) is generated using the following expression from the reference image data subjected to gradation correction.

M(X,Y,Zf)=I_{ref}(X,Y,Zf)/Imax [Expression 45]

Here, I_{ref}(X, Y, Zf) represents reference image data, and Iₘₐₓ represents the maximum brightness value (255 in the case of 8-bit image data). Thus, the transmitted light component suppression mask is image data obtained by normalizing brightness values of each pixel of the reference image data (or reference image data subjected to gradation correction) with the maximum brightness value.

FIG. 15B is a graph representing the relationship between the output coefficient (ordinate) of the transmitted light component suppression mask and the input brightness (abscissa) of the reference image data. Reference numeral 1901 represents the relationship when no gradation correction is performed, 1902—when the gradation correction is performed with a tone curve, and 1903—when binarization processing is performed. The coefficient of each pixel of the transmitted light component suppression mask has a value range of 0 to 1, and has a low value in a low-brightness region and a high value in a high-brightness region. Thus, the value of the coefficient of each pixel of the transmitted light component suppression mask is set to have a positive correlation with the brightness of each pixel of reference image data.

By using the transmitted light component suppression mask such as depicted in FIG. 15B, it is possible to suppress the out-of-focus blur component of the subject in the low-brightness region of the scattered light extraction image data generated in step S1602. Details will be described hereinbelow.

(Scattered Light Extraction Image Data Generation Step S1602)

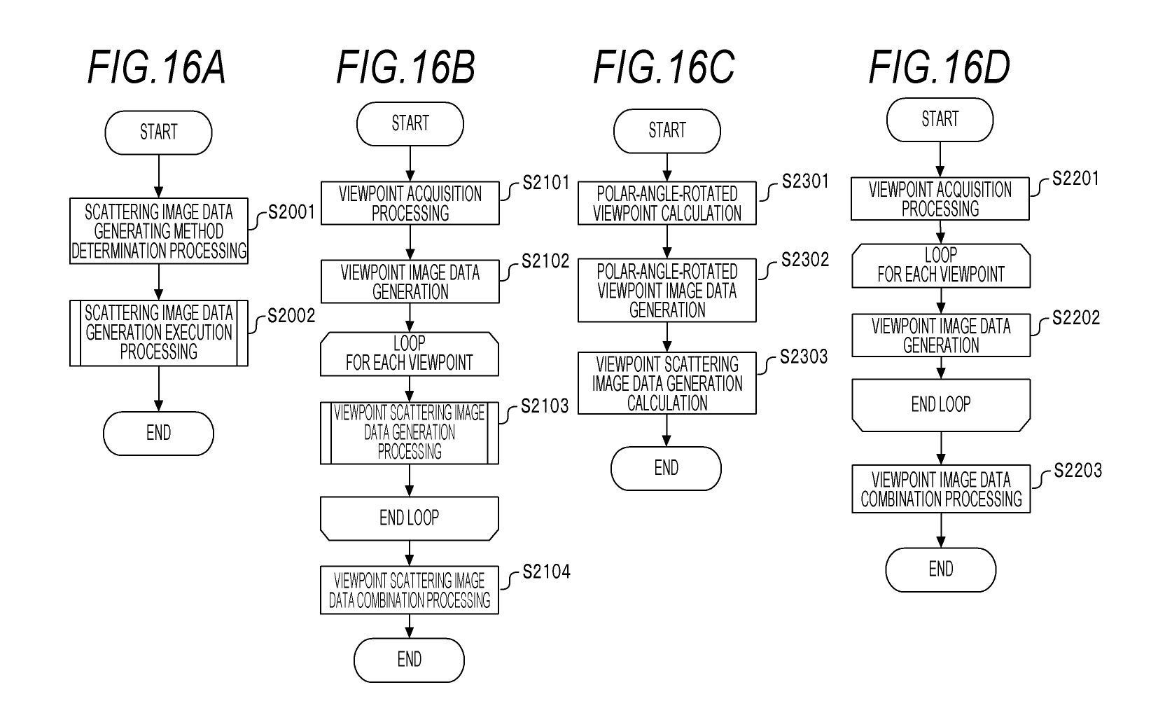

FIG. 16A is a flowchart representing the internal processing of the scattered light extraction image data generation step S1602.

Initially, in a scattered light extraction image data generating method determination processing step S2001, a scattered light extraction image data generating method is determined on the basis of “METHOD” selected on the setting screen 1402. As mentioned hereinabove, where the method is different, the calculation method in the below-described scattering image data generation execution processing step S2002 is also different. Further, “POLAR ANGLE CHANGE”, “OBSERVATION ANGLE CHANGE”, and “COMPOSITE CHANGE” are selected as the method on the setting screen 1402. Then, in the scattering image data generation execution processing step S2002, scattering image data are generated on the basis of parameters that have been set on the setting screens 1401 and 1402.

(Scattering Image Data Generation Execution Processing Step S2002: Polar Angle Change or Composite Change)

FIG. 16B is a flowchart showing the internal processing in the below-described scattering image data generation execution processing step S2002 when “POLAR ANGLE CHANGE” or “COMPOSITE CHANGE” is selected as “METHOD” on the setting screen 1402. Where “POLAR ANGLE CHANGE” is selected, computations corresponding to Expression 44 are performed, and where “COMPOSITE CHANGE” is selected, computations corresponding to Expression 32 are performed.

Initially, in a viewpoint acquisition processing step S2101, position information on a viewpoint that is necessary for generating viewpoint image data in step S2102 of the subsequent stage is acquired. In step S2101, predetermined viewpoint position information may be acquired from the main memory 302, the storage device 130, or another computer system 140. In step S2101, viewpoint position information may be also calculated on the basis of information that has been set on the image display application. Details will be described hereinbelow.

Then, in a viewpoint image data generation step S2102, viewpoint image data corresponding to the viewpoint obtained in step S2101 are generated on the basis of the Z stack image data of the selection region 207. This function executed by the image data generating apparatus 100 (CPU 301) is called a “viewpoint image data generation means”. Methods disclosed in the aforementioned PTL 1 and NPLs 2-4 and various other methods may be used as a method (MFI arbitrary viewpoint/out-of-focus blur image generating method) for generating arbitrary viewpoint image data from the Z stack image data.

Then, in a viewpoint scattering image data generation processing step S2103, the scattering image data generation processing is performed on the basis of the scattering image data calculation setting (1305) with respect to the generated viewpoint image data. Where a plurality of viewpoints is present, the viewpoint scattering image data generation processing is executed according to the number of viewpoints. Then, in a viewpoint scattering image data combining processing step S2104, a plurality of viewpoint scattering image data generated in step S2103 is combined together on the basis of the scattering image data calculation setting (1305), and scattering image data are generated. The functions of steps S2103 and S2104 executed by the image generating device 100 (CPU 301) are called a “scattering image data generation means” (feature image data generation means). However, when the scattered light of the subject is extracted, the functions may be called a “scattered light extraction image data generation means”, and when the scattered light of the subject is enhanced, the functions may be called a “scattered light enhancement image data generation means”, thereby distinguishing one from another. Details will be described hereinbelow.

Details of the viewpoint acquisition processing step S2101, viewpoint scattering image data generation processing step S2103, and viewpoint scattering image data combining processing step S2104 are described hereinbelow.

(Viewpoint Acquisition Processing Step S2101)

The processing of calculating viewpoint position information in the viewpoint acquisition processing step S2101 on the basis of the viewpoint setting (1304) is described below.

The viewpoint setting screen 1401 depicted in FIG. 13C is an example of setting screen displayed when the viewpoint setting button 1304 depicted in FIG. 13B is pressed. The viewpoint position of viewpoint image data to be used for generating the scattering image data is set on this screen.

Two methods, namely, “DIRECT SETTING” and “MESH SETTING” can be selected as viewpoint setting methods on the viewpoint setting screen 1401. With the direct setting, the user directly designates the number of viewpoints and viewpoint positions (s, t). Meanwhile, with the mesh setting, the user designates an outer diameter, an inner diameter (central shielding), and a discretization step, and the positions of the viewpoints are calculated from those designated values.

A maximum shift amount (the distance of the viewpoint from a point of origin when the position where the optical axis crosses the lens plane is taken as the point of origin) of the viewpoint which is to be calculated is designated as “OUTER DIAMETER”, and a minimum shift amount (that is, the maximum shift amount of a viewpoint which is not calculated) of the viewpoint which is to be calculated is designated as “INNER DIAMETER (CENTRAL SHIELDING)”. In this case, values of the outer diameter and inner diameter (central shielding) are set according to a distance (radius) centered on the point of origin on the lens plane. A value exceeding a radius rₘ of the optical system on the lens plane cannot be set as the outer diameter. The “DISCRETIZATION STEP” is an increment interval for discretely setting positions of viewpoints for which viewpoint image data are to be generated within a donut-shaped region obtained by subtracting a circle defined by “INNER DIAMETER” from a circle defined by “OUTER DIAMETER”. The finer is the discretization step, the larger is the number of viewpoints to be calculated.

Further, various shapes can be set in addition to the above-described circles. For example, a plurality of concentric circles with different radii or straight lines extending radially from a center can be set. When concentric circles are set, the discretization step (for example, setting of an angular interval) that determines a radius of each circle or a density of viewpoints on each circle can be set. In the case of straight lines radially extending from a center, the discretization step that determines an interval of lines (for example, setting of an angular interval) or a density of viewpoints on the radial lines can be set.

(Viewpoint Scattering Image Data Generation Processing Step S2103)

The scattering image data calculation setting screen 1402 depicted in FIG. 13D is an example of a setting screen to be displayed when the scattering image data calculation setting button 1305 depicted in FIG. 13B is pressed. In this case, parameters such as types of generation of scattered light enhancement image data or scattered light extraction image data, calculation methods therefor, and viewpoint weighting functions are set.

In “TYPE” on the setting screen 1402, “SCATTERED LIGHT ENHANCEMENT IMAGE” or “SCATTERED LIGHT EXTRACTION IMAGE” is selected by the user from a group box located below “TYPE” according to the usage objective.

A method for calculating the scattering image data to be used in the viewpoint scattering image data generation processing step S2103 can be selected from a dropdown list below “METHOD”. As mentioned hereinabove, in the present example, a calculation method can be selected from “POLAR ANGLE CHANGE”, “OBSERVATION ANGLE CHANGE”, and “COMPOSITE CHANGE”.

A viewpoint weighting function to be used in viewpoint scattering image data combination processing step S2104 can be selected from dropdown lists below “VIEWPOINT WEIGHTING FUNCTION 1” and “VIEWPOINT WEIGHTING FUNCTION 2”. A plurality of parameter settings obtained by combining an out-of-focus blur shape, such as Gaussian blur represented by a Gaussian function or a columnar blur represented by a columnar shape, with the radius thereof is displayed in the dropdown list, and the user can select a parameter setting therefrom. In the viewpoint scattering image data generation processing step S2103, a viewpoint weighting function for scattered light information extraction is generated using a viewpoint weighting function selected with the dropdown lists of “VIEWPOINT WEIGHTING FUNCTION 1” and “VIEWPOINT WEIGHTING FUNCTION 2” (“VIEWPOINT WEIGHTING FUNCTION 1” corresponds to kₐ₁(s, t) of Expression 29 and “VIEWPOINT WEIGHTING FUNCTION 2” corresponds to kₐ₂(s, t) of Expression 29. Therefore, the viewpoint weighting function kₑₓ(s, t) for scattered light information extraction can be calculated as a difference of the two).

Further, a noise removal setting can be present in the viewpoint scattering image data calculation setting screen 1402. Binarization using a threshold, a median filter, and a bilateral filter which enables noise removal while retaining an edge can be used as the noise removal setting. Such processing generates scattering image data having a clear contrast and further facilitates the detection of N/C ratio.

(Examples of Settable Viewpoint Weighting Function)

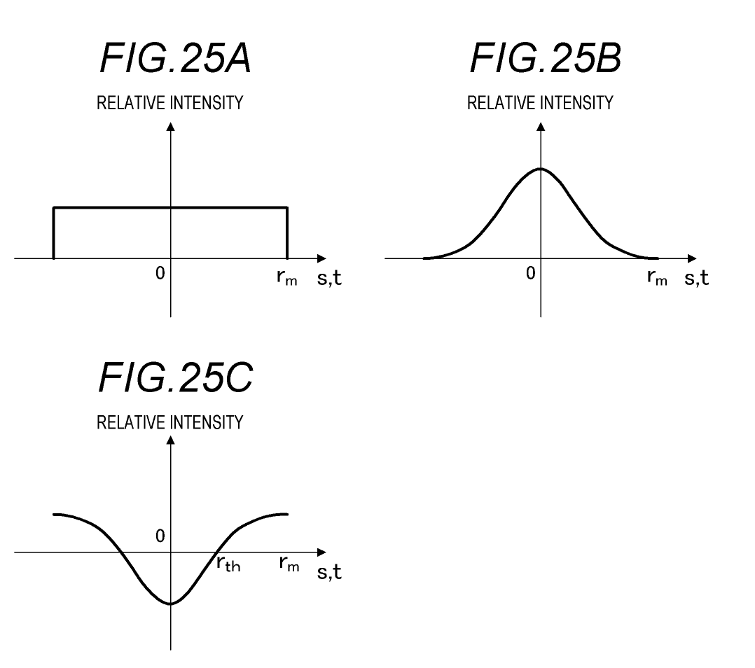

FIGS. 25A and 25C are schematic diagrams illustrating examples of a viewpoint weighting function, FIG. 25C illustrates an example of a viewpoint weighting function for extracted light information extraction. FIG. 25A shows a viewpoint weighting function represented by a columnar shape, and FIG. 25B shows a viewpoint weighting function represented by a Gaussian function. Rₘ represents a distance from a point of origin (0, 0) of the outermost viewpoint on the lens plane, from among the viewpoints to be used for generating the arbitrary out-of-focus blur image.

The viewpoint weighting function kₐ(s, t) in FIG. 25A can be represented by the following expression.

$${k}_{a} ( s , t ) = \{ \begin{matrix}1 / π {r}_{m}^{2} : \sqrt{{s}^{2} + {t}^{2}} \leq {r}_{m} \\ 0 : \sqrt{{s}^{2} + {t}^{2}} > {r}_{m}\end{matrix} \qquad [ Expression 46 ]$$

The viewpoint weighting function kₐ(s, t) in FIG. 25B can be represented by the following expression.

$${k}_{a} ( s , t ) = \frac{1}{2 {πσ}^{2}} exp ( - \frac{{s}^{2} + {t}^{2}}{2 {σ}^{2}} ) \qquad [ Expression 47 ]$$

Here, σ is a standard deviation of a Gaussian function. The spread of blur can be controlled by σ.

The integral of kₐ(s, t) shown in Expression 46 and Expression 47 takes a value of 1 and fulfils the condition of Expression 18.

The three-dimensional out-of-focus blur of an imaging optical system cannot be accurately represented by a viewpoint weighting function because of the effects of wave-optical blur and various types of astigmatism, but can be relatively well approximated by a viewpoint weighting function of a Gaussian function shown in Expression 47. The viewpoint weighting function in FIG. 25C is obtained by subtracting the viewpoint weighting function in FIG. 25B from the viewpoint weighting function in FIG. 25A, and fulfils the conditions of Expression 30 and Expression 31. Thus, for the viewpoint weighting function in FIG. 25C, the integral of all of the viewpoints is 0, the integral of a region in which the radius vector r of a viewpoint is equal to or less than a predetermined threshold rₜₕ is negative, and the integral of a region in which the radius vector is greater than the predetermined threshold rₜₕ is positive.

A method for generating viewpoint scattering image data in viewpoint scattering image data generation processing step S2103 is described below.

As has already been explained with Expression 10, where subtraction is performed between viewpoint image data of a predetermined viewpoint (s, t) and viewpoint image data of a viewpoint that has the same observation angle φ and a polar angle θ that differs by 180 degrees, information on tint caused by the difference in transmittance of the specimen can be canceled and scattering image data can be efficiently generated.

FIG. 16C is a flowchart showing the internal processing of viewpoint scattering image data generation processing S2103 in the present embodiment. A method for generating scattering image data for each viewpoint is explained hereinbelow with reference to FIG. 16C.

Initially, in a polar-angle-rotated viewpoint calculation step S2301, a polar-point-rotated viewpoint is calculated which is at a position obtained by rotation of the polar angle θ through a predetermined angle with respect to a viewpoint which is the processing object. Since 180 degrees is the most preferred rotation angle, the case of a 180-degree rotation is explained below.

Where the coordinate of the viewpoint P0 which is the processing object is taken as (x, y)=(sₚ, tₚ) in the coordinate system depicted in FIG. 7A, the coordinate of the polar-angle-rotated viewpoint P1 obtained by rotation through 180 degrees is (x, y)=(−sₚ, −tₚ).

Then, in a polar-angle-rotated viewpoint image data generation step S2302, viewpoint image data observed from the polar-angle-rotated viewpoint P1 calculated in step S2301 are generated. Since a method for generating the viewpoint image data has already been explained in the viewpoint image data generation step S2102, the explanation thereof is herein omitted. Where the viewpoint image data of the polar-angle-rotated viewpoint P1 have already been calculated in the viewpoint image data generation step S2102, no recalculation is performed, the data present in the main memory 303 or the storage device 130 of the image data generating apparatus 100 are read and used.

Then, in a viewpoint scattering image data generation computation step S2303, viewpoint scattering image data are generated from viewpoint image data I_{P0} (X, Y, Zf) of the viewpoint P0 which is the processing object and the viewpoint image data I_{P1}(X, Y, Zf) of the polar-angle-rotated viewpoint P1, and the generated data are outputted. More specifically, where “POLAR ANGLE CHANGE” is selected as a method on the setting screen 1402, computations indicated in Expression 22 or Expression 23 are performed, and where “COMPOSITE CHANGE” is selected, computations of Expression 33 are performed.

(Viewpoint Scattering Image Data Combination Processing Step S2104)

In a viewpoint scattering image data combination processing step S2104, a plurality of viewpoint scattering image data is combined together and scattering image data (scattered light enhancement image data or scattered light extraction image data) are generated.

More specifically, where “POLAR ANGLE CHANGE” is selected as a method on the setting screen 1402, computations of Expression 44 are performed, and where “COMPOSITE CHANGE” is selected, computations of Expression 32 are performed.

In this case, kₑₓ(s, t) in Expressions 44 and 32 is calculated using Expression 29 after calculating kₐ₁(s, t) and kₐ₂(s, t) from parameters which have been set by “VIEWPOINT WEIGHTING FUNCTION 1” and “VIEWPOINT WEIGHTING FUNCTION 2” on the setting screen 1402.

In the flowchart of FIG. 16B, it is possible to initialize the storage buffer of scattering image data at 0 before starting the viewpoint loop processing, execute the computations in the integral of Expression 44 or Expression 32 in step S2103, and add the result obtained to the storage buffer of the scattering image data. In this case, the computations of step S2104 are unnecessary.

It is also possible to use Expression 25 instead of Expression 44, and generate scattered light extraction image data by using an arbitrary viewpoint weighting function k(s, t) instead of the viewpoint weighting function kₑₓ(s, t) for scattered light information extraction, such a configuration being within the scope of the present invention.

Further, in the viewpoint scattering image data combination processing step S2104, the processing of removing noise included in scattering image data may be performed in the same manner as in the viewpoint scattering image data generation processing step S2103. In this case, noise removal setting is performed on the scattering image data computation setting screen 1402. The numerical values of the generated scattering image data which are less than 0 are taken to be 0. This is because the scattered light component is practically absent in a region with a numerical value less than 0 and the number of out-of-focus blur components is large (this processing also results in noise removal)

(Scattering Image Data Generation Execution Processing Step S2002: Observation Angle Change)

FIG. 16D is a flowchart showing the internal processing of the scattering image data generation execution processing step S2002 when “OBSERVATION ANGLE CHANGE” is selected as “METHOD” on the setting screen 1402.

Since the processing of the viewpoint acquisition processing step S2201 is the same as that of step S2101 in FIG. 16B, the explanation thereof is herein omitted.

Then, in a scattering image data generation execution processing step S2202, viewpoint image data corresponding to the viewpoint obtained in step S2201 are generated on the basis of the Z stack image data. This function executed by the image data generating apparatus 100 (CPU 301) is called a “viewpoint image data generation means”. Methods disclosed in the aforementioned PTL 1 and NPLs 2-4 and various other methods may be used as a method (MFI arbitrary viewpoint/out-of-focus blur image generating method) for generating arbitrary viewpoint image data from the Z stack image data.

Once the processing of step S2202 has been completed with respect to all of the viewpoints obtained in step S2201, the processing advances to a viewpoint image data combination processing step S2203.

In the viewpoint image data combination processing, the viewpoint image data obtained in step S2202 are combined using the viewpoint weighting function for scattered light information extraction that has been calculated using Expression 29, on the basis of “VIEWPOINT WEIGHTING FUNCTION 1” and “VIEWPOINT WEIGHTING FUNCTION 2” selected on the setting screen 1402. Calculations corresponding to Expression 28 are performed when combining the viewpoint image data. As a result scattering image data are obtained.

In the viewpoint image data combination processing step S2203, noise may be also removed according to the noise removal setting of the setting screen 1402 in the same manner as in step S2104 depicted in FIG. 16B. Numerical values of the generated scattering image data which are less than 0 are taken as 0.

(Transmitted Light Component Suppression Processing Step S1603)

The processing of the transmission light component suppression processing step S1603 depicted in FIG. 14B is explained hereinbelow.

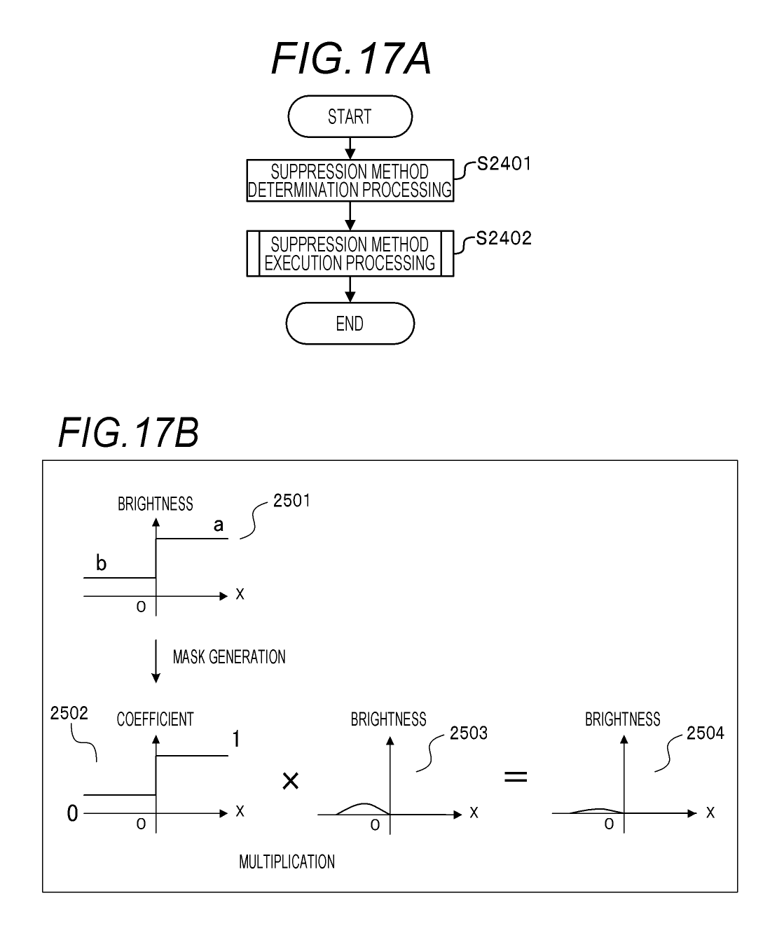

Performed in step S1603 is the processing of suppressing an artefact (out-of-focus blur component) included in the scattering image data generated in step S1602. As mentioned hereinabove, the artefact which is a problem herein appears prominently in a low-brightness region in the Z stack image data (original image data obtained by capturing an image), from among the scattering image data (feature image data). Accordingly, in the present example, the artefact is reduced by an operation of performing correction processing of reducing the brightness with respect to pixels corresponding to at least the low-brightness region in the original image data, from among the scattering image data. The scattering image data after the brightness correction (feature image data) are called “corrected image data”. FIG. 17A is a flowchart representing the internal processing of step S1603. The processing is explained hereinbelow together with settings.

Initially, in suppression method determination processing step S2401, a method to be executed in step S2402 of the subsequent stage is determined on the basis of the method of transmitted light component suppression processing (for example, “MULTIPLICATION”) selected in “METHOD” on the transmitted light component suppression setting screen 1403 depicted in FIG. 13E.

Then, in a suppression execution processing step S2402, the artefact (out-of-focus blur component) in the scattered light extraction image data is suppressed on the basis of the method determined in step S2401.

In the transmitted light component suppression processing unit 1703 of the present example, multiplication is executed between the transmitted light component suppression mask M(X, Y, Zf) and the scattered light extraction image data DS(X, Y, Zf) on the basis of “MULTIPLICATION” which is “METHOD” selected on the setting screen 1403. As a result, corrected scattered light extraction image data (corrected image data) MDS(X, Y, Zf) obtained by suppressing the artefact (out-of-focus blur component) of the low-brightness region are generated. The multiplication of the transmitted light component suppression mask M(X, Y, Zf) and the scattered light extraction image data DS(X, Y, Zf) is an operation of multiplying pixel values of the pixels of the scattered light extraction image data by the coefficients of the corresponding pixels of the transmitted light component suppression mask. This operation is represented by the following expression.

MDS(X,Y,Zf)=M(X,Y,Zf)×DS(X,Y,Zf) [Expression 48]

FIG. 17B is a one-dimensional schematic diagram illustrating the processing performed in the suppression execution processing step S2402 when “MULTIPLICATION” is selected as the method, and the effect of the processing. Details of the processing and effect are explained using FIG. 17B.

Reference numeral 2501 in FIG. 17B represents the reference image data of a subject present at a position at a distance from the focusing position and having an edge with a large brightness difference, and reference numeral 2502 represents the transmitted light component suppression mask M(X, Y, Zf) calculated by the transmitted light component suppression mask generation unit 1701. In the mask 2502, the coefficient in the low-brightness region (region with a negative X) decreases. The coefficient of the mask 2502 has a value of 0 to 1. As mentioned hereinabove, all-in-focus image data or arbitrary out-of-focus blur image data having arbitrary out-of-focus blur can be used as the reference image data 2501.

Reference numeral 2503 represents the scattered light extraction image data DS(X, Y, Zf) calculated by the scattered light extraction image data generation unit 1702. An artefact (out-of-focus blur component) is generated in the low-brightness region (region with a negative X) of an edge. A scattered light component is also included in 2503 at the same time, but is not shown in the figure.

Reference numeral 2504 denotes the computation result obtained with Expression 48. In the transmitted light component suppression mask 2502, the coefficient of the low-brightness region (region with a negative X) has a value less than that of the coefficient of the high-brightness region (region with a positive X). Therefore, in the image data 2504 obtained by multiplying the scattered light extraction image data 2503 by the coefficient, the artefact (out-of-focus blur component) of the low-brightness region (region with a negative X) is reduced.

The settings screens shown in FIGS. 13C to 13E merely represent examples. Default settings or a function of automatically setting optimum values is desirably provided such that a pathologist who is the user could promptly perform observations and diagnosis without having to worry about settings.

Described hereinabove the scattering image data calculation processing (S1502 in FIG. 14A) of the present example.

(Contour Extraction Processing)

Next, an example of contour extraction processing (S1503 in FIG. 14A) is described.

Although the scattered light component in the subject is enhanced in the scattering image data, certain noise and signals are present therein. Accordingly, contour extraction processing is performed to make a contour more visible. For example, a contour can be extracted by binarizing scattering image data (a binarization threshold may have a predetermined value or may be determined dynamically) and then repeating the expansion/contraction processing. Various known techniques can be also used as contour extracting methods and, in this case, any method can be used. Furthermore, accuracy of positions where a contour is present can be increased by adding line thinning processing. As a result of the processing, contour extracted image data are obtained from the scattering image data.

(Display/Analysis of Image Data)

Then, a cell boundary between cells and a boundary between a cell and a sinusoid can be made readily distinguishable by displaying the viewpoint scattering image data, scattering image data, or contour extracted image data on the image display application through the image display processing S1504. As a result, the pathologist can easily visualize the three-dimensional structure of an affected tissue.

Further, image analysis can be performed by invoking the function extension menu 1310 by right-clicking the mouse in the window 1300 and selecting an item such as N/C ratio (nucleus/cytoplasm ratio) calculation.

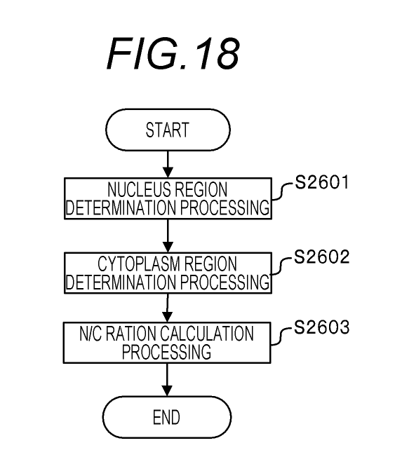

FIG. 18 shows an example of a processing flow of N/C ratio calculation.

The use of two image data, that is, image data in the selection region 207 in the left-side region 1301 and contour extracted image data, is presumed in N/C ratio calculation. Hereinbelow, a portion of a nucleus in image data is referred to as a nucleus region, a portion of cytoplasm surrounding the nucleus is referred to as a cytoplasm region, and a combined whole of the nucleus region and the cytoplasm region is referred to as a cell region.

Initially, in a nucleus region determination processing step S2601, a nucleus region is determined. The following method can be used therefor. With HE staining, since the inside of a nucleus is stained deep blue, whether or not a region is a nucleus region can be identified based on whether or not pixels in the selection region 207 positioned inside a corresponding closed region in the contour extracted image belong in a prescribed color gamut range at a ratio equal to or greater than a certain value. The ratio and the color gamut to be used for the identification may be learned in advance by using a plurality of specimens.

Then, in a cytoplasm region determination processing step S2602, a cytoplasm region is determined. With HE staining, a cytoplasm is stained in pink. Therefore, in the same manner as in the nucleus region determination processing, whether or not a region is a cell region can be identified based on whether or not pixels in the selection region 207 positioned inside a corresponding closed region in the contour extracted image data belong in a prescribed color gamut range at a ratio equal to or greater than a certain value. A cytoplasm region is hereafter specified by subtracting the closed region that has been assumed to be a nucleus region in step S2601 from the cell region. The ratio and the color gamut used for this identification may be also learned in advance using a plurality of specimens.

When sufficient accuracy cannot be obtained with automatic processing, the user may intervene (assist) to determine a region. In this case, after step S2602, a setting screen that enables the user to correct a contour, a nucleus region, or a cell region is displayed on the GUI.

Finally, in an N/C ratio calculation processing step S2603, a surface area of the nucleus region obtained hereinabove is divided by a surface area of the cytoplasm region to obtain an N/C ratio.

The N/C ratio calculation flow described hereinabove is merely an example and can be modified and improved in a variety of ways.

(Advantages of Present Example)

As described above, in the present example, an artefact (out-of-focus blur component) in a low-brightness region can be reduced by using the property of a scattered light quantity being small in the low-brightness region and multiplying the scattered light extraction image data by a mask calculated from the subject. As a result, the demands of users who want to observe surface unevenness (scattered light) at a cytoplasm or cell boundary can be met without having to worry about the effect of artefact (out-of-focus blur component) in the low-brightness region present in the nucleus, or the like, of a pathological specimen.

Further, all of the methods described in the present example make it possible to extract scattering image data of a specimen from the Z stack image data. Therefore, a cell membrane, a cell boundary, and a boundary between a cell and a tube or a cavity which are useful when observing a specimen can be clarified by image processing (post-processing with a computer) alone (that is, without changing the optical system or exposure conditions at the time of image capturing). Another effect is that surface unevenness that practically does not appear as a change in brightness or color can be visualized at a high contrast.

As a result, diagnosis support functions of presenting images useful for diagnosis and calculating an N/C ratio can be realized.

Further, in the present example, the scattering image data generation processing is executed when the execution button 1308 is pressed, but the scattering image data generation processing may be also executed each time the setting parameters shown in FIG. 13B and FIGS. 13C to 13E are changed. As a result, processing results are displayed in real-time synchronously with the changes of the setting parameters. In the case of this configuration, the setting items shown in FIG. 13B and FIGS. 13C to 13E may be deployed and arranged in a single setting screen. Such an implementation mode is also included in the scope of the present invention.

### Example 2

In the above-described Example 1, the processing relating to scattered light extraction image data as an example of scattering image data is described. By contrast, in Example 2, a method for suppressing an artefact (out-of-focus blur component) in a low-brightness region of scattered light enhancement image data is described. It has already been mentioned hereinabove, the scattered light enhancement image data are obtained by adding scattered light extraction image data to arbitrary out-of-focus blur image data.

(Scattering Image Data Calculation Setting Screen 1402)

In the present example, “SCATTERED LIGHT ENHANCEMENT IMAGE” is selected as a “TYPE” setting on the scattering image data calculation setting screen 1402. “METHOD” can be selected from “POLAR ANGLE CHANGE”, “OBSERVATION ANGLE CHANGE”, and “COMPOSITE CHANGE” in the same manner as in Example 1. Parameter settings obtained by combining an out-of-focus blur shape, such as Gaussian blur represented by a Gaussian function or a columnar blur represented by a columnar shape, with the radius thereof can be selected from the dropdown lists, in the same manner as in Example 1, as “VIEWPOINT WEIGHTING FUNCTION 1” and “VIEWPOINT WEIGHTING FUNCTION 2”. Since the viewpoint setting screen 1401 and the transmitted light component suppression setting screen 1403 are the same as in Example 1, the explanation thereof is herein omitted.

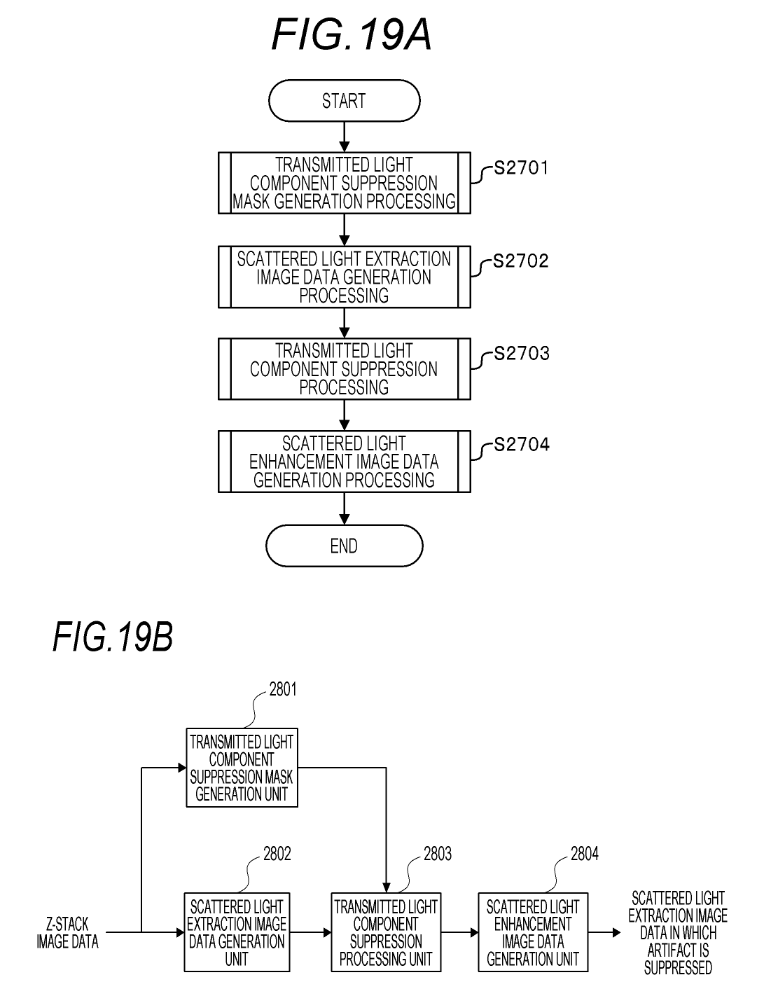

FIG. 19A is a flowchart showing the internal processing of the scattering image data calculation processing step S1502 in the present example. FIG. 19B is a block diagram for realizing the function of the scattering image data calculation processing. A method for generating scattering image data (scattered light enhancement image data) is explained hereinbelow with reference to FIGS. 19A and 19B.

The difference between the flowchart (FIG. 19A) of the present example and the flowchart (FIG. 14B) of Example 1 is that a scattered light enhancement image data generation processing step S2704 is present. Further, the difference between the functional block (FIG. 19B) of the present example and the functional block (FIG. 14C) of Example 1 is that a scattered light enhancement image data generation unit 2804 is present. Since the processing of steps S2701 to S2703 in FIG. 19A is the same as that of steps S1601 to S1603 in FIG. 14B, the detailed explanation thereof is herein omitted. Since the blocks 2801 to 2803 in FIG. 19B have functions same as those of the blocks 1701 to 1703 in FIG. 14C, the detailed explanation thereof is herein omitted. The scattered light enhancement image data generation processing step S2704 and the scattered light enhancement image data generation unit 2804 are described in detail hereinbelow.

(Scattered Light Enhancement Image Data Generation Unit 2804)

Input and output of the scattered light enhancement image data generation unit 2804 depicted in FIG. 19B are explained below. The Z stack image data and the corrected scattered light extraction image data MDS(X, Y, Zf) calculated from the information on the setting screens 1401 to 1403 are inputted to the scattered light enhancement image data generation unit 2804. The corrected scattered light extraction image data MDS(X, Y, Zf) is obtained, for example, by computations with Expression 48.

The scattered light enhancement image data generation unit 2804 executes the processing of the scattered light enhancement image data generation processing step S2704. Corrected scattered light enhancement image data Mcomp(X, Y, Zf) in which an artefact (out-of-focus blur component) in a low-brightness region has been suppressed are generated from the Z stack image data and the corrected scattered light extraction image data MDS(X, Y, Zf), and the generated data are outputted.

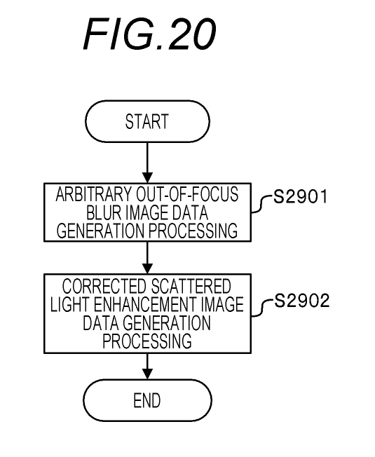

FIG. 20 is a flowchart showing the internal processing of the scattered light enhancement image data generation processing step S2704. The processing depicted in FIG. 20 is described hereinbelow.

In an arbitrary out-of-focus blur image data generation processing step S2901, initially, arbitrary out-of-focus blur image data a(X, Y, Zf) are generated from the Z stack image data. Methods disclosed in the aforementioned PTL 1 and NPLs 2-4, and various other methods may be used for generating the arbitrary out-of-focus blur image data a(X, Y, Zf) from the Z stack image data. Image data having the out-of-focus blur different from that of the layer image data constituting the Z stack image data, and image data having the out-of-focus blur same as that of the layer image data are included in the arbitrary out-of-focus blur image data. The image data of both types can be generated by the methods disclosed in the aforementioned PTL 1 and NPLs 2-4, but some layer image data selected from among the Z stack image data may be used unchanged as the latter image data.

Then, in a corrected scattered light enhancement image data generation processing step S2902, the corrected scattered light extraction image data MDS(X, Y, Zf) generated in step S2703 are magnified by a factor α and added to the arbitrary out-of-focus blur image data a(X, Y, Zf). As a result, corrected scattered light enhancement image data Mcomp(X, Y, Zf) are generated. The generated data are represented by the following expression.

MComp(X,Y,Zf)=a(X,Y,Zf)+α×MDS(X,Y,Zf) [Expression 49]

Here, α is a combination factor that determines the enhancement degree of the scattered light and has a positive value. The setting of α can be changed by the user on the setting screen 1403 (not shown in the figure). In the explanation below, the case is described in which α=1.

Where “POLAR ANGLE CHANGE” is set in “METHOD” on the setting screen 1402, “VIEWPOINT WEIGHTING FUNCTION 1” that has been set on the setting screen 1402 is used to generate the arbitrary out-of-focus blur image data and scattered light enhancement image data. The corrected scattered light enhancement image data generated in step S2902 are represented by the following expression.

$$[ Expression 50 ]$$

$$\begin{matrix}MComp ( X , Y , Zf ) = \int \int {k}_{a 1} ( s , t ) \times {I}_{P 0} ( X , Y , Zf ) d s d t + \\ M ( X , Y , Zf ) \times \int \int {k}_{a 1} ( s , t ) \times {S}_{P 0} ( X , Y , Zf ) d s d t \\ = \int \int {k}_{a 1} ( s , t ) \times \{ \begin{matrix}{I}_{P 0} ( X , Y , Zf ) + M ( X , Y , Zf ) \times \\ {S}_{P 0} ( X , Y , Zf )\end{matrix} \} d s d t\end{matrix}$$

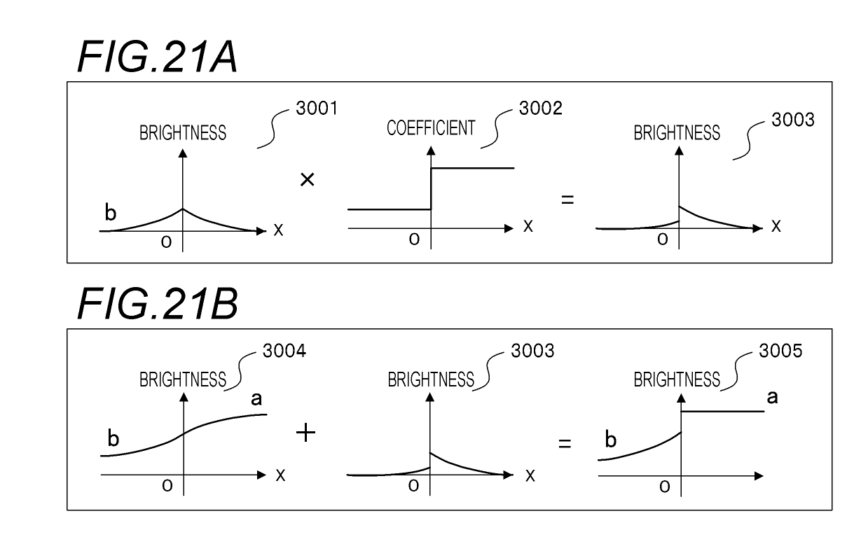

The processing of the scattered light enhancement image data generation processing step S2704 and the effect of the processing are described hereinbelow with reference to FIGS. 21A and 21B.

FIG. 21A is a schematic diagram that one-dimensionally represents the processing performed in the transmitted light component suppression processing unit 2803. FIG. 21B is a schematic diagram that one-dimensionally represents the processing performed in the scattered light enhancement image data generation unit 2804.

Reference numeral 3001 in FIG. 21A represents the scattered light extraction image data DS(X, Y, Zf), reference numeral 3002 represents the transmitted light component suppression mask M(X, Y, Zf), and reference numeral 3003 represents the corrected scattered light extraction image data MDS(X, Y, Zf). As has already been explained in Example 1, in the corrected scattered light extraction image data MDS(X, Y, Zf), an artefact (out-of-focus blur component) in the low-brightness region (region with a negative X) of an edge is suppressed.

Reference numeral 3004 in FIG. 21B stands for the arbitrary out-of-focus blur image data a(X, Y, Zf) calculated from the Z stack image data. The corrected scattered light enhancement image data Mcomp(X, Y, Zf) represented by reference numeral 3005 can be generated by adding the corrected scattered light extraction image data 3003 to the arbitrary out-of-focus blur image data 3004.

In the corrected scattered light enhancement image data 3005, the artefact (out-of-focus blur component) in the low-brightness region (region with a negative X) is suppressed to a greater extent than in the scattered light enhancement image data 1214 depicted in FIG. 12B. Meanwhile, in the high-brightness region (region with a positive X), the out-of-focus blur is suppressed in the same manner as in the scattered light enhancement image data 1214. Further, since the high-brightness region of the corrected scattered light extraction image data 3003 includes a large scattered light component (not shown in the figure), the scattered light component is enhanced in the corrected scattered light enhancement image data 3005.

In the flowchart depicted in FIG. 19A, the integration of a plurality of viewpoints is executed in each of steps S2702 to S2704. However, the integration can be also performed after the calculations of steps S2702 to S2704 have been performed for each viewpoint, as indicated by Expression 50. Such a method is also included in the scope of the present invention.

Where “OBSERVATION ANGLE CHANGE” or “COMPOSITE CHANGE” is set in “METHOD” on the setting screen 1402, “VIEWPOINT WEIGHTING FUNCTION 1” that has been set with the setting screen 1402 is used in the generation of arbitrary out-of-focus blur image data. A viewpoint weighting function for scattered light information extraction that has been calculated from the setting information of “VIEWPOINT WEIGHTING FUNCTION 1” and “VIEWPOINT WEIGHTING FUNCTION 2” that have been set with the setting screen 1402 is used in the generation of scattered light enhancement image data. Since the corrected scattered light extraction image data MDS(X, Y, Zf) is also used in this case, the scattered light can be enhanced while suppressing the artefact (out-of-focus blur component) in a low-brightness region.

(Advantages of Present Example)

With the method of the present example, the effect of out-of-focus blur in a low-brightness region in the scattered light enhancement image data can be reduced. As a result, the demands of users who want to observe surface unevenness at the cytoplasm or cell boundaries or scattered light inside the specimen can be met without having to worry about the effect of artefact (out-of-focus blur component) in the low-brightness region such as the nucleus, or the like, of a pathological specimen.

### Example 3

With the method described in the present example, the artefact (out-of-focus blur component) in a low-brightness region is further suppressed by changing the value range of the transmitted light component suppression mask M(X, Y, Zf).

In the present example, threshold processing is performed in step S1803 in FIG. 15A, a region with a high brightness is set to a maximum brightness (255), and a region with a low brightness is set to a negative maximum brightness (−255), rather than 0. As a result, the transmitted light component suppression mask M(X, Y, Zf) having a value range from −1 to +1 can be generated in step S1804.

By using this mask, it is possible to reduce further the out-of-focus blur in the low-brightness region and enhance the scattered light in the high-brightness region. Further, in the present example, “SCATTERED LIGHT IMAGE ENHANCEMENT” is selected as “TYPE”, and “OBSERVATION ANGLE CHANGE” is selected as “METHOD” on the scattering image data calculation setting screen 1402. “MULTIPLICATION” is selected in “METHOD” on the transmitted light component suppression setting screen 1403.

The effect obtained when the abovementioned transmitted light component suppression mask M(X, Y, Zf) is used is explained hereinbelow. Since the flow of the scattering image data generation processing is the same as in Example 2, the explanation hereinbelow also refers to the block diagram depicted in FIG. 19B.

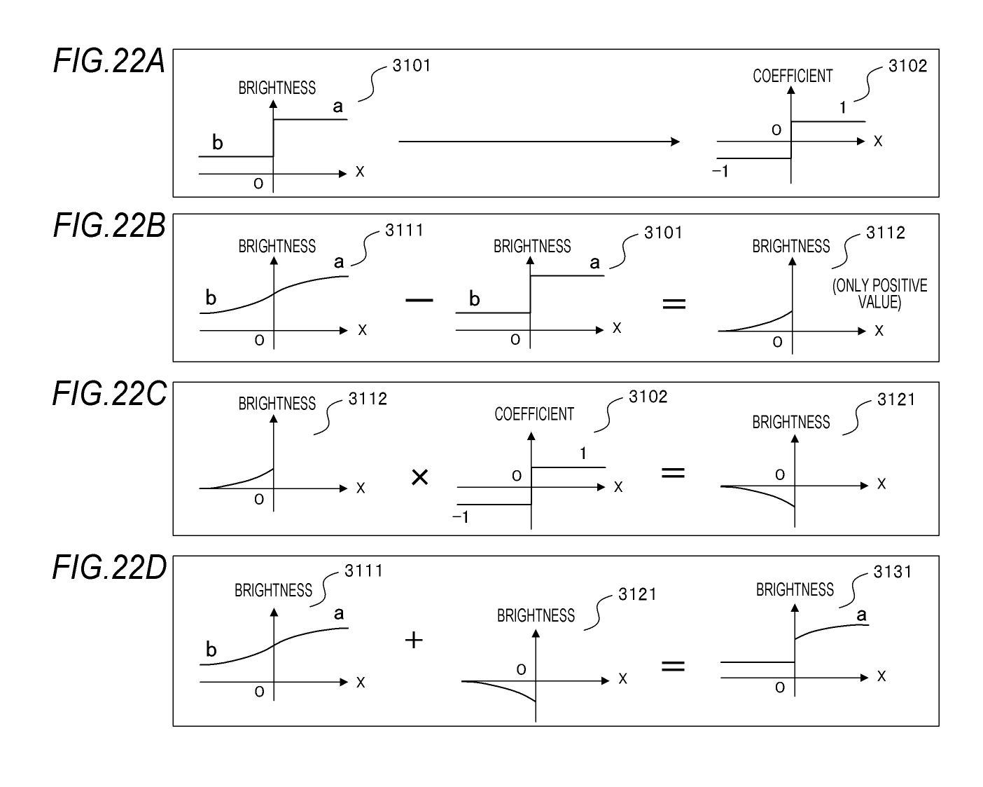

FIGS. 22A to 22D are schematic diagrams explaining one-dimensionally the internal processing of the transmitted light component suppression mask generation unit 2801, the scattered light extraction image data generation unit 2802, the transmitted light component suppression processing unit 2803, and the scattered light enhancement image data generation unit 2804, respectively.

In FIG. 22A, a transmitted light component suppression mask 3102 having a value range from −1 to +1 is generated from all-in-focus image data (reference image data) 3101 of an edge of a subject with a difference in brightness.

In FIG. 22B, a viewpoint weighting function for scattered light information extraction is obtained by using parameters of “VIEWPOINT WEIGHTING FUNCTION 1” and “VIEWPOINT WEIGHTING FUNCTION 2” selected on the setting screen 1402, and processing corresponding to Expression 28 is executed. Reference numeral 3111 represents arbitrary out-of-focus blur image data in the case in which a parameter selected with “VIEWPOINT WEIGHTING FUNCTION 1” is set. Reference numeral 3101 represents all-in-focus image data generated from a parameter selected with “VIEWPOINT WEIGHTING FUNCTION 2”. Reference numeral 3112 represents scattered light extraction image data obtained by determining a difference between the arbitrary out-of-focus blur image data 3111 and the all-in-focus image data 3101 and taking only positive values.

FIG. 22C shows how the corrected scattered light extraction image data 3121 in which the sign is reversed in a low-brightness region are generated by multiplying the scattered light extraction image data 3112 and the transmitted light component suppression mask 3102.

FIG. 22D shows how the corrected scattered light enhancement image data 3131 in which the artefact (out-of-focus blur component) in a low-brightness region has been suppressed are generated by adding up the arbitrary out-of-focus blur image data 3111 and the corrected scattered light extraction image data 3121.

In the corrected scattered light enhancement image data 3131, the artefact in a low-brightness region (region with a negative X) is further suppressed by comparison with the corrected scattered light enhancement image data 3005 (see FIG. 21) of Example 2. In the high-brightness region (region with a positive X) of the corrected scattered light enhancement image data 3131, the out-of-focus blur is not reduced, but the scattered light component (not shown in the figure) is enhanced by the addition.

When the method of the present example is applied to image capturing image data of a HE-stained pathological specimen, the effect of the artefact (out-of-focus blur component) can be suppressed in a low-brightness region where a nucleus is present, and the scattered light can be enhanced in a high-brightness region where cytoplasm or the like is present.

(Advantages of Present Example)

With the method of the present example, it is possible to generate the scattered light enhancement image data in which the artefact (out-of-focus blur component) in a low-brightness region is further reduced by comparison with Example 2. As a result, the demands of users who want to observe surface unevenness at the cytoplasm or cell boundaries or scattered light inside the specimen can be met without having to worry about the effect of artefact (out-of-focus blur component) in the low-brightness region such as the nucleus, or the like, of a pathological specimen.

### Example 4

In Example 4, a method is described for speeding up the processing of the scattered light extraction image data generation step S1602 when “OBSERVATION ANGLE CHANGE” is selected as the method on the setting screen 1402 of Example 1.

The computational expression of Expression 28 calculated according to the flowchart depicted in step S2203 in FIG. 16D of Example 1 can be considered as processing of generating arbitrary out-of-focus blur image data having the out-of-focus blur corresponding to the viewpoint weighting function kₑₛ(s, t) from the Z stack image data.

In the method based on NPL 2, the multiplication of Fourier transforms represented by Expression 14 and the inverse Fourier transform represented by Expression 15 need to be performed for each calculation of viewpoint image data. The resultant problem is that where the number of viewpoints is increased to increase the accuracy of calculations, the calculation time increases proportionally to the number of viewpoint.

Therefore, the rate of calculations can be increased by using the method of PTL 1 or NPLs 3 and 4 which does not require the Fourier transform of inverse Fourier transform for each viewpoint.

(Calculations by Method of PTL 1)

Initially, the calculations performed by the method described in PTL 1 which is one of MFI arbitrary viewpoint/out-of-focus blur image generating methods are summarized.

When the relationship of Expression 13 is valid between the three-dimensional subject f(X, Y, Z), the three-dimensional out-of-focus blur h(X, Y, Z), and the Z stack image data g(X, Y, Z), the convolution on the space is represented by a product on the frequency, and therefore the following relationship is valid (when an imaging optical system is not bilaterally telecentric, the coordinate transform processing is needed for the Z stack image data, but since such processing has already been described, the explanation thereof is herein omitted).

G(u,v,w)=H(u,v,w)×F(u,v,w) [Expression 51]

F(u, v, w), H(u, v, w), and G(u, v, w) represent three-dimensional Fourier transform of the three-dimensional subject f(X, Y, Z), the three-dimensional out-of-focus blur h(X, Y, Z) of the imaging optical system, and the Z stack image data g(X, Y, Z), respectively.

Three-dimensional Fourier transform of a desired three-dimensional out-of-focus blur hₐ(X, Y, Z) is denoted by Hₐ(u, v, w). Three-dimensional Fourier transform Gₐ(u, v, w) of a Z stack image data gₐ(X, Y, Z) having the out-of-focus blur represented by hₐ(X, Y, Z) is represented by the following expression.

Gₐ(u,v,w)=Hₐ(u,v,w)×F(u,v,w)=C(u,v,w)×G(u,v,w) [Expression 52]

where C(u, v, w) is a three-dimensional frequency filter (also referred to hereinbelow as “three-dimensional filter”) which can be represented by the following expression.

$$C ( u , v , w ) = \frac{{H}_{a} ( u , v , w )}{H ( u , v , w )} \qquad [ Expression 53 ]$$

It follows from Expression 52 that the Z stack image data having the desired three-dimensional out-of-focus blur hₐ(X, Y, Z) can be calculated with the following expression.

gₐ(X,Y,Z)=F⁻¹{Gₐ(u,v,w)} [Expression 54]

Thus, the desired out-of-focus blur image data can be generated from information on the Z stack image data g(X, Y, Z), the three-dimensional focusing h(X, Y, Z) of the imaging optical system, and the desired three-dimensional out-of-focus blur hₐ(X, Y, Z), without using information on the three-dimensional subject f(X, Y, Z).

In order to obtain the gₐ(X, Y, Z) stably, the three-dimensional frequency filter represented by Expression 53 should be stable and the three-dimensional out-of-focus blur hₐ(X, Y, Z) should be an out-of-focus blur represented by a light beam within a range of light flux passing through inside the imaging optical system.

As has already been explained with Expression 17, the three-dimensional out-of-focus blur h(X, Y, Z) of an imaging optical system is generated from the viewpoint weighting function k(s, t) corresponding to the imaging optical system. As indicated in FIG. 10B or 10E, the ideal three-dimensional out-of-focus blur increases with the distance from the focusing position. Therefore, where the viewpoint weighting function k(s, t) is represented by a function or image data, a two-dimensional out-of-focus blur at each Z position of the three-dimensional out-of-focus blur h(X, Y, Z) can be obtained by enlarging or contracting the function or image data according to the distance from the focal point.

Since the three-dimensional out-of-focus blur h(X, Y, Z) of an imaging optical system and the arbitrary three-dimensional out-of-focus blur hₐ(X, Y, Z) do not depend on the captured image of the subject, they can be calculated in advance. In the present example, calculated in advance are Hₐ₁(u, v, w) and Hₐ₂(u, v, w) which are Fourier transforms of hₐ₂ (X, Y, Z) and hₐ₂ (X, Y, Z) corresponding to the viewpoint weighting function that can be selected by “VIEWPOINT WEIGHTING FUNCTION 1” and “VIEWPOINT WEIGHTING FUNCTION 2”. Those Fourier transforms are stored in advance in the main memory 302 or the storage device 130 in the image data generating apparatus 100. The Fourier transform H(u, v, w) of the three-dimensional out-of-focus blur h(X, Y, Z) of an imaging optical system is likewise calculated in advance and stored in the main memory 302 or the storage device 130.

(Scattered Light Extraction Image Data Generation Step S1602 Using Method of PTL 1)

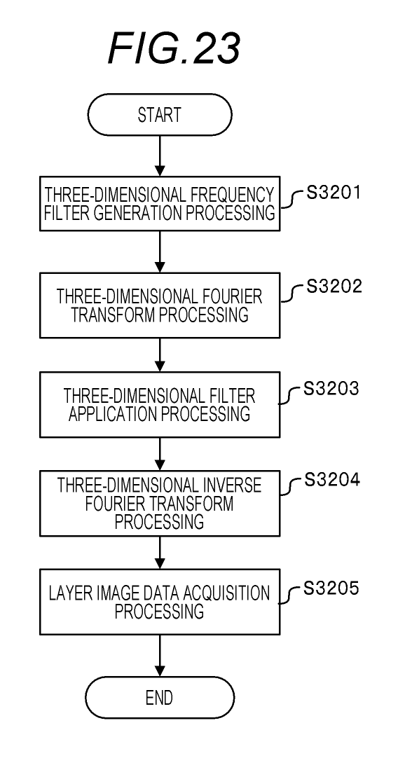

FIG. 23 is a flowchart representing the internal processing of the scattered light extraction image data generation step S1602 in the case in which the method described in PTL 1 is used. The order of the processing is explained hereinbelow.

Initially, in a three-dimensional frequency filter generation processing step S3201, a three-dimensional frequency filter C(u, v, w) is generated. A method for generating the three-dimensional frequency filter C(u, v, w) is explained below.

The H(u, v, w) of the three-dimensional out-of-focus blur h(X, Y, Z) of an imaging optical system is read from the storage device 130 or the like. The Fourier transforms Hₐ₁(u, v, w) and Hₐ₂(u, v, w) of three-dimensional out-of-focus blur corresponding to the viewpoint weighting function that has been selected with “VIEWPOINT WEIGHTING FUNCTION 1” and “VIEWPOINT WEIGHTING FUNCTION 2” by taking the setting information on the setting screen 1402 as an index are also read from the storage device 130 or the like.

The Fourier transform of the three-dimensional out-of-focus blur corresponding to the viewpoint weighting function kₑₓ(s, t) for scattered light information extraction that is obtained from “VIEWPOINT WEIGHTING FUNCTION 1” and “VIEWPOINT WEIGHTING FUNCTION 2” is represented by the following expression by using the linearity of Fourier transform.

Hₐ(u,v,w)=Hₐ₁(u,v,w)−Hₐ₂(u,v,w) [Expression 55]

The three-dimensional frequency filter C(u, v, w) corresponding to the viewpoint weighting function kₑₓ(s, t) for scattered light information extraction can be generated by substituting H(u, v, w) and Hₐ(u, v, w), which is obtained with Expression 55, into Expression 53.

Hₐ(u, v, w) may be also obtained by obtaining kₑₓ(s, t) by computations according to Expression 29, then obtaining hₐ(X, Y, Z) by expansion or contraction of the function or image data corresponding to the distance from the focusing position, and finally performing Fourier transform of hₐ(X, Y, Z).

Further, kₑₓ(s, t) is a viewpoint weighting function fulfilling the conditions of Expression 30 and Expression 31, in the same manner as in Example 1.

Then, in a three-dimensional Fourier transform processing step S3202, the Z stack image data g(X, Y, Z) is subjected to three-dimensional Fourier transform, and the three-dimensional Fourier transform G(u, v, w) of the Z stack image data is generated.

Then, in a three-dimensional filter application processing step S3203, the C(u, v, w) calculated in step S3201 and the G(u, v, w) calculated in step S3202 are substituted into Expression 52, and Gₐ(u, v, w) is determined.

Then, in a three-dimensional inverse Fourier transform processing step S3204, three-dimensional inverse Fourier transform is applied to the Gₐ(u, v, w), and the Z stack image data gₐ(X, Y, Z) having the desired three-dimensional out-of-focus blur hₐ(X, Y, Z) are generated.

Finally, in a layer image data acquisition processing step S3205, layer image data gₐ(X, Y, Zf) of the focal position (Z=Zf) are acquired from the calculated gₐ(X, Y, Z) and obtained as scattered light extraction image data DS(X, Y, Zf).

With the above-described processing, it is possible to generate scattered light extraction image data from the original Z stack image data by using the viewpoint weighting function kₑₓ(s, t) for scattered light information extraction, without obtaining individually the viewpoint image data.

(Calculations by Method of NPLs 3 and 4)

The calculations performed by the method described in NPLs 3 and 4 which is an MFI arbitrary viewpoint/out-of-focus blur image generating method are summarized below.

With the method described in NPLs 3 and 4, Fourier transform A(u, v) of the arbitrary out-of-focus blur image data a(X, Y, Zf) at the Z position Z=Zf can be generated by the following expression.

$$A ( u , v ) = {\sum }_{n = 0}^{N - 1} {H}^{( n - {n}_{j} )} ( u , v ) {G}^{( n )} ( u , v ) \qquad [ Expression 56 ]$$

In Expression 56, n is the number of layer image data which starts at 0 and ends at N−1. Further, n_{f} represents the number of layer image data of a position corresponding to Z=Zf. Further, G⁽ⁿ⁾(u, v) is a Fourier transform of n-th layer image data g⁽ⁿ⁾(X, Y) of the Z stack image data that can be represented by the following expression.

G⁽ⁿ⁾(u,v)=F{g⁽ⁿ⁾(X,Y)} [Expression 57]

Here, F{ } represents Fourier transform.

Further, H⁽ⁿ⁾(u, v) in Expression 56 represents a two-dimensional frequency filter (also referred to simply as “two-dimensional filter”) for each layer image data. This filter can be represented by the following expression.

H⁽ⁿ⁾(u,v)=∫∫kₐ(s,t)e^{-2πi(su+tv)n}C_{s,t}(u,v)⁻¹dsdt [Expression 58]

Here, kₐ(s, t) represents a viewpoint weighting function for generating the desired three-dimensional out-of-focus blur. C_{s,t}(u, v) is a Fourier transform of an integration value c_{s,t}(X, Y, Zf) of the three-dimensional out-of-focus blur h(X, Y, Z) of the imaging optical system in the line-of-sight direction, and C_{s,t}(u, v)⁻¹ is an inverse number thereof. Further, e^{-πi(su+tv)n} is a filter that performs translation in a frequency region.

Expression 58 does not depend on the captured image G⁽ⁿ⁾(u, v) of the subject. Therefore, the computation according to Expression 56 can be significantly speeded up by calculating the H⁽ⁿ⁾(u, v) in advance and storing the calculation result in the main memory 302 or the storage device 130 in the image data generating apparatus 100.

In the present example, the H⁽ⁿ⁾(u, v) is obtained in advance using Expression 58 and the result is stored in advance in the main memory 302 or the storage device 130 with respect to a viewpoint weighting function that can be selected with “VIEWPOINT WEIGHTING FUNCTION 1” and “VIEWPOINT WEIGHTING FUNCTION 2” on the setting screen 1402.

(Scattered Light Extraction Image Data Generation Step S1602 Using Method of NPLs 3 and 4)

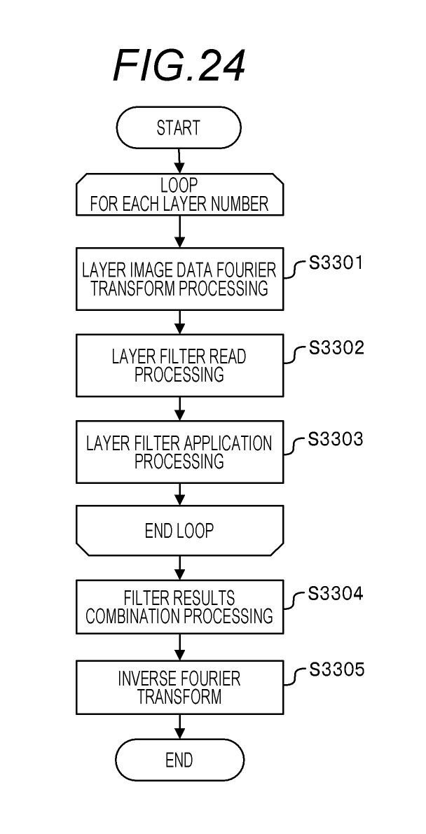

FIG. 24 is a flowchart representing the internal processing of the scattered light extraction image data generation step S1602 in the case in which the method described in NPLs 3 and 4 is used. The order of the processing is explained hereinbelow.

Steps S3301 to S3303 are present in loops which are equal in number to the number of layers in the Z stack image data, and the processing of those steps is performed for each layer image data. The layer number in the loops changes orderly from 0 to N−1.

In a layer image data Fourier transform processing step S3301, the layer image data g⁽ⁿ⁾(X, Y) with a layer number n, which are the processing object, are acquired from the Z stack image data, the Fourier transform is executed as indicated by Expression 57, and the G⁽ⁿ⁾(u, v) is generated.

In a layer filter read processing step S3302, a frequency filter for each layer image data corresponding to a respective viewpoint weighting function is read from the storage device 130 or the main memory 302 on the basis of selection information of “VIEWPOINT WEIGHTING FUNCTION 1” and “VIEWPOINT WEIGHTING FUNCTION 2”.

Then, a frequency filter for each layer image data corresponding to the viewpoint weighting function for extracted light information extraction is generated using a frequency filter for each layer image data that corresponds to the viewpoint weighting function 1 and the viewpoint weighting function 2, respectively.

For example, the viewpoint weighting function 1 is taken as kₐ₁(s, t), the viewpoint weighting function 2 is taken as kₐ₂(s, t), and the respective frequency filter for each layer image data is taken as Hₐ₁⁽ⁿ⁾(u, v) and Hₐ₂⁽ⁿ⁾(u, v). In this case, a frequency filter H⁽ⁿ⁾(u, v) corresponding to the viewpoint weighting function kₑₓ(s, t) (=kₐ₁(s, t)−kₐ₂(s, t)) for scattered light information extraction can be calculated by the following expression.

H⁽ⁿ⁾(u,v)=Hₐ₁⁽ⁿ⁾(u,v)−Hₐ₂⁽ⁿ⁾(u,v) [Expression 59]

The viewpoint weighting function kₑₓ(s, t) for scattered light information extraction is a viewpoint weighting function fulfilling the conditions of Expression 30 and Expression 31, in the same manner as in Example 1.

It is also possible to generate a frequency filter for each layer image data corresponding to the viewpoint weighting function for scattered light information when the viewpoint weighting function 1 and the viewpoint weighting function 2 are selected, and to store the generated frequency filters in the storage device 130 or the main memory 302. In this case, in the layer filter read processing step S3302, the H⁽ⁿ⁾(u, v) corresponding to the viewpoint weighting function kₑₓ(s, t) for scattered light information extraction is read on the basis of information on the viewpoint weighting function 1 and the viewpoint weighting function 2.

Then, in a layer filter application processing step S3303, multiplication is executed between the frequency filter H^{(n-nf)}(u, v) and G⁽ⁿ⁾(u, v) for each layer image data that have been read. A frequency filter application result H^{(n-nf)}(u, v)×G⁽ⁿ⁾(u, v) for each layer image data is thus generated.

Where unprocessed layer image data are present, the number of layers is increased and the processing is returned to step S3301. Meanwhile, where the processing of the abovementioned steps S3301 to S3303 is completed with respect to all of the layer image data from 0 to N−1, the processing advances to step S3304.

In a filter result combination processing step S3304, the frequency filter application results relating to all of the layer image data are combined together. More specifically, the processing corresponding to Expression 56 is performed and A(u, v) is obtained.

Finally, in step S3305, the A(u, v) is subjected to inverse Fourier transform and the arbitrary out-of-focus blur image data a(X, Y, Zf) are generated. As explained with Expression 28, the arbitrary out-of-focus blur image data a(X, Y, Zf) generated using the viewpoint weighting function kₑₓ(s, t) for scattered light information extraction become scattering image data (scattered light extraction image data) DS(X, Y, Zf). Therefore, the image data calculated in step S3305 are outputted as the scattered light extraction image data DS(X, Y, Zf).

As mentioned hereinabove, when the method of NPLs 3 and 4 is used, the scattered light extraction image data can be generated from the original Z stack image data by using the viewpoint weighting function kₑₓ(s, t) for scattered light information extraction, without obtaining scattering image data for each viewpoint.

(Advantages of Present Example)

With the method of the present example, by contrast with the processing flow explained with reference to FIG. 16D of Example 1, it is not necessary to generate the viewpoint image data in the number equal to the number of viewpoints, such generation creating a large computational load. Therefore, the scattering image data (scattered light extraction image data) can be generated at a high rate. As a result, the demands of users who want to speed up the observations of surface unevenness at the cytoplasm or cell boundaries or scattered light inside the specimen can be met.

### Example 5

Described in Example 5 is a method for generating scattered light enhanced data in which the scattered light is more enhanced when “OBSERVATION ANGLE CHANGE” is selected as “METHOD” in the scattering image data calculation settings 1402.

In the present example, the scattered light enhancement image data can be calculated in the same manner as the scattered light extraction image data by using the flowchart depicted in FIG. 16D, 23, or 24. However, the frequency filter used is different from those of the aforementioned examples.

The viewpoint weighting function corresponding to the scattered light enhancement image data is obtained as a sum of the viewpoint weighting function kₐ(s, t) of the desired arbitrary out-of-focus blur image data and the viewpoint weighting function kₑₓ(s, t) for scattered light information extraction. Therefore, a frequency filter may be generated or read using a function k_{b}(s, t) of the expression below instead of the viewpoint weighting function kₑₓ(s, t) for scattered light information extraction in step S3201 of FIG. 23 or step S3302 of FIG. 24. k_{b}(s, t) is called a “viewpoint weighting function for scattered light information enhancement”.

k_{b}(s,t)=kₐ(s,t)+kₑₓ(s,t) [Expression 60]

The integration value of kₐ(s, t) is 1 from Expression 18, the integration value of kₑₓ(s, t) is 0 from Expression 30. Therefore, the integration value of k_{b}(s, t) is 1.

∫∫k_{b}(s,t)dsdt=1 [Expression 61]

Where k_{b}(s, t) satisfies the following relationship, scattering enhancement image data in which information on scattered light is further enhanced can be generated.

$$\int \int {k}_{b} ( s , t ) outr ( s , t , {r}_{th} ) d s d t > 1 \\ \int \int {k}_{b} ( s , t ) inr ( s , t , {r}_{th} ) d s d t < 0 \\ outr ( s , t , {r}_{th} ) = \{ \begin{matrix}0 \text{:} & \sqrt{{s}^{2} + {t}^{2}} \leq {r}_{th} \\ 1 \text{:} & \sqrt{{s}^{2} + {t}^{2}} > {r}_{th}\end{matrix} \\ inr ( s , t , {r}_{th} ) = \{ \begin{matrix}1 \text{:} & \sqrt{{s}^{2} + {t}^{2}} \leq {r}_{th} \\ 0 \text{:} & \sqrt{{s}^{2} + {t}^{2}} > {r}_{th}\end{matrix} \qquad [ Expression 62 ]$$

A negative value of the integral of the viewpoint weighting function which is equal to or less than a predetermined threshold rₜₕ in Expression 62 means that the extraction effect of scattered light information using kₑₓ(s, t) is not canceled. Where the integral of the viewpoint weighting function which is greater than the threshold rₜₕ is greater than 1, it means that viewpoint image data which have an observation angle φ larger than a predetermined threshold and a large contrast of the scattered light component are used.

In the arbitrary out-of-focus blur image data generated with the viewpoint weighting function meeting the conditions of Expression 61 and Expression 62, the information on scattered light is more enhanced than in the arbitrary out-of-focus blur image data generated with the viewpoint weighting function meeting the condition of Expression 61.

In the present example, when scattered light enhancement image data are generated, “SCATTERED LIGHT EXTRACTION IMAGE” is selected as “TYPE” and “OBSERVATION ANGLE CHANGE” is selected as “METHOD” on the scattering image data calculation setting screen 1402. Further, “NO SUPPRESSION PROCESSING” is selected as “METHOD” on the transmitted light component suppression setting screen 1403. Where “NO SUPPRESSION PROCESSING” is selected, only the processing of step S2702 is executed, and the processing of steps S2701, S2703, and S2704 is not executed in FIG. 19A of Example 2. Further, in FIG. 19B, the processing of blocks 2801, 2803, and 2804 is not executed, only the processing of the scattered light extraction image data generation unit 2802 is executed, and the result thereof is outputted.

In the present example, in the scattered light extraction image data generation step S2702, the viewpoint weighting function k_{b}(s, t) for scattered light information enhancement is generated using the following expression.

k_{b}(s,t)=kₐ₁(s,t)+kₑₓ(s,t)=2×kₐ₁(s,t)−kₐ₂(s,t) [Expression 63]

In order to enhance the information on scattered light to a greater degree, it is desirable than the viewpoint weighting function for scattered light information enhancement satisfy the conditions of Expression 61 and Expression 62. Therefore, a user assist setting that represents a combination of “VIEWPOINT WEIGHTING FUNCTION 1” and “VIEWPOINT WEIGHTING FUNCTION 2” which can generate the viewpoint weighting function for scattered light information enhancement satisfying the conditions of Expression 61 and Expression 62 may be present. For example, “COLUMNAR BLUR WITH RADIUS rm” having the same weight for all of the viewpoints with a radius vector equal to or less than rm is selected as “VIEWPOINT WEIGHTING FUNCTION 1”, and “PINHOLE (0, 0)” representing a pinhole having a weight only at a viewpoint (0, 0) is selected as “VIEWPOINT WEIGHTING FUNCTION 2”. In this case, a display color may be changed in the “PINHOLE (0, 0)” of a dropdown list so that the viewpoint weighting function k_{b}(s, t) for scattered light information enhancement that is calculated by Expression 63 could satisfy the conditions of Expression 61 and Expression 62.

The internal processing of step S2702 may be that of any of FIGS. 16D, 23, and 24 described in Example 1.

Where the processing of FIG. 16D is used, in step S2203, the viewpoint image data obtained in step S2202 are combined using the viewpoint weighting function for scattered light information enhancement that can be calculated using the expression of Expression 63 on the basis of “VIEWPOINT WEIGHTING FUNCTION 1” and “VIEWPOINT WEIGHTING FUNCTION 2”. This processing corresponds to the method of NPL 2.

Explained below is the case in which the flowchart of FIG. 23 which corresponds to the method of PTL 1 is used.

The Fourier transform Hₐ(u, v) of three-dimensional out-of-focus blur corresponding to the viewpoint weighting function for scattered light information enhancement can be calculated by the following expression in step S3201. Hₐ₁ (u, v, w) and Hₐ₂ (u, v, w) are Fourier transforms of three-dimensional out-of-focus blur that have been read on the basis of information of “VIEWPOINT WEIGHTING FUNCTION 1” and “VIEWPOINT WEIGHTING FUNCTION 2” selected on the setting screen 1402.

Hₐ(u,v,w)=2×Hₐ₁(u,v,w)−Hₐ₂(u,v,w) [Expression 64]

Then, a three-dimensional frequency filter C(u, v, w) corresponding to the viewpoint weighting function k_{b}(s, t) for scattered light information enhancement can be generated using Expression 53.

Explained below is the case in which the flowchart of FIG. 24 which corresponds to the method of NPLs 3 and 4 is used.

The frequency filter H⁽ⁿ⁾(u, v) for each layer image corresponding to the viewpoint weighting function for scattered light information enhancement can be calculated by the following expression. Hₐ₁⁽ⁿ⁾(u, v) and Hₐ₂⁽ⁿ⁾(u, v) are frequency filters for each layer image that have been read on the basis of information of “VIEWPOINT WEIGHTING FUNCTION 1” and “VIEWPOINT WEIGHTING FUNCTION 2” selected on the setting screen 1402.

H⁽ⁿ⁾(u,v)=2×Hₐ₁⁽ⁿ⁾(u,v)−Hₐ₂⁽ⁿ⁾(u,v) [Expression 65]

Described above are the conditions (Expression 61 and Expression 62) for further enhancement of scattered light and a method for generating the scattered light enhancement image data in the case where “OBSERVATION ANGLE CHANGE” is selected as “METHOD” on the scattering image data calculation setting screen 1402.

In the present example, in FIG. 19A, the case is explained in which the processing of the transmitted light component suppression mask generation processing step S2701, the transmitted light component suppression processing step S2703, and the scattered light enhancement image data generation processing step S2704 are not executed. However, those steps can be executed in the same manner as in Example 2, and such a procedure is also within the scope of the present invention.

(Advantages of Present Example)

By using the method of the present example, it is possible to generate scattered light enhancement image data in which information on scattered light is further enhanced. Further, where the processing flow of FIGS. 23 and 24 is used, the scattering image data (scattered light enhancement image data) can be generated at a high rate. As a result, the demands of users who want to speed up the observations of surface unevenness at the cytoplasm or cell boundaries or scattered light inside a specimen can be met.

### Example 6

Described in Example 6 is a method for rapidly generating scattered light extraction image data or scattered light enhancement image data when “POLAR ANGLE CHANGE” or “COMPOSITE CHANGE” is selected as “METHOD” on the scattering image data calculation setting screen 1402.

In the method described in Example 4, the calculations are collectively performed using a filter rather than by obtaining the scattering image data after calculating the viewpoint image data with different observation angles φ. In the method described in the present example, the calculations are collectively performed using a filter also when different polar angles θ are used.

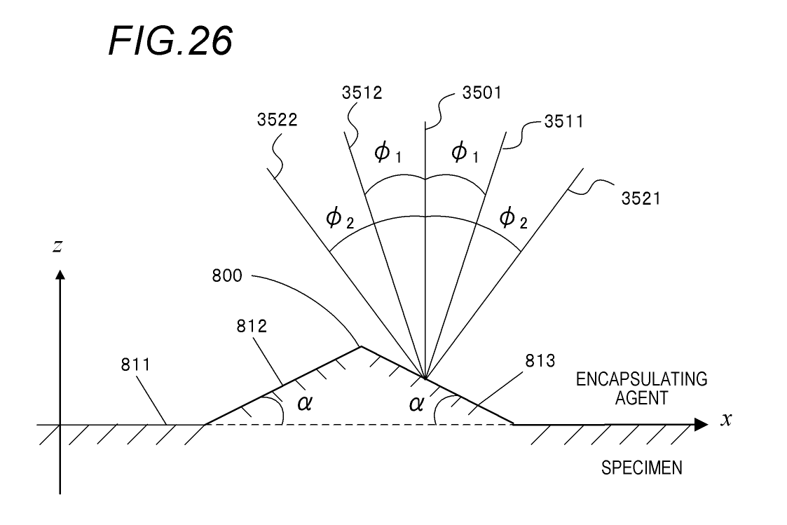

FIG. 26 is a schematic diagram illustrating how the inclined plane 813 of surface unevenness of the specimen depicted in FIG. 8 is observed from viewpoints with the same observation angle φ and polar angles θ that differ by 180 degrees. A straight line 3501 is parallel to the optical axis, and the observation angle φ thereof is 0. The polar angle θ of a straight line 3511 and a straight line 3512 is θ₁ and θ₁+π([rad]), respectively, and the observation angle φ thereof is φ₁. The polar angle θ of a straight line 3521 and a straight line 3522 is θ₁ and θ₁+π([rad]), respectively, and the observation angle φ thereof is φ₂.

As has already been indicated with reference to Expression 10, information on scattered light at a predetermined position (X, Y, Zf) where the inclined plane is present can be extracted by using a difference between viewpoint image data with the same observation angle and different polar angles. As indicated with reference to Expression 10, where a difference is determined between viewpoint image data with a viewpoint direction parallel to the straight line 3511 and viewpoint image data with a viewpoint direction parallel to the straight line 3512, it is possible to extract information on scattered light 2α×B(φ₁) proportional to the inclination angle α and B(φ₁) of the inclined plane 813. Likewise, where a difference is determined between viewpoint image data with a viewpoint direction parallel to the straight line 3521 and viewpoint image data with a viewpoint direction parallel to the straight line 3522, it is possible to extract information on scattered light 2α×B(φ₂).

In the case described hereinbelow in the present example, information on scattered light is extracted by using a difference between viewpoint image data corresponding to viewpoints with polar angles θ that differ from each other by 180 degrees (π [rad]), but the difference in polar angle between the two viewpoints is not limited to 180 degrees. For example, even when the difference in polar angle is 45 degrees, the apparent change of the inclination angle α′ determined from Expression 7 is about ½, α−α′=α/2 in Expression 10, and a scattered image can be extracted at an intensity which is about ¼ that obtained when the difference in polar angle is 180 degrees. Where the difference in polar angle between two viewpoints is equal to or greater than 45 degrees, the intensity sufficient for extracting information on scattered light (the specific value of intensity also depends on the value of the observation angle φ) can be obtained. Therefore, this range defines the scope of the present invention.

Where an imaging optical system is bilaterally telecentric, the relationship represented by Expression 5 is valid between the observation angle φ of a line of sight and the radius vector r (=√(s²+t²)) of a viewpoint (where the optical system is not bilaterally telecentric, the relationship represented by Expression 4 is valid between the observation angle φ_{T} and the radius vector r in transformed coordinates.). Therefore, the representation can also use the radius vector r of a viewpoint instead of the observation angle φ of a line of sight.

Viewpoint image data with a radius vector r of a viewpoint (observation angle φ of a line of sight) and a polar angle θ are represented by I_{r,θ}(X, Y, Zf). The following expression represents the operation of adding up the absolute values of the difference between the viewpoint image data having the same radius vector r of a viewpoint (observation angle φ of a line of sight) and the polar angles 0 and 0+π([rad]), respectively, the addition being performed for M different radius vectors r.

$$AbsDiff ( X , Y , Zf ) = {\sum }_{j = 0}^{M - 1} \vert {I}_{{r}_{j} , {θ}_{i}} ( X , Y , Zf ) - {I}_{{r}_{j} , {θ}_{i} + π} ( X , Y , Zf ) \vert \qquad [ Expression 66 ]$$

Where an apparent inclination angle of positions of a specimen observed from the directions of an inclination angle θ is represented by α_{θ}(X, Y, Zf), Expression 66 can be transformed in the following manner.

$$AbsDiff ( X , Y , Zf ) = {\sum }_{j = 0}^{M - 1} \vert 2 {α}_{{θ}_{i}} ( X , Y , Zf ) \times B ( {φ}_{j} ) \vert \qquad [ Expression 67 ]$$

As long as the polar angle θᵢ is not changed, the apparent inclination angle does not change and, therefore, α_{θi}(X, Y, Zf) is constant. B(φ) is an increasing function that is 0 when (φ)=0 and increases with the increase in φ (since Expression 5 indicates that B(φ) can be considered as a function of r, B(φ) can be also referred to as an increasing function that is 0 when r=0 and increases with the increase in r).

Therefore, as long as the polar angle θᵢ is not changed, the sign (positive or negative) in the absolute value in Expression 67 does not change even when the radius vector rⱼ is changed. Therefore, the absolute value Σ and the order of summation in the right side of Expression 67 can be changed and the expression can be transformed as follows.

$$AbsDiff ( X , Y , Zf ) = \vert {\sum }_{j = 0}^{M - 1} \{ 2 {α}_{{θ}_{i}} ( X , Y , Zf ) \times B ( {φ}_{j} ) \} \vert \qquad [ Expression 68 ]$$

Therefore, the right side of Expression 66 can be transformed as follows.

$${\sum }_{j = 0}^{M - 1} \vert {I}_{{r}_{j} , {θ}_{i}} ( X , Y , Zf ) - {I}_{{r}_{j} , {θ}_{i} + π} ( X , Y , Zf ) \vert = \vert {\sum }_{j = 0}^{M - 1} \{ {I}_{{r}_{j} , {θ}_{i}} ( X , Y , Zf ) - {I}_{{r}_{j} , {θ}_{i} + π} ( X , Y , Zf ) \} \vert \qquad [ Expression 69 ]$$

Thus, from the standpoint of the result obtained, the information on scattered light in which absolute values of a difference between two viewpoint image data that have the same radius vectors rⱼ and different polar angles θ are collected with respect to a plurality of radius vectors is the same as the information on scattered light in which a difference between two viewpoint image data that have the same radius vectors rⱼ and different polar angles θ is collected with respect to a plurality of radius vectors and the absolute value thereof is then taken.

The sign in the absolute value does not change even when the right side of Expression 66 is multiplied by a viewpoint weighting function k(rⱼ, θᵢ) having a positive sign and corresponding to viewpoint image data with a viewpoint radius vector rⱼ and polar angle θᵢ. Therefore, the viewpoint weighting function k(rⱼ, θᵢ) can be also introduced in the absolute value and the following relationship is also valid.

$${\sum }_{j = 0}^{M - 1} k ( {r}_{j} , {θ}_{i} ) \times \vert {I}_{{r}_{j} , {θ}_{i}} ( X , Y , Zf ) - {I}_{{r}_{j} , {θ}_{i} + π} ( X , Y , Zf ) \vert = \vert {\sum }_{j = 0}^{M - 1} k ( {r}_{j} , {θ}_{i} ) \times \{ {I}_{{r}_{j} , {θ}_{i}} ( X , Y , Zf ) - {I}_{{r}_{j} , {θ}_{i} + π} ( X , Y , Zf ) \} \vert \qquad [ Expression 70 ]$$

(However, the viewpoint weighting function in Expression 70 is symmetrical with respect to an optical axis, and the value of the viewpoint weighting function of viewpoint image data corresponding to a viewpoint with a radius vector rⱼ and a polar angle θᵢ+π is equal to k(rⱼ, θᵢ)).

The computations having nonlinearity of S_{P0} (X, Y, Zf) in Expression 25 are transformed, and Expression 70 is compared with Expression 25 to increase the computation rate. The expression presented hereinbelow relates to the case in which Expression 22 is used to calculate the S_{P0} (X, Y, Zf) in Expression 25.

DS(X,Y,Zf)= 1/2∫∫k(s,t)×|I_{P0}(X,Y,Zf)−I_{P1}(X,Y,Zf)|dsdt [Expression 71]

Where the integration by s and t is performed only under the condition that the polar angle of the viewpoint P0 is θᵢ, the polar angle of the viewpoint P1 is θᵢ+π, and the radius vector rⱼ (observation angle) of viewpoints P0 and P1 is the same, the absolute value and integration order in the right side of Expression 71 can be changed in the same manner as in Expression 70.

Thus, the integration in Expression 71 can be represented by the following expression.

∫k(rⱼ,θᵢ)×|I_{P0}(X,Y,Zf)−I_{P1}(X,Y,Zf)|drⱼ=|∫k(rⱼ,θᵢ)×{I_{P0}(X,Y,Zf)−I_{P1}(X,Y,Zf)}drⱼ| [Expression 72]

In a polar coordinate representation, the coordinates of the viewpoint P0 and the viewpoint P1 are P0(rⱼ, θᵢ) and P1(rⱼ, θᵢ+π), respectively.

(Effect of Changing Absolute Value and Order of Integration)

The effect of changing the absolute value and the order of integration is described below.

Where the order of integration can be changed as in Expression 72, the expression in the absolute value in Expression 72 can be represented by filter processing, in the same manner as in Example 4. Therefore, it is not necessary to obtain viewpoint image data relating to a large number of viewpoints, and the calculation rate can be increased. Details are explained hereinbelow.

Where information on scattered light is extracted using the expression in the left side of Expression 72, when noise is present in each viewpoint image data, the noise is converted to positive values by taking the absolute value of the difference and accumulated in integration. Meanwhile, where information on scattered light is extracted using the expression in the right side of Expression 72, even when noise is present in the viewpoint image data, since averaging is performed by adding up the differences between a plurality of viewpoint image data and an absolute value is thereafter taken, the noise is unlikely to accumulate. Therefore, by using the expression in the right side of Expression 72, it is possible to obtain extracted information on scattered light with a lower noise and a higher quality.

(Method for High-Rate Generation of Scattering Image Data by Using Viewpoints Represented in Polar Coordinates)

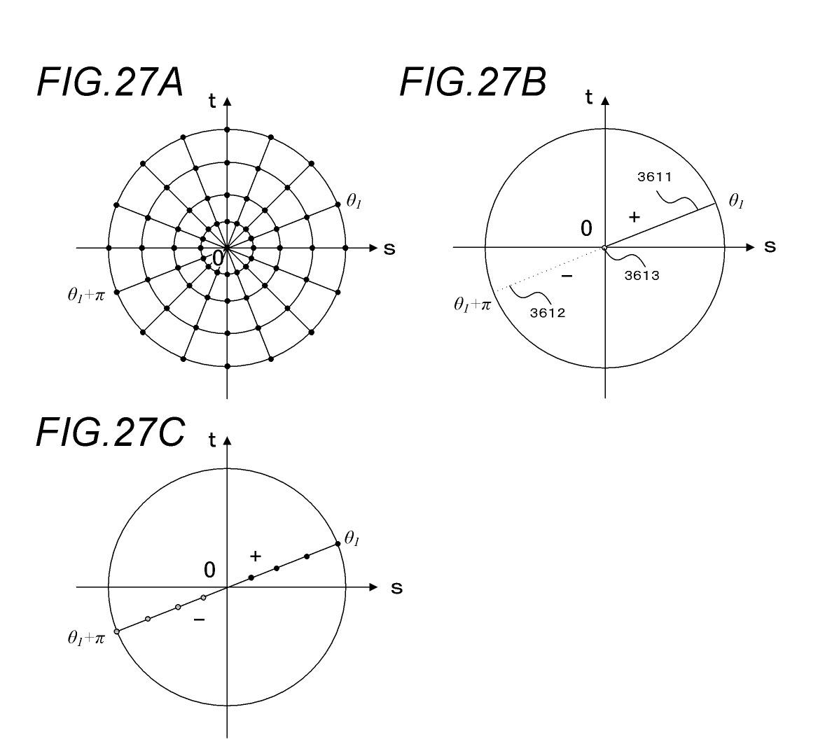

FIG. 27A shows an example of viewpoint positions in the present example, The position of each viewpoint is represented in polar coordinates by using elements of M radius vectors rⱼ and 2N polar angles θᵢ as described hereinbelow.

rⱼ={r₀,r₁, . . . ,r_{M-1}} [Expression 73]

θᵢ={θ₀,θ₁, . . . ,θ_{2N-1}}

The ranges of the radius vector rⱼ and polar angle θᵢ are 0≦rⱼ≦rₘ and 0≦θᵢ<2π. In FIG. 27A, the sampling number of the radius vector directions is M=5 and the sampling number of polar angle directions is 2N=16 (N=8). The radius vector rⱼ and polar angle θᵢ are represented below.

$${r}_{j} = \frac{{r}_{m}}{M - 1} j \\ {θ}_{i} = \frac{π}{ N} i \qquad [ Expression 74 ]$$

Further, in FIG. 27A, as indicated hereinbelow, viewpoints obtained by rotation of the polar angle through 180 degrees (π[rad]) with respect to the polar angle θᵢ are present among all of the viewpoints.

θ_{i+N}=θᵢ+π [Expression 75]

The viewpoint positions depending on the radius vector direction and polar angle direction, such as depicted in FIG. 27A, can be designated by performing setting (not depicted in the figure) on the viewpoint setting screen 1401.

(Extraction of Scattered Light Information)

It is assumed hereinbelow that information on scattered light at positions of a large number of viewpoints depicted in FIG. 27A is extracted by adding up the absolute values of the differences between two viewpoint image data with predetermined polar angles θᵢ and θᵢ+π with respect to a plurality of radius vectors rⱼ and then adding up the results obtained with respect to various polar angles θᵢ. In mathematical formula representation, the calculations are performed with Expressions 76 and 77 hereinbelow.

$$\begin{matrix}{DS}_{{θ}_{i}} ( X , Y , Zf ) = \frac{1}{2} {\sum }_{j = 0}^{M - 1} k ( {r}_{j} , {θ}_{i} ) \times \vert {I}_{P 0} ( X , Y , Zf ) - {I}_{P 1} ( X , Y , Zf ) \vert & [ Expression 76 ] \\ DS ( X , Y , Zf ) = {\sum }_{i = 0}^{2 N - 1} {DS}_{{θ}_{i}} ( X , Y , Zf ) & [ Expression 77 ]\end{matrix}$$

Since the values of viewpoint weighting function and the results in the absolute values are the same when the viewpoint P0(rⱼ, θᵢ) and the viewpoint P1(rⱼ, θᵢ+π) are substituted, Expressions 76 and 77 can be transformed to the following expressions. In Expression 79, the number of summation (Σ) operations can be reduced from 2N to N.

$$\begin{matrix}{DS}_{{θ}_{i}} ( X , Y , Zf ) = {\sum }_{j = 0}^{M - 1} k ( {r}_{j} , {θ}_{i} ) \times \vert {I}_{P 0} ( X , Y , Zf ) - {I}_{P 1} ( X , Y , Zf ) \vert & [ Expression 78 ] \\ DS ( X , Y , Zf ) = {\sum }_{i = 0}^{N - 1} {DS}_{{θ}_{i}} ( X , Y , Zf ) & [ Expression 79 ]\end{matrix}$$

DS_{θi}(X, Y, Zf) represented by Expression 76 or Expression 78 is called hereinbelow “polar angle selection scattering image data”. DS(X, Y, Zf) represented by Expression 77 or Expression 79 is called “scattering image data” or “scattered light extraction image data” in the same manner as hereinabove.

The right side of Expression 78 can be transformed into the following expression by using Expression 70.

$${DS}_{{θ}_{i}} ( X , Y , Zf ) = \vert {\sum }_{j = 0}^{M - 1} k ( {r}_{j} , {θ}_{i} ) \times \{ {I}_{P 0} ( X , Y , Zf ) - {I}_{P 1} ( X , Y , Zf ) \} \vert \qquad [ Expression 80 ]$$

Where the position (r, θ) of a viewpoint in Expression 80 is represented by (s, t) and sigma (Σ) is represented by integral (∫∫), the following Expressions 81 to 84 can be obtained.

DS₀_{ᵢ}(X,Y,Zf)=|S₀_{ᵢ}(X,Y,Zf) [Expression 81]

S_{θ}_{ᵢ}(X,Y,Zf)=∫∫k(s,t)L_{θ}_{ᵢ}(s,t)I_{P0}(X,Y,Zf)dsdt [Expression 82]

Here, L_{θi}(s, t) is represented by the following expression.

L_{θ}_{ᵢ}(s,t)=l_{θ}_{ᵢ}(s,t)−l_{θ}_{ᵢ}_{+π}(s,t) [Expression 83]

Further, l_{θi}(s, t) is represented by the following expression.

$${l}_{{θ}_{i}} ( s , t ) = \{ \begin{matrix}1 \text{:} & θ = {θ}_{i} \\ 0 \text{:} & θ \neq {θ}_{i}\end{matrix} \qquad [ Expression 84 ]$$

Thus, l_{θi}(s, t) is a function that takes a value of 1 when the polar angle θ of the viewpoint (s, t) is θᵢ and takes a value of 0 in other cases. However, it is assumed that l_{θi}(, 0)=0 and L_{θi}(0, 0)=0 when the viewpoint (s, t) is (0, 0).

In the explanation hereinbelow, k(s, t) L_{θi}(s, t) is called “polar angle selection viewpoint weighting function” and L_{θi}(s, t) is called “polar angle selection function”.

The calculation S_{θi}(X, Y, Zf) in Expression 82 is equivalent to the calculation of arbitrary out-of-focus blur image data for which the viewpoint weighting function is the polar angle selection viewpoint weighting function k(s, t) L_{θi} (s, t).

(Polar Angle Selection Viewpoint Weighting Function)

A method for generating the polar angle selection viewpoint weighting function k(s, t) L_{θi}(s, t) is explained hereinbelow with reference to the appended drawings.

FIG. 27B is a schematic diagram illustrating an example of the polar angle selection function L_{θi}(s, t), and FIG. 27C is a schematic diagram illustrating an example of the polar angle selection viewpoint weighting function k(s, t) L_{θi}(s, t).

FIG. 27A is a schematic diagram of the viewpoint weighting function k(s, t). As has already been explained, a sampling position is determined by a combination of a plurality of radius vectors rⱼ and polar angles θᵢ. FIG. 27B is a schematic diagram representing the polar angle selection function L_{θ1}(s, t) at θᵢ=θ1. This function has a value of 1 on a line (3611) with the polar angle θ₁, a value of −1 on a line (3612) with the polar angle θ₁+π, and a value of 0 in other cases. The value thereof in the point of origin (3613) is 0.

FIG. 27C is a schematic diagram showing the polar angle selection viewpoint weighting function k(s, t) L_{θi}(s, t) which is obtained by multiplying the viewpoint weighting function k(s, t) depicted in FIG. 27A and the polar angle selection function L_{θi}(s, t) depicted in FIG. 27B. This function has a positive value in a viewpoint (point of origin is excluded) with a polar angle θ₁, a negative value in a viewpoint (point of origin is excluded) with a polar angle θ₁+π, and a value of 0 in other cases. Thus, the expression in the right side of Expression 82 means the addition of viewpoint image data corresponding to a plurality of viewpoints with polar angles θᵢ, and the subtraction of viewpoint image data corresponding to a plurality of viewpoints with polar angles θᵢ+π. In FIG. 27C, there are four viewpoints with polar angles θᵢ and polar angles θᵢ+π. Therefore, where processing is performed with a filter corresponding to the polar angle section viewpoint weighting function, it is possible to combine the generation of a total of eight viewpoint image data with the processing of a difference between the corresponding viewpoint image data.

(Generation Flow for Scattered Light Extraction Image Data)

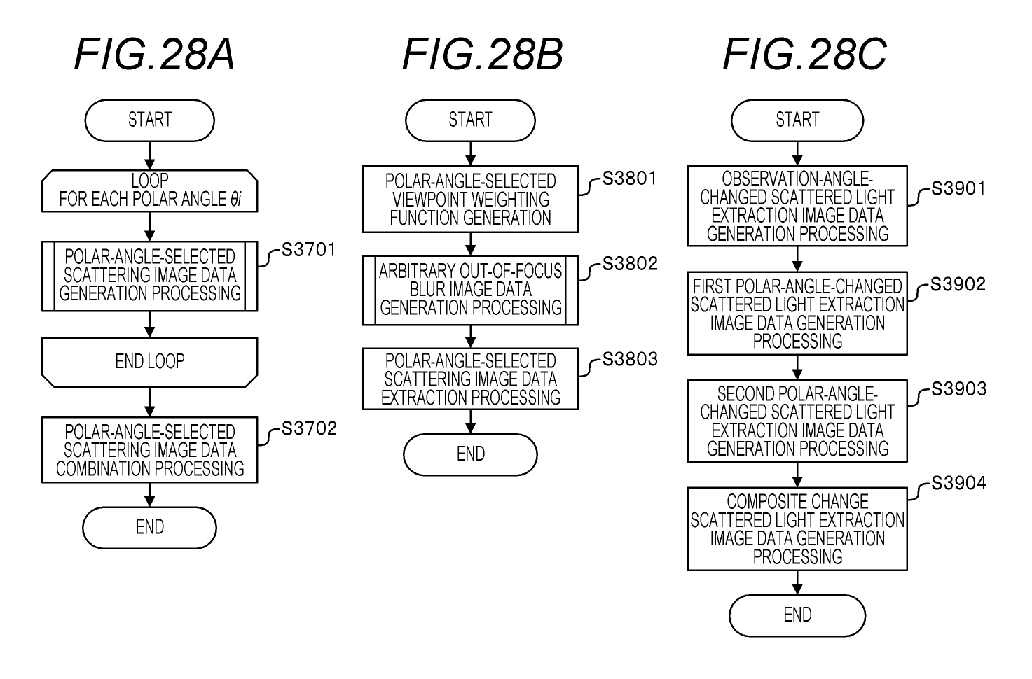

FIG. 28A is a flowchart showing the internal processing of the scattered light extraction image data generation step S1602 in the present example in the case in which “SCATTERED LIGHT EXTRACTION IMAGE” is selected as “TYPE” and “POLAR ANGLE CHANGE” is selected as “METHOD” on the scattering image data calculation setting screen 1402. The processing is described below with reference to FIG. 28A (a method for generating the scattered light extraction image data depicted in FIG. 28A corresponds to calculations by Expression 25).

In a polar angle selected scattering image data generation processing step S3701 in FIG. 28A, polar angle selected scattering image data corresponding to a polar angle θᵢ which is within a loop of viewpoint polar angles θᵢ and has been set with the loop are generated. For example, in the case of viewpoint positions depicted in FIG. 27A, θᵢ is changed from θ₀ to θ_{N-1} and N-cycle loop processing is performed.

Further, Expression 81 and Expression 82 are used for calculating the polar-angle-selected scattering image data DS_{θi}(X, Y, Zf). SOX, Y, Zf) is obtained by generating arbitrary out-of-focus blur image data corresponding to the polar-angle-selected viewpoint weighting function k(s, t) L_{θi} (s, t), and the absolute value of S_{θi}(X, Y, Zf) is then obtained with Expression 81. Details are explained hereinbelow.

Once the processing of step S3701 has been completed with respect to all of the preset polar angles θᵢ, the processing advances to a polar-angle-selected scattering image data combination processing step S3702.

In the polar-angle-selected scattering image data combination processing step S3702, computations of Expression 79 are performed and scattered light extraction image data DS(X, Y, Zf) are generated from the polar-angle-selected scattering image data DS_{θi}(X, Y, Zf) calculated in step S3701.

Details of the polar-angle-selected scattering image data generation processing step S3701 are described hereinbelow. FIG. 28B is a flowchart showing the internal processing of the polar-angle-selected scattering image data generation processing step S3701.

In a polar-angle-selected viewpoint weighting function generation processing step S3801, the polar-angle-selected viewpoint weighting function k(s, t) L_{θi}(s, t) is generated. More specifically, initially, kₐ₁ (s, t) (kₐ₁(r, θ) in polar coordinate representation) is generated on the basis of selection information on “VIEWPOINT WEIGHTING FUNCTION 1” on the scattering image data calculation setting screen 1402. The polar angle selection function L_{θi}(s, t) corresponding to the polar angle θᵢ which is a processing object is then read from the main memory 302 or the storage device 130 in the image data generating apparatus 100. The polar-angle-selected viewpoint weighting function k(s, t) L_{θi}(s, t) is then generated by multiplying the polar angle selection function L_{θi}(s, t) by the kₐ₁(s, t) corresponding to the viewpoint weighting function 1.

In step S3801, an index for reading, from the main memory 302 or the like, a plurality of two-dimensional filters or three-dimensional filters corresponding to the polar-angle-selected viewpoint weighting function may be generated without generating the polar-angle-selected viewpoint weighting function k(s, t) L_{θi}(s, t). For example, a number d1 of a viewpoint weighting function and a number d2 of a polar angle θᵢ are determined as the index.

Then, in an arbitrary out-of-focus blur image generation processing step S3802, arbitrary out-of-focus blur image data are generated on the basis of the polar-angle-selected viewpoint weighting function k(s, t) L_{θi}(s, t), and the generated data are outputted as S_{θi}(X, Y, Zf). Where an index for reading the polar-angle-selected viewpoint weighting function is created in step S3801, a plurality of two-dimensional filters or three-dimensional filters corresponding to the polar-angle-selected viewpoint weighting function is read from the numbers d1 and d2, and arbitrary out-of-focus blur image data are generated.

Any method represented by the processing flow in FIG. 23 (PTL 1) or by the processing flow in FIG. 24 (NPLs 3, 4) may be used to generate the arbitrary out-of-focus blur image data. Details are explained hereinbelow. A method represented by the processing flow in FIG. 16D (NPL 2) may be also used to reduce noise rather than to increase the processing rate.

Finally, in a polar-angle-selected scattering image data extraction processing step S3803, computations are performed to obtain the absolute value indicated by Expression 81 with respect to the S_{θi}(X, Y, Zf) outputted in step S3802, and polar-angle-selected scattering image data DS_{θi}(X, Y, Zf) are generated.

The arbitrary out-of-focus blur image generation processing step S3802 is described hereinbelow in greater detail.

(Case in which Processing Flow Depicted in FIG. 23 is Used to Generate Arbitrary Out-of-Focus Blur Image Data)

The processing steps implemented when the processing flow (PTL 1) of FIG. 23 is used are described below.

In step S3201, the Fourier transform Hₐ(u, v, w) of three-dimensional out-of-focus blur corresponding to the polar-angle-selected viewpoint weighting function k(s, t) L_{θi} (s, t) and the Fourier transform H(u, v, w) of three-dimensional out-of-focus blur of the imaging optical system are read from the main memory 302 or the like. It is assumed that those Fourier transforms have been calculated in advance and stored in the main memory 302 or the storage device 130. The Fourier transform Hₐ(u, v, w) of three-dimensional out-of-focus blur corresponding to the polar-angle-selected viewpoint weighting function can be read using the index determined in step S3801.

A three-dimensional filter C(u, v, w) is generated by computations indicated by Expression 53.

In a three-dimensional Fourier transform processing step S3202, the Fourier transform results that have been once calculated without executing the three-dimensional Fourier transform of the Z stack image data for each polar angle θᵢ which is the processing object are stored in the main memory 302 or the storage device 130 and thereafter read therefrom for processing.

The processing of the subsequent three-dimensional filter application processing step S3203, three-dimensional inverse Fourier transform processing step S3204, and layer image data acquisition processing step S3205 is the same as explained in Example 4. Therefore, the explanation thereof is herein omitted.

(Case in which Processing Flow Depicted in FIG. 24 is Used to Generate Arbitrary Out-of-Focus Blur Image Data)

The processing steps implemented when the processing flow (NPLs 3, 4) of FIG. 24 is used are described below.

In step S3301, the Fourier transform results that have been once calculated without executing the Fourier transform of layer image data for each polar angle θᵢ which is the processing object are stored in the main memory 302 or the storage device 130 and thereafter read therefrom for processing.

Then, in step S3302, frequency filter data H^{(n-nf)}(u, v) for each layer image data corresponding to the polar-angle-selected viewpoint weighting function k(s, t) L_{θi}(s, t) are read from the main memory 302 or the like. It is assumed that frequency filter data have been calculated in advance and stored in the main memory 302 or the storage device 130.

The frequency filter data H^{(n-nf)}(u, v) for each layer image data can be read using the index determined in step S3801. Alternatively, the frequency filter data H^{(n-nf)}(u, v) for each layer may be calculated from Expression 58 by using the polar angle selected viewpoint weighting function k(s, t) L_{θi}(s, t) calculated in step S3801. In this case, C_{s,t}(u, v)⁻¹ or e^{-2πi(su+tv)n} may be calculated in advance and stored in the main memory 302 or the storage device 130. Where those data are read and used for calculations, Expression 58 can be calculated at a high rate.

The processing of the subsequent layer filter application processing step S3303, filter result combination processing step S3304, and inverse Fourier transform step S3305 is the same as explained in Example 4. Therefore, the explanation thereof is herein omitted.

Described hereinbelow is a method for generating scattered light extraction image data when “POLAR ANGLE CHANGE” is selected as “METHOD” on the scattering image data calculation setting screen 1402.

The calculation rate of the scattered light extraction image data can be increased by using the processing flow depicted in FIGS. 28A and 28B in the scattered light extraction image data generation step S1602. Further, the scattered light extraction image data include the effect of averaging and suppressing a noise, and the noise of the generated scattered light extraction image data can be reduced.

(Method for Generating Scattered Light Enhancement Image Data when “POLAR ANGLE CHANGE” Is Selected)

The case in which the scattered light enhancement image data are obtained from the scattered light extraction image data described in the present example, that is, the case in which “SCATTERED LIGHT ENHANCEMENT IMAGE” is selected as “TYPE” and “POLAR ANGLE CHANGE” is selected as “METHOD” in the scattering image data calculation setting screen 1402, is described below. The explanation is performed using FIG. 19A in the same manner as in Example 2.

In order to simplify the explanation, in the present example, the case is also described in which “NO SUPPRESSION PROCESSING” is selected as “METHOD” on the transmitted light component suppression screen 1403, in the same manner as in Example 5. Therefore, in FIG. 19A of Example 2, the processing of step S2702 and step S2704 is executed, whereas the processing of step S2701 and step S2703 is not executed. Further, in FIG. 19B, the processing is executed only in block 2802, and no processing is executed in blocks 2801, 2803, and 2804. The case in which “MULTIPLICATION” is selected as “METHOD” on the transmitted light component suppression setting screen 1403, in the same manner as in Example 2, is also within the scope of the present invention (this case is not described in the present example).

Initially, in the scattered light extraction image data generation processing step S2702, the viewpoint weighting function kₐ₁ (s, t) corresponding to the setting information on “VIEWPOINT WEIGHTING FUNCTION 1” is generated and the scattered light extraction image data DS(X, Y, Zf) are generated. The processing flow depicted in FIGS. 28A and 28B is performed in step S2702 of the present example. This processing has already been described, and detailed explanation thereof is herein omitted.

Then, in the scattered light enhancement image data generation processing step S2704, the arbitrary out-of-focus blur image data a(X, Y, Zf) are generated from the Z stack image data, and the processing of combining the generated data with the scattered light extraction image data DS(X, Y, Zf) is performed. The internal processing of step S2704 is explained using FIG. 20.

In an arbitrary out-of-focus blur image data generation processing step S2901, initially, arbitrary out-of-focus blur image data a(X, Y, Zf) are generated from the Z stack image data. A method represented by the processing flow in FIG. 23 (PTL 1) or a method represented by the processing flow in FIG. 24 (NPLs 3, 4) may be used as a method for generating the arbitrary out-of-focus blur image data from the Z stack image data.

In the present example, “NO SUPPRESSION PROCESSING” is selected as “METHOD” on the setting screen 1403. Therefore, in the corrected scattered light enhancement image data generation processing step S2902, the scattered light extraction image data DS(X, Y, Zf) generated in step S2702 are used as the corrected scattered light extraction image data MDS(X, Y, Zf). Further, the scattered light enhancement image data are obtained by magnifying the data MDS(X, Y, Zf) in the right side and adding the magnified data to the arbitrary out-of-focus blur image data a(X, Y, Zf), as indicated in Expression 49.

Described hereinabove, is a method for generating the scattered light enhancement image data in the case in which “POLAR ANGLE CHANGE” is selected as “METHOD” on the scattering image data calculation setting screen 1402.

By using the processing flow depicted in FIGS. 28A and 28B in step S2702, it is possible to increase the calculation rate of scattered light extraction image data and obtain the scattered light enhancement image data at a high rate. Further, since the scattered light extraction image data obtained in step S2702 include the effect of averaging and suppressing a noise, the noise of the generated scattered light enhancement image data can be also reduced.

(Method for Generating Scattered Light Extraction Image Data when “COMPOSITE CHANGE” Is Selected)

A method for generating scattered light extraction image data when “COMPOSITE CHANGE” is selected as “METHOD” on the setting screen 1402 is described below. In the above-mentioned setting, the sum of the scattered light enhancement image data obtained when “OBSERVATION ANGLE CHANGE” is selected and the scattered light enhancement image data obtained when “POLAR ANGLE CHANGE” is selected is obtained by using the viewpoint weighting function for scattered light information extraction, as indicated by Expression 32.

Where the scattered light extraction image data for which “POLAR ANGLE CHANGE” has been selected are obtained using Expression 44, the calculations can be performed by using the viewpoint weighting function kₑₓ(s, t) for scattered light information extraction obtained from the setting information on “VIEWPOINT WEIGHTING FUNCTION 1” and “VIEWPOINT WEIGHTING FUNCTION 2”. However, in the present example, where the scattered light extraction image data are obtained by calculations indicated in the above-described Expression 79 and Expression 80, since the viewpoint weighting function is present inside the absolute value, linearity is not fulfilled. Therefore, the scattered light extraction image data cannot be calculated by replacing the viewpoint weighting function k(rⱼ, θᵢ) in Expression 80 with kₑₓ(rⱼ, θᵢ). For this reason, the scattered light enhancement image data of the viewpoint weighting function kₐ₁(s, t) and the viewpoint weighting function kₐ₂(s, t) are obtained, as indicated in Expression 34, and the scattered light extraction image data are obtained by taking a difference therebetween.

Shown hereinbelow is the expression for obtaining the scattered light extraction image data when “COMPOSITE CHANGE” is selected as “METHOD” on the setting screen 1402 in the present example, those data being obtained by transforming Expression 34.

$$DS ( X , Y , Zf ) = \int \int {k}_{ex} ( s , t ) \times {I}_{P 0} ( X , Y , Zf ) d s d t + \{ \int \int {k}_{a 1} ( s , t ) \times {S}_{P 0} ( X , Y , Zf ) d s d t - \int \int {k}_{a 2} ( s , t ) \times {S}_{P 0} ( X , Y , Zf ) d s d t \} \qquad [ Expression 85 ]$$

Thus, such a method is equivalent to adding a difference between the scattered light enhancement image data obtained using the viewpoint weighting function kₐ₁(s, t) and the scattered light enhancement image data obtained using the viewpoint weighting function kₐ₂ (s, t) to the scattered light extraction image data obtained in Example 5. As has already been mentioned, the generation flow of scattered light extraction image data mentioned hereinabove in Example 4 and the present example is the processing of generating arbitrary out-of-focus blur image data, without obtaining a plurality of viewpoint image data. Therefore, high-rate calculations can be performed.

FIG. 28C is a flowchart representing the internal processing of the scattered light extraction image data generation step S1602 in the present example in the case in which “SCATTERED LIGHT EXTRACTION IMAGE” is selected as “TYPE” and “COMPOSITE CHANGE” is selected as “METHOD” on the setting screen 1402.

In an observation-angle-changed scattered light extraction image data generation step S3901, the viewpoint weighting function kₑₓ(s, t) for scattered light information extraction is generated from the setting information on “VIEWPOINT WEIGHTING FUNCTION 1” and “VIEWPOINT WEIGHTING FUNCTION 2” that have been set on the setting screen 1402, as has been explained in Example 4. Then, the arbitrary out-of-focus blur image data corresponding to the viewpoint weighting function for scattered light information extraction are generated. The processing flow depicted in FIG. 23 (PTL 1) or the processing flow depicted in FIG. 24 (NPLs 3, 4) may be used as the method for generating the arbitrary out-of-focus blur image data. The scattered light extraction image data calculated in step S3901 are referred to as “observation-angle-changed scattered light extraction image data”.

Then, in a first polar-angle-changed scattered light extraction image data generation step S3902, kₐ₁ (s, t) or the index number thereof is obtained on the basis of the setting information on “VIEWPOINT WEIGHTING FUNCTION 1”, and the scattered light extraction image data DS(X, Y, Zf) are generated using Expression 81 and Expression 79. Since the processing flow has been described with reference to FIGS. 28A and 28B, the explanation thereof is herein omitted. The scattered light extraction image data calculated in step S3902 are referred to as “first polar-angle-changed scattered light extraction image data”.

Likewise, in a second polar-angle-changed scattered light extraction image data generation step S3903, kₐ₂(s, t) or the index number thereof is obtained on the basis of the setting information on “VIEWPOINT WEIGHTING FUNCTION 2”, and the scattered light extraction image data DS(X, Y, Zf) are generated using Expression 81 and Expression 79. The processing contents are the same as in step S3902, except that the viewpoint weighting function is different. The scattered light extraction image data calculated in step S3903 are referred to as “second polar-angle-changed scattered light extraction image data”.

Finally, in a composite change scattered light extraction image data generation step S3904, the calculations shown in Expression 85 are performed. Thus, initially, the second polar-angle-changed scattered light extraction image data are subtracted from the first polar-angle-changed scattered light extraction image data and polar-angle-changed scattered light extraction image data are calculated. Then, the obtained polar-angle-changed scattered light extraction image data are added to the observation-angle-changed scattered light extraction image data and composite change scattered light extraction image data are generated.

Where the composite change scattered light extraction image data are generated are displayed as an image, in the data less than 0, the amount of information on the scattered light is small and can be considered as noise. Therefore, the data less than 0 may be displayed as 0.

Described hereinabove is a method for generating scattered light extraction image data when “COMPOSITE CHANGE” is selected as “METHOD” on the setting screen 1402. The scattered light extraction image data can be calculated at a high rate by using the calculation methods described in Example 4 and the present example. Further, as has already been mentioned, since noise is suppressed in the polar-angle-changed scattered light extraction image data, the generated scattered light extraction image data are also low-noise data.

Further, a difference between the first polar-angle-changed scattered light extraction image data and the second polar-angle-changed scattered light extraction image data may be also outputted as the scattered light extraction image data when “SCATTERED LIGHT EXTRACTION IMAGE” is selected as “TYPE” and “POLAR ANGLE CHANGE” is selected as “METHOD” on the setting screen 1402. The scattered light extraction image data in this case correspond to calculations by Expression 44.

(Advantages of Present Example)

Where the method of the present example is used, even when the differences between the viewpoint image data having the same observation angle φ and different polar angles θ are calculated and collected by addition, the data can be calculated collectively by filter processing, without calculating the corresponding viewpoint image data. Therefore, the generation rate of scattered light extraction image data and scattered light enhancement image data can be increased. As a result, the demands of users who want to speed up the observations of surface unevenness at the cytoplasm or cell boundaries and scattered light inside the specimen can be met. Further, in the scattered light extraction image data and scattered light enhancement image data obtained in the present example, since the subtraction and the operation of taking an absolute value are performed after the addition for a plurality of viewpoint image data, the noise component is suppressed. Therefore, even a weak scattered light component can be observed without being buried in the noise component.

The preferred examples of the present invention are explained hereinabove, but the features of the present invention are not limited to these examples.

Thus, in the examples, the case is explained in which Z stack image data captured with a bright field microscope are uses as original image data. However, the present invention can be also applied to original image data captured with an epi-illumination microscope, a light field camera, a light field microscope, and the like.

Further, in the example, a pathological specimen is considered as a subject by way of example, but the subject is not limited thereto. Thus, a reflecting object such as a metal which is an observation object of an epi-illumination microscope may be used. A transparent biological specimen which is an observation object of a transmission observation microscope may be also used. In either case, where the technique disclosed in PTL 1, or the like, is used, it is possible to generate arbitrary viewpoint image data from a group of a plurality of layer image data captured by varying the focusing position in the depth direction of the subject, and the present invention can be applied. Where original image data obtained by capturing images of a reflective object are used, the original image data include an image of reflected light (mirror reflection) component and an image of a scattered light component, but with a low-gloss subject such as paper the scattered light is predominant. In this case, the scattered light component can be extracted or enhanced by performing the processing same as in the examples.

Further, the features explained in the examples may be combined together. For example, when viewpoint scattering image data are generated in step S2103, the intensity and reliability of the viewpoint scattering image data may be increased by using a viewpoint which is the processing object, a polar-angle-rotated viewpoint, and an observation-angle-changed viewpoint, obtaining the respective viewpoint scattering image data, and adding up the obtained data.

Further, with the processing of generating various image data described in the examples, in some cases, the same processing can be performed by computations in a real space and in a frequency space. In such cases, the computations may be carried out in a real space or in a frequency space. Thus, in the present specification, the term “image data” is a concept including both the image data in a real space and the image data in a frequency space.

In the examples, the computations of image data are represented by mathematical expressions, but calculations in the actual processing are not necessarily performed according to mathematical expressions. Thus, the specific processing or algorithms may be designed in any manner, provided that image data corresponding to the computation results represented by mathematic expressions can be obtained.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-067033, filed on Mar. 27, 2014, which is hereby incorporated by reference herein in its entirety.

What is claimed is:

1. An image data generating apparatus comprising:
a transform unit that transforms original image data including a plurality of layer image data obtained by capturing images of a plurality of layers in a subject that differ in a position in an optical axis direction, into data in a frequency space;
a filter application unit that applies a filter to the transformed data in the frequency space; and
an inverse transform unit that inverse transforms the data to which the filter has been applied into image data in a real space, wherein
the filter is designed such that any of the layer image data included in the inverse-transformed image data become feature image data corresponding to image data for which a difference between a plurality of viewpoint image data with mutually different line-of-sight directions with respect to the subject has been extracted or enhanced.

2. An image data generating apparatus comprising:
a transform unit that uses original image data including a plurality of layer image data obtained by capturing images of a plurality of layers in a subject that differ in a position in an optical axis direction, to transform each of the plurality of layer data into data in a frequency space;
a filter application unit that applies a plurality of filters to the plurality of transformed data in the frequency space, respectively;
a combination unit that combines together the plurality of data to which the filters have been applied; and
an inverse transform unit that inverse transforms the combined data into image data in a real space, wherein the plurality of filters is designed such that the inverse-transformed image data become feature image data corresponding to image data for which a difference between a plurality of viewpoint image data with mutually different line-of-sight directions with respect to the subject has been extracted or enhanced.

3. The image data generating apparatus according to claim 1, wherein
the filter is data generated using a viewpoint weighting function which is a function defining a weight for each viewpoint position.

4. The image data generating apparatus according to claim 3, wherein
where the viewpoint position is represented by (s, t) and the viewpoint weighting function is represented by k(s, t),
the viewpoint weighting function k(s, t) is a function satisfying conditions of
$$\int \int k ( s , t ) d s d t = 0$$
$$\int \int k ( s , t ) outr ( s , t , {r}_{th} ) d s d t > 0$$
$$\int \int k ( s , t ) inr ( s , t , {r}_{th} ) d s d t < 0 \\ outr ( s , t , {r}_{th} ) = \{ \begin{matrix}0 \text{:} & \sqrt{{s}^{2} + {t}^{2}} \leq {r}_{th} \\ 1 \text{:} & \sqrt{{s}^{2} + {t}^{2}} > {r}_{th}\end{matrix} \\ inr ( s , t , {r}_{th} ) = \{ \begin{matrix}1 \text{:} & \sqrt{{s}^{2} + {t}^{2}} \leq {r}_{th} \\ 0 \text{:} & \sqrt{{s}^{2} + {t}^{2}} > {r}_{th}\end{matrix}$$
(where, rₜₕ is a predetermined threshold).

5. The image data generating apparatus according to claim 3, wherein
where the viewpoint position is represented by (s, t) and the viewpoint weighting function is represented by k(s, t),
the viewpoint weighting function k(s, t) is a function satisfying conditions of
$$\int \int k ( s , t ) d s d t = 1$$
$$\int \int k ( s , t ) outr ( s , t , {r}_{th} ) d s d t > 1$$
$$\int \int k ( s , t ) inr ( s , t , {r}_{th} ) d s d t < 0 \\ outr ( s , t , {r}_{th} ) = \{ \begin{matrix}0 \text{:} & \sqrt{{s}^{2} + {t}^{2}} \leq {r}_{th} \\ 1 \text{:} & \sqrt{{s}^{2} + {t}^{2}} > {r}_{th}\end{matrix} \\ inr ( s , t , {r}_{th} ) = \{ \begin{matrix}1 \text{:} & \sqrt{{s}^{2} + {t}^{2}} \leq {r}_{th} \\ 0 \text{:} & \sqrt{{s}^{2} + {t}^{2}} > {r}_{th}\end{matrix}$$
(where, rₜₕ is a predetermined threshold).

6. The image data generating apparatus according to claim 3, wherein
where an angle with respect to an axis parallel to the optical axis direction is referred to as a polar angle,
the viewpoint weighting function is a function such that a weight of a viewpoint having a first polar angle takes a positive value and a weight of a viewpoint having a second polar angle obtained by rotation through a predetermined angle from the first polar angle takes a negative value.

7. The image data generating apparatus according to claim 3, wherein
the filter is a three-dimensional filter obtained by transforming, into the frequency space, a three-dimensional out-of-focus blur represented by
∫∫k(s,t)×δ(X+s×Z,Y+t×Z)dsdt
(where (s, t) is a viewpoint position, k(s, t) is a viewpoint weighting function, δ is a Dirac delta function, and XYZ is an orthogonal coordinate system in which a Z axis is parallel to the optical axis direction).

8. The image data generating apparatus according to claim 3, wherein
the filter is a two-dimensional filter represented by
∫∫k(s,t)×A×Bdsdt
(where (s, t) is a viewpoint position, k(s, t) is a viewpoint weighting function, A is a function representing a translation in the frequency space, and B is an inverse value of a value obtained by converting an integration value obtained by integrating a three-dimensional out-of-focus blur of an optical system that captures an image of the subject in a line-of-sight direction passing through a viewpoint (s, t)).

9. The image data generating apparatus according to claim 1, further comprising
a storage device that stores data of the filter that have been calculated in advance, wherein
the filter application unit reads data of a filter that is to be applied to the transformed data in the frequency space, from the storage device.

10. The image data generating apparatus according to claim 1, wherein a parameter that determines a characteristic of the filter can be changed by a user.

11. The image data generating apparatus according to claim 1, further comprising a correction unit that generates corrected image data by performing correction processing of reducing a brightness with respect to pixels corresponding to at least a low-brightness region in the original image data among pixels of the feature image data.

12. The image data generating apparatus according to claim 1, wherein the original image data are microscopic image data obtained by capturing an image of the subject with a microscope.

13. The image data generating apparatus according to claim 1, wherein the feature image data are image data in which a feature of a scattered light component included in the original image data is extracted or enhanced.

14. The image data generating apparatus according to claim 1, wherein the feature image data are image data in which a contrast of unevenness on a surface of the subject is increased by comparison with that in the original image data.

15. An image data generating method comprising the steps of:
causing a computer to transform original image data including a plurality of layer image data obtained by capturing images of a plurality of layers in a subject that differ in a position in an optical axis direction, into data in a frequency space;
causing the computer to apply a filter to the transformed data in the frequency space; and
causing the computer to inverse transform the data to which the filter has been applied into image data in a real space, wherein
the filter is designed such that any of the layer image data included in the inverse-transformed image data become feature image data corresponding to image data for which a difference between a plurality of viewpoint image data with mutually different line-of-sight directions with respect to the subject has been extracted or enhanced.

16. An image data generating method comprising the steps of:
causing a computer to use original image data including a plurality of layer image data obtained by capturing images of a plurality of layers in a subject that differ in a position in an optical axis direction, to transform each of the plurality of layer data into data in a frequency space;
causing the computer to apply a plurality of filters to the plurality of transformed data in the frequency space, respectively;
causing the computer to combine together the plurality of data to which the filters have been applied; and
causing the computer to inverse transform the combined data into image data in a real space, wherein
the plurality of filters is designed such that the inverse-transformed image data become feature image data corresponding to image data for which a difference between a plurality of viewpoint image data with mutually different line-of-sight directions with respect to the subject has been extracted or enhanced.

17. A non-transitory computer readable storage medium that stores a program for causing a computer to execute each step of the image data generating method according to claim 15.

18. A non-transitory computer readable storage medium that stores a program for causing a computer to execute each step of the image data generating method according to claim 16.
